(19) United States
(12) Patent Application Publication
(10) Pub. No.: US 2019/0122305 A1
(43) Pub. Date: Apr. 25, 2019

(54) METHOD AND APPARATUS FOR CHARACTERIZING THE KEY PROPERTIES AND ANALYZING THE FUTURE PERFORMANCE OF AN INVESTMENT PORTFOLIO

(71) Applicant: Foliofn, Inc., McLean, VA (US)

(72) Inventor: Geoff Considine, Boulder, CO (US)

(73) Assignee: Foliofn, Inc., McLean, VA (US)

(21) Appl. No.: 16/194,448

(22) Filed: Nov. 19, 2018

Related U.S. Application Data
(62) Division of application No. 12/725,204, filed on Mar. 16, 2010, now abandoned.
(60) Provisional application No. 61/210,210, filed on Mar. 16, 2009.

(51) Int. Cl. G06Q 40/06

(52) U.S. Cl. CPC G06Q 40/06

(57) ABSTRACT

Prognostic and diagnostic information is determined about an investment portfolio through perturbing the investment portfolio with allocations to other sectors and reviewing the performance of the perturbed investment portfolios using historical data, and combining that with other factors. Relationships between one's investment portfolio and other assets, rights or liabilities can be identified by creating several modified portfolios each of which comprise a mix of the original investment portfolio and one or more of the other assets, rights or liabilities. The performance of these modified portfolios, as compared to the original portfolio over a historical period, indicates the correlation (or lack thereof) between these other assets, rights or liabilities and one's investment portfolio. By identifying these correlations, one can then take any desired action to modify one's portfolio to obtain the desired results.

### RELATED APPLICATIONS

This application is a divisional of and claims priority to U.S. patent application Ser. No. 12/725,204 filed Mar. 16, 2010, which application claimed the benefit of U.S. Provisional Patent Application No. 61/210,210 filed by the same inventor on Mar. 15, 2009 with the same title. U.S. patent application Ser. No. 12/725,204 and U.S. Provisional Patent Application No. 61/210,210 are hereby incorporated by reference as if repeated herein in their entirety, including the drawings.

### FIELD OF THE INVENTION

The present invention relates generally to methods and apparatuses for analyzing individual investments or investment portfolios and to a method and apparatus for analyzing an individual investment or an investment portfolio to predict possible future performance of these investments.

### BACKGROUND

Since the dawn of investment time, investors have been looking for new ways to evaluate their portfolios. Investor's portfolios can now include individual stocks, mutual funds and Exchange Traded Funds (ETFs) among other investments. Many models have been proposed and many tools have been developed. Some of these tools are useful, many are not. While tools to predict the future performance of an investment exist, such as Fama-French factors, related fundamental factors, and momentum, none of these tools provide verifiable and accurate results. Investment analysts have developed several techniques for so doing, with few verifiable results.

Outside of the challenging problem of prediction, there are more mundane issues having to do with creating metrics that fully characterize a portfolio. While the concept of portfolio diversification is well known, there is no standard metric for the degree of diversification in a portfolio.

Style analysis provides a method of analyzing the holdings of a portfolio by performing multiple linear regressions on the returns of the portfolio against a series of independent variables, each of which represents a specific asset class. The returns from the original portfolio are thus partially attributed to some number of core asset classes. A range of research showed that the performance of a portfolio is overwhelmingly determined by the asset classes represented within the portfolio (i.e., the asset allocation) rather than by the specific holdings, thereby leading to assumptions about the predictability of future performance. Style analysis partly captures diversification benefits between portfolio components, but style analysis does not directly yield a measure of diversification. Style analysis does not predict future performance except insofar as indicating that the performance will be driven by the asset classes to which the regression analysis assigns the highest weight. Style Analysis provides a strategic asset allocation tool, but does not help in timing of an investment.

Models that are intended to help in timing when to buy, sell, or modify a portfolio are generally referred to as tactical asset allocation tools (as opposed to strategic asset allocation tools). Two related classes of models include (1) sector rotation models and (2) momentum models.

The idea behind many sector rotation models is to identify the sectors that have recently out-performed and then to allocate more heavily to these sectors.

Momentum models are closely related to sector momentum models. The natural distinction relates to the fact that momentum models often are based on buy/sell signals that are absolute—such as the price of an asset moving above its ten-month moving average or dropping below its ten month moving average.

Moreover, the traditional tools (for example, Morningstar) available to investors merely analyze one investment at a time, such as a mutual fund. They do not provide useful information as to what occurs if a series of these individual investments are then combined into a portfolio, or when to modify that portfolio.

Finally, the traditional tools analyze specific types of investments—such as mutual funds, stocks or ETFs—as if they are different types from a portfolio perspective and they cannot be compared directly. Consequently, an investor thinking of investing in a group of stocks has no way of comparing that investment to an investment in a mutual fund.

The present invention is therefore directed to the problem of developing a method and apparatus for generating a ranking or rating for an investment portfolio, which is more accurate and useful than prior techniques.

### SUMMARY OF THE INVENTION

The present invention solves these and other problems by, inter alia, developing prognostic and diagnostic information about an investment portfolio through perturbing the investment portfolio with allocations to other sectors and reviewing the performance of the perturbed investment portfolios using historical data, and combining that with other factors.

According to one aspect of the present invention, relationships between one's investment portfolio and other assets, rights or liabilities can be identified by creating several modified portfolios each of which comprise a mix of the original investment portfolio and one or more of the other assets, rights or liabilities. The exact relative mixture is not critical to the implementation of the present invention, but should be significant enough to exhibit differences in performance of the modified portfolio as compared to the original portfolio. One example of the relative mixture is approximately 20% of the modified investments. The performance of these modified portfolios, as compared to the original portfolio over a historical period, indicates the correlation (or lack thereof) between these other assets, rights or liabilities and one's investment portfolio.

For example, one can identify the relative diversification of an investment portfolio by determining how correlated the investment portfolio is to other core asset classes or investment styles. For an investment portfolio that tracks the performance of one or more core asset classes or investment styles, adding more of these core asset classes or investment styles increases this correlation (or reduces the diversification in the portfolio). Alternatively, for an investment portfolio that has no relationship between the performance of one or more core asset classes or investment styles, adding more of these core asset classes or investment styles increases the diversification in the portfolio. By identifying these correlations, one can then take any desired action to modify one's portfolio to obtain the desired results, such as increasing the diversification of one's portfolio by adding more of the investments that indicate little correlation between the portfolio and these investments. Alternatively, one can add more of those investments that have a high correlation with the portfolio to increase the likelihood that one's portfolio will track certain investments.

According to another exemplary embodiment of the present invention, a method for analyzing the performance of an investment portfolio follows a series of basic steps:

The user specifies a portfolio comprised of one or more mutual funds, stocks, exchange traded funds (ETF's) or combinations of these. This is termed the original portfolio.

The user specifies a series of N “core asset classes,” where N is determined by the user. For example, the user could specify five or six core asset classes to be used in this analysis. There are some requirements regarding these specified core asset classes.

The core asset class will typically be an index or an index fund that represents an asset class (although this is not required for all embodiments of the present invention);

To be useful, the core asset must have historical data (or at least must permit one to generate data indicative of the historical performance of the core asset if the data is not available directly).

The model creates a series of “perturbed” or “modified” portfolios that are each comprised of a predetermined percentage of the original portfolio and a remainder of one of the core asset classes. For example, a perturbed portfolio could be 80% from the original portfolio and 20% from one of core asset classes. In this manner, N perturbed portfolios are created. Other percentages of mixtures are suitable without departing from the scope of the present invention.

The historical performance (e.g., risk and return) of the original portfolio is compared to the historical performance of the perturbed portfolios;

A number of perturbed portfolios that the original portfolio has out-performed in a specified historical period can then be used as a predictor of future performance of the original portfolio.

The method identifies situations in which a high (low) performance is a likely predictor of future high (low) performance, which suggests that momentum is a likely outcome.

The method identifies situations in which a high (low) performance is a likely predictor of future low (high) performance, which suggests that mean reversion is a likely outcome.

The approach emphasizes the balance between momentum and mean reversion.

Comparing the original portfolio to the perturbed portfolios as a predictor of future performance is a key component of this approach.

The specific comparison in step (5) is simply one example.

The methods of the present invention look at the degree to which various core asset classes relate to portfolio performance. One exemplary method of the present invention employs a uni-variate non-parametric perturbation approach to the problem of predicting future performance of an investment portfolio. The present invention perturbs a portfolio with allocations to each of a series of core asset classes and quantifies the response of the portfolio to these perturbations. The set of perturbed portfolio and responses is then used to create the signal that characterizes the portfolio.

Certain methods of the present invention compare the performance of a portfolio to a series of perturbed portfolios and calculates how many of the perturbed portfolios have out-performed or under-performed the portfolio in question. Thus, the present invention provides a new approach to assessing diversification and relative timing aspects of an investment or an investment portfolio. The present invention characterizes an investment or an investment portfolio by looking at how the risk and return change as allocations to specific asset classes are added to the investment or investment portfolio. This permits one to infer information about the investment portfolio from the entire range of responses to the perturbations.

According to one aspect of the present invention, an exemplary embodiment of a computer implemented method for analyzing an investment portfolio includes calculating with a computer a plurality of historical returns for the investment portfolio, creating with a computer a plurality of modified portfolios each of which comprise a first percentage allocation to said investment portfolio and a remaining percentage allocation to one of a plurality of core asset classes, calculating with a computer a plurality of historical returns for each of the plurality of modified portfolios, displaying with a graphical user interface a plot including the calculated plurality of historical returns, calculating with a computer how many of the modified portfolios out-performed the original portfolio, and displaying via a graphical user interface a result of how many of the modified portfolios out-performed the original portfolio. This exemplary embodiment may also include generating with a graphical user interface a two dimensional chart, in which one axis represents risk and another axis represents return; generating with a graphical user interface a first point on the two dimensional chart, wherein said first point represents a risk and return for the original portfolio over the historical period; generating with a graphical user interface a first plurality of points on the two dimensional chart, wherein each of said first plurality of points represents a risk and return for one of the modified portfolios over the historical period; and drawing with a graphical user interface a line from said first point to each of said first plurality of points.

According to another aspect of the present invention, an exemplary embodiment of a computer implemented method for analyzing a portfolio of investments includes generating with a computer and a graphical user interface a first point on a two dimensional chart, one axis of said chart representing risk and another axis of said chart representing return, and said first point representing a return and risk for the portfolio over a user specifiable historical period, and generating with a computer and a graphical user interface a plurality of other points on the two dimensional chart, each of said plurality of other points representing a risk and return for one of a plurality of modified portfolios over the user specifiable historical period, each of said plurality of modified portfolios including a user specifiable percentage of one of a plurality of core asset classes, and a remaining portion of said portfolio of investments. This exemplary embodiment may include drawing with a computer and a graphical user interface a line from said first point to each of said plurality of other points.

According to yet another aspect of the present invention, an exemplary embodiment of a computer implemented method for analyzing a portfolio of one or more assets, rights or liabilities includes specifying via a graphical user interface a plurality of sets of one or more assets, rights or liabilities, creating with a computer a plurality of modified portfolios, each of which includes a specifiable percentage of the portfolio to be analyzed and a remaining percentage comprised of one of the plurality of sets of one or more assets, rights or liabilities, and generating with a computer and a graphical user interface a graphic depiction of a risk and return of the portfolio to be analyzed in combination with a risk and return of each of the plurality of modified portfolios over a specifiable historical period.

According to still another aspect of the present invention, an exemplary embodiment of a computer implemented method for analyzing a portfolio includes creating with a computer a plurality (N) of modified portfolios, each of which includes a predetermined percentage (x) of one of a plurality of user specifiable analytic elements and a remaining percentage (100−x) composed of the portfolio being analyzed, determining with a computer a historical probability (Hᵢ) that a given number (i) of the plurality of modified portfolios outperformed the portfolio being analyzed during a predetermined period for each possible number (i=0 through N), including zero, of the plurality of modified portfolios, and displaying with a graphical user interface the determined probability (Hᵢ) for each possible number (i) of modified portfolios. This exemplary embodiment may include calculating a metric representing the portfolio being analyzed with a computer by calculating a weighted sum of the determined probabilities, and displaying the calculated metric via a graphical user interface.

According to yet another aspect of the present invention, an exemplary embodiment of a computer implemented method for analyzing a portfolio of investment elements includes perturbing with a computer the portfolio with allocations to each of a plurality of other investment elements, quantifying with a computer a response of the portfolio to each of the perturbations, and displaying with a graphical user interface the quantified responses to each of the perturbations. This exemplary embodiment may include creating with a computer a signal from a set of the perturbed portfolios and the quantified responses to characterize the portfolio.

According to still another aspect of the present invention, an exemplary embodiment of a computer readable media for analyzing a portfolio of investment elements has a plurality of programming instructions that cause a computer to perturb the portfolio with allocations to each of a plurality of other investment elements, quantify a response of the portfolio to each of the perturbations, and display via a graphical user interface the quantified responses to each of the perturbations.

According to yet another aspect of the present invention, an exemplary embodiment of a apparatus for analyzing an investment portfolio includes a processor and a graphical user interface. The processor includes capability to calculate a plurality of historical returns for the investment portfolio, create a plurality of modified portfolios each of which comprise a first percentage allocation to said investment portfolio and a remaining percentage allocation to one of a plurality of core asset classes, to calculate a plurality of historical returns for each of the plurality of modified portfolio. The graphical user interface is coupled to the processor and includes capability to display a plot including the calculated plurality of historical returns. The processor includes capability to calculate how many of the modified portfolios out-performed the original portfolio. The graphical user interface includes capability to display a result of how many of the modified portfolios out-performed the original portfolio. In this exemplary embodiment, the graphical user interface may include capability to generate a two dimensional chart, in which one axis represents risk and another axis represents return, generate a first point on the two dimensional chart, wherein said first point represents a risk and return for the original portfolio over the historical period, generate a first plurality of points on the two dimensional chart, wherein each of said first plurality of points represents a risk and return for one of the modified portfolios over the historical period, and draw with a graphical user interface a line from said first point to each of said first plurality of points.

According to yet another aspect of the present invention, an exemplary embodiment of an apparatus for analyzing a portfolio of investments includes a processor and a graphical user interface coupled to the processor, which in combination generate a first point on a two dimensional chart, one axis of said chart representing risk and another axis of said chart representing return, and said first point representing a return and risk for the portfolio over a user specifiable historical period, and generate a plurality of other points on the two dimensional chart, each of said plurality of other points representing a risk and return for one of a plurality of modified portfolios over the user specifiable historical period, each of said plurality of modified portfolios including a user specifiable percentage of one of a plurality of core asset classes, and a remaining portion of said portfolio of investments. In this exemplary embodiment, the processor and graphical user interface may include capability to draw a line from said first point to each of said plurality of other points.

According to still another aspect of the present invention, an exemplary embodiment of an apparatus for analyzing a portfolio of one or more assets, rights or liabilities includes a graphical user interface coupled to a processor. The graphical user interface includes capability to enable a user to specify a plurality of sets of one or more assets, rights or liabilities. The processor includes capability to create a plurality of modified portfolios, each of which includes a specifiable percentage of the portfolio to be analyzed and a remaining percentage comprised of one of the plurality of sets of one or more assets, rights or liabilities. The processor and graphical user interface include capability to generate a graphic depiction of a risk and return of the portfolio to be analyzed in combination with a risk and return of each of the plurality of modified portfolios over a specifiable historical period.

According to still another aspect of the present invention, an exemplary embodiment of an apparatus for analyzing a portfolio includes a processor and a graphical user interface. The processor includes capability to create a plurality (N) of modified portfolios, each of which includes a predetermined percentage (x) of one of a plurality of user specifiable analytic elements and a remaining percentage (100−x) composed of the portfolio being analyzed, to determine a historical probability (Hᵢ) that a given number (i) of the plurality of modified portfolios outperformed the portfolio being analyzed during a predetermined period for each possible number (i=0 through N), including zero, of the plurality of modified portfolios. The graphical user interface includes capability to display the determined probability (Hᵢ) for each possible number (i) of modified portfolios. In this exemplary embodiment the processor may include the capability to calculate a metric representing the portfolio being analyzed by calculating a weighted sum of the determined probabilities. In this exemplary embodiment, the graphical user interface may include the capability to display the calculated metric.

According to yet another aspect of the present invention, an exemplary embodiment of an apparatus for analyzing a portfolio of investment elements includes a processor to perturb the portfolio with allocations to each of a plurality of other investment elements, to quantify a response of the portfolio to each of the perturbations/This exemplary embodiment may include a graphical user interface coupled to the processor to display the quantified responses to each of the perturbations. In this exemplary embodiment, the processor may include capability to create a signal from a set of the perturbed portfolios and the quantified responses to characterize the portfolio.

According to yet another aspect of the present invention, an exemplary embodiment of a computer readable media has programming instructions that cause a processor to analyze a portfolio by creating a plurality (N) of modified portfolios, each of which includes a predetermined percentage (x) of one of a plurality of user specifiable analytic elements and a remaining percentage (100−x) composed of the portfolio being analyzed, determining a historical probability (Hᵢ) that a given number (i) of the plurality of modified portfolios outperformed the portfolio being analyzed during a predetermined period for each possible number (i=0 through N), including zero, of the plurality of modified portfolios, displaying via a graphical user interface the determined probability (Hᵢ) for each possible number (i) of modified portfolios, calculating a metric representing the portfolio being analyzed with a computer by calculating a weighted sum of the determined probabilities, and displaying the calculated metric via a graphical user interface.

These and other aspects of the present invention will become evident from the detailed description below in light of the following drawings.

### BRIEF DESCRIPTION OF THE DRAWINGS

FIG. 1 depicts an exemplary embodiment of a graph of risk and return developed in accordance with one aspect of the present invention to analyze the performance of the S&P Index Fund during the period from Jan. 1, 1998 through Jan. 1, 2000 when perturbed with ten predetermined asset classes.

FIG. 2 depicts an exemplary embodiment of another graph developed in accordance with one aspect of the present invention to analyze the performance of the S&P Index Fund during the period from Jan. 1, 2000 through Jan. 1, 2002 when perturbed with the same ten predetermined asset classes used in FIG. 1.

FIG. 3 depicts an exemplary embodiment of still another graph developed in accordance with one aspect of the present invention to analyze the performance of the S&P Index Fund during the period from Jan. 1, 2002 through Jan. 1, 2004 when perturbed with the same ten predetermined asset classes used in FIGS. 1-2.

FIG. 4 depicts an exemplary embodiment of yet another graph developed in accordance with one aspect of the present invention to analyze the performance of the S&P Index Fund during the period from Jan. 1, 2004 through Jan. 1, 2006 when perturbed with the same ten predetermined asset classes used in FIGS. 1-3.

FIG. 5 depicts an exemplary embodiment of still another graph developed in accordance with one aspect of the present invention to analyze the performance of the S&P Index Fund during the period from Jan. 1, 2006 through Jan. 1, 2008 when perturbed with the same ten predetermined asset classes used in FIGS. 1-4.

FIG. 6 depicts a standard plot of the returns of a known fund from approximately July 2003 through July 2008 compared to two other funds.

FIG. 7 depicts an exemplary embodiment of a graph developed according to one aspect of the present invention showing for a given state of a fund, i.e., the number of modified portfolios that have quarterly returns higher than the returns of the known fund, the performance for the next quarter of that fund.

FIG. 8 depicts an exemplary embodiment of a graph developed according to one aspect of the present invention showing the same type of graph as in FIG. 7 with a second graph developed according to another aspect of the present invention placed below the first graph, which second graph shows the percent of cases in which the modified portfolios outperformed the known fund.

FIG. 9 depicts an exemplary embodiment of a graph developed according to one aspect of the present invention showing the same types of graphs as in FIG. 7-8 for the S&P 500 fund.

FIG. 10 depicts an exemplary embodiment of a graph developed according to one aspect of the present invention showing the same types of graphs as in FIGS. 7-9 for an investment portfolio comprised of 60% of the S&P 500 fund and 40% of bonds.

FIG. 11 depicts an exemplary embodiment of a graph developed according to one aspect of the present invention showing the same types of graphs as in FIGS. 7-10 for an investment portfolio comprised of 50% of the S&P 500 fund and 50% of an international index.

FIG. 12 depicts an exemplary embodiment of a screen shot of an input screen to a computer program that generates the various plots shown in FIGS. 1-5 and 7-12 according to one aspect of the present invention.

FIG. 13 depicts an exemplary embodiment of a screen shot of an output screen from a computer program that generates the various plots shown in FIGS. 1-5 and 7-12 according to one aspect of the present invention, which output screen shows the results from analyzing Ford stock's future performance in 2008 using only data up through Dec. 31, 2007.

FIG. 14 depicts the standard graph of the returns of Ford stock during 2008 to compare the actual performance of Ford stock during 2008 relative to the predicted performance of Ford stock during 2008 using the methods of the present invention.

FIG. 15 depicts an exemplary embodiment of a screen shot of an output screen from a computer program that generates the various plots shown in FIGS. 1-5 and 7-13 according to one aspect of the present invention, which output screen shows the results from analyzing the S&P 500 fund's future performance in 2008 using only data up through Dec. 31, 2007.

FIG. 16 depicts an exemplary embodiment of a screen shot of an output screen from a computer program that generates the various plots shown in FIGS. 1-5, 7-13 and 15 according to one aspect of the present invention, which output screen shows the results from analyzing General Electric stock's future performance in 2008 using only data up through Dec. 31, 2007.

FIG. 17 depicts an exemplary embodiment of an apparatus for implementing the methods of the present invention according to one aspect of the present invention.

FIGS. 18-20 depict an exemplary embodiment of a method for analyzing an investment or an investment portfolio according to one aspect of the present invention.

FIG. 21 depicts the Diversification metric of the present invention versus annualized standard deviation in return for all Fidelity, T. Rowe Price, Vanguard, and American mutual funds as of the end of 2007.

FIG. 22 depicts the Diversification metric of the present invention versus Beta for all Fidelity, T. Rowe Price, Vanguard, and American mutual funds as of the end of 2007.

FIG. 23 depicts a graph of the Diversification metric of the present invention, in which the horizontal axis shows the diversification threshold and the vertical axis shows the difference in average annual return between funds rated as ‘buy’ and the entire population.

FIG. 24 shows a graph similar to FIG. 23, but with a graph of randomized sub-sampled portfolios added.

FIG. 25 depicts a graph of the improvement in worst annual fund return versus diversification threshold as determined according to the present invention.

FIG. 26 shows a graph similar to FIG. 24, but with a graph of randomized sub-sampled portfolios added.

FIG. 27 shows a graph comparing the Diversification metric of the present invention with Normalized Variance (NV).

FIG. 28 shows a graph comparing the Diversification metric of the present invention with Normalized Variance (NV) with the results normalized by the trailing portfolio volatility.

FIG. 29 shows a plot of return versus the diversification metric of the present invention for 36 portfolios versus funds.

FIG. 30 depicts the diversification metric of the present invention for the thirty stocks that make up the Dow Jones Industrial Average, superposed on the values for the four major mutual fund families.

FIGS. 31-32 show exemplary embodiments of screen shots for an apparatus for analyzing investment portfolios according to one aspect of the present invention.

FIG. 33 depicts a plot of risk versus return using a timing model of the present invention for one of the four fund families over a 22-year period.

FIG. 34 shows a similar plot with the results from certain NoLoad FundX strategies added.

FIG. 35 shows the performance of the timing model of the present invention and the NoLOand Fund X versus the S&P 500 over a 22-year period.

FIG. 36 shows a plot of the percentiles of the diversification metric of the present invention for all Vanguard funds (top line) versus the individual stocks that make up the S&P100 (bottom line).

FIGS. 37-38, which show the number of 12-month periods certain funds were in each State for a given historical period according to one aspect of the present invention.

FIG. 39 shows an exemplary embodiment of weights used to calculate the Diversification metric according to one aspect of the present invention.

FIGS. 40A-F show plots demonstrating the meaning of the portfolio compass tool according to one aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

As used herein, assets, rights or liabilities refers to any investable item or tradable commodity or item of value in which there exists a market for trading. This definition includes securities, equities, derivatives, currencies, fungible commodities, insurance contracts, mortgages, bonds, airline reservations, hotel reservations, golf tee times, country club memberships, antiques, etc. Although the computer-based system of the present invention can be used with regard to any asset or liability that is traded or invested, the discussion herein relates primarily to its use in connection with securities and instruments for simplicity purposes.

The present invention approaches the problem of predicting the future performance of an investment portfolio starting from the best-established factors in finance that inform the investing process. The techniques of the present invention are built on market-based information, which is the information that the market provides in the price movements of an investment and of that investment relative to broad asset classes. There are a range of standard market-based metrics that are used in portfolio management, such as: Volatility, Beta, Average return, Correlations between assets and Momentum.

Volatility measures the variability in returns for an investment (e.g., stock, fund, or portfolio). Beta measures the degree to which an investment tends to move up or down in response to a broad market index (e.g., the S&P500 is most often used as the basis of Beta for domestic equities). High Beta means that an investment amplifies moves in the S&P 500 (and vice versa). Average return is self-explanatory. The correlations between assets tell us how assets move relative to one another. A principle of good investing is to combine assets that have low correlation to one another, which forms the basis for diversification. Momentum measures the tendency of prices to continue moving in the same direction, in other words assets that have performed well recently tend to continue (and vice versa) for some period of time.

All of the above statistics are useful measures of a portfolio. Moving averages (MA's) are a way to track momentum effects. The Morningstar star rating for mutual funds is a momentum-based indicator: a mutual fund is assigned stars purely based on past performance—the higher the trailing returns, the higher the rating. There are adjustments made for risk in a fund, but this does not change the essential nature of the Morningstar ratings as momentum-based.

While momentum effects are useful information, momentum does not persist forever. An asset class cannot outperform all other asset classes forever. When outperformers correct downwards (or underperformers correct upwards), this is called Reversion To the Mean (RTM) or reversal. Markets are a balance between momentum and mean reversion. An excellent summary of the relative roles of momentum and mean reversion is provided in a recent academic paper by Messrs. Vayanos and Woolley, in which these authors state:

Two of the most prominent financial-market anomalies are momentum and reversal. Momentum is the tendency of assets with good (bad) recent performance to continue overperforming (underperforming) in the near future. Reversal concerns predictability based on a longer performance history: assets that performed well (poorly) over a long period tend to subsequently underperform (overperform). Closely related to reversal is the value effect, whereby the ratio of an asset's price relative to book value is negatively related to subsequent performance. Momentum and reversal have been documented extensively and for a wide variety of assets, ranging from individual stocks to industry- and country-level stock portfolios, to bonds, commodities and currencies

The aforementioned authors refer to reversion to the mean as “reversal.”

The present invention provides, inter alia, a mechanism for evaluating investments that captures reversion to the mean in combination with momentum. Prior art momentum-based models will never support selling assets that have been out-performing or buying assets that are beaten down. Investors who have no tools to evaluate the potential for mean reversion are therefore more likely to get caught up in bubbles and less likely to identify times when they can buy assets very cheaply. Certain aspects of the present invention capture the interplay between momentum effects and reversion to the mean effects in a broad-based rating model. Furthermore, momentum and mean reversion manifest differently for different types of portfolios, a distinction that has been missed in previous research on momentum effects.

According to one aspect of the present invention, a method is provided for analyzing portfolios that can evaluate mutual funds, portfolios of individual stocks, ETF's and combinations of all of these in a single tool. This method remains consistent for all of these cases and allows investors to generate the same ratings statistics for their own portfolios in direct contrast to other ratings, such as Morningstar, which uses different ratings models for mutual funds, ETF's and individual stocks. The comparability between all possible portfolio choices that the tool of the present invention provides to investors is substantial. Simply being able to compare the key attributes of a portfolio to that of a favorite money manager provides significant advantages. Similarly, being able to critically compare the properties of one “income” based portfolio to another (such as a bond fund or a portfolio of bonds), or one target date portfolio to another (such as comprised of a portfolio of ETFs and the other a single mutual fund) has heretofore been unattainable.

According to one aspect of the present invention, a method termed herein as the Portfolio Compass combines risk and return information, with some indication of the degree to which the returns on a portfolio are determined by the movements in a range of broad indexes, but not just a single index as in Beta. The technique of the present invention incorporates reversion to the mean, because some of the greatest investment opportunities are likely to occur when an asset class is out of favor (i.e., when betting against momentum).

In brief, the Portfolio Compass of the present invention shows the current portfolio (whether that portfolio contains five stocks, one mutual fund, several stocks and funds, etc.) and how its trailing performance would have been different with the addition of an allocation to a specific asset class. The following examples have employed a two-year look-back period and a series of index funds to add the allocations to specific sectors.

Investing in S&P500 Index Fund for Jan. 1, 1998-Jan. 1, 2000

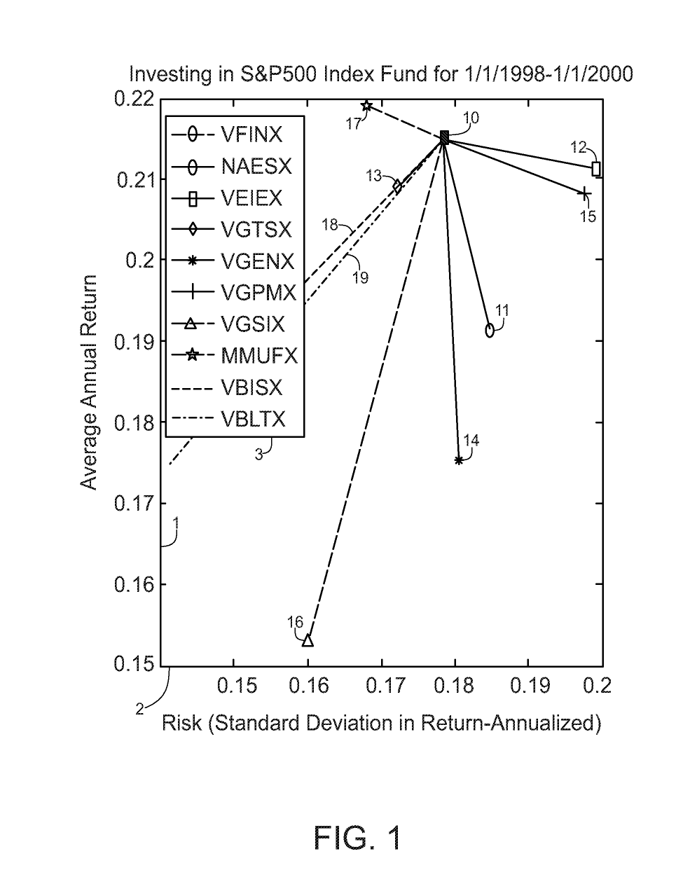

An example of an exemplary embodiment of a graph developed using a method of the present invention for a 100% investment in the S&P 500 is shown in FIG. 1. The plot in FIG. 1 compares Risk (depicted on the horizontal axis 2) and Return (depicted on the vertical axis 1) over the period from Jan. 1, 1998 through Jan. 1, 2000. The trailing return and risk for the selected portfolio is shown by the point at the center 10 of the ‘star’. Each leg (11-19) of the star shows the portfolio performance if one had allocated 20% of the original portfolio to another asset class. In this example, a long-lived index fund was employed for each of these “additions”—and each one represents an asset class. The specific long-lived index funds employed in this example are:

VFINX=S&P500 (10)

NAESX=Small Cap Stocks (11)

VEIEX=Emerging Markets (12)

VGTSX=International Stocks (13)

VGENX=Energy Stocks (14)

VGPMX=Precious Metals Stocks (15)

VGSIX=REIT's (16)

MMUFX=Utilities (17)

VBISX=Short-Term Bonds (18)

VBLTX=Long-Term Bonds (19)

The chart in FIG. 1 shows, therefore a great deal of information about the relative performance of a portfolio, as well as how well other asset classes would alter the portfolio. This chart in FIG. 1 also shows a great deal with regard to momentum and diversification. Note that the most compelling evidence for the use of momentum in portfolio construction looks at the relative performance of asset classes rather than absolute performance—and the chart in FIG. 1 clearly shows relative performance. Top performing asset classes tend to continue to out-perform for some period (and possibly as long as three years, depending on the study) and vice versa.

The first thing to notice in this chart in FIG. 1 is that there is no asset class for which adding the asset class to the portfolio 10 generates a substantial increase in return. This means that the S&P 500 (our entire portfolio 10) would not have benefited substantially from mixing in other asset classes for this two year period. A 20% allocation to utilities (MMUFX 17) would have increased returns very slightly, as well as reducing risk slightly. If the addition of other asset classes does not help the risk/return profile over the historical period, then the portfolio is due for Reversion to the Mean (RTM) because no portfolio can dominate forever. Note that the S&P 500 portfolio 10 has generated more return with less risk than any of the modified portfolios (except for the portfolio modified with utilities). This portfolio 10 is fairly diversified (as expected) and this is shown by the spread in response of the portfolio 10 to the additions of other asset classes 11-19. The various legs 11-19 of the star are spread out in all directions—and this shows wide diversification inherent in the S&P 500 portfolio 10.

Also notice that there is no leg of the Portfolio Compass ion FIG. 1 for large cap stocks (i.e., VFINX). This is because VFINX's symbol lies directly on top of the center of the pattern 10. Adding more S&P 500 to a portfolio made up of the S&P 500 does nothing. The length of any leg reflects correlation of that asset class to the portfolio. Longer legs indicate less correlation, which in turn suggests the potential for diversification benefit. A portfolio that is highly correlated to a single asset class will exhibit a very short “leg” for that asset class. A portfolio that is perfectly correlated to an asset class will exhibit a leg of zero length—so the observer can immediately tell that this portfolio is simply a large cap domestic stock portfolio.

There are two very distinct ways that a portfolio can outperform. One is for the portfolio to be concentrated in the asset class that has outperformed all others over some period. Given a universe of investors randomly selecting a single major asset class in which to invest, and considering 10 major asset classes, 10% of investors will outperform each year. This outperformance is due to luck. In the case of a 100% investment in the S&P 500 (element 4), we see this high concentration in domestic large cap stocks via the leg of zero length for the S&P500 as an asset class. A portfolio that generates high risk adjusted returns through superior asset allocation will exhibit high return relative to risk (i.e., high mean return vs. standard deviation) on the portfolio compass chart but also exhibit legs to the various asset classes that are relatively long.

Investing in S&P500 Index Fund for Jan. 1, 2000-Jan. 1, 2002

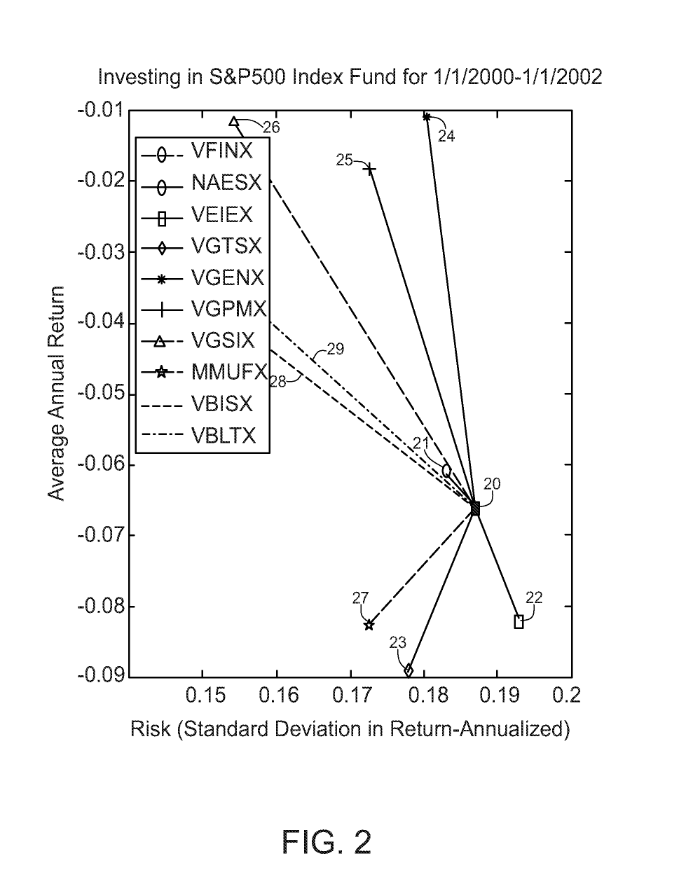

The chart in FIG. 2 shows the performance of the same S&P 500 index fund portfolio 20 depicted in FIG. 1 over the next two years i.e., Jan. 1, 2000 through Jan. 1, 2002. Sure enough, reversion to the mean prevails and this portfolio 20 has declined substantially. Now, the addition of six of the aforementioned asset classes (21, 24, 25, 26, 28 and 29) would all have increased return and lowered risk! This portfolio 20 is so much weaker than any of the modified portfolios (21-29) that we can see that momentum is towards the downside.

The research on momentum effects shows that asset classes that are in the top cohort of a group tend to outperform for some period of time (on the order of one year). Given that most of the asset classes would have improved this portfolio 20 (six modified portfolios 21, 24, 25, 26, 28 and 29 point upwards, whereas three modified portfolios 22, 23 and 27 point downwards), the portfolio 20 of large cap stocks has momentum working against it.

Investing in S&P500 Index Fund for Jan. 1, 2002-Jan. 1, 2004

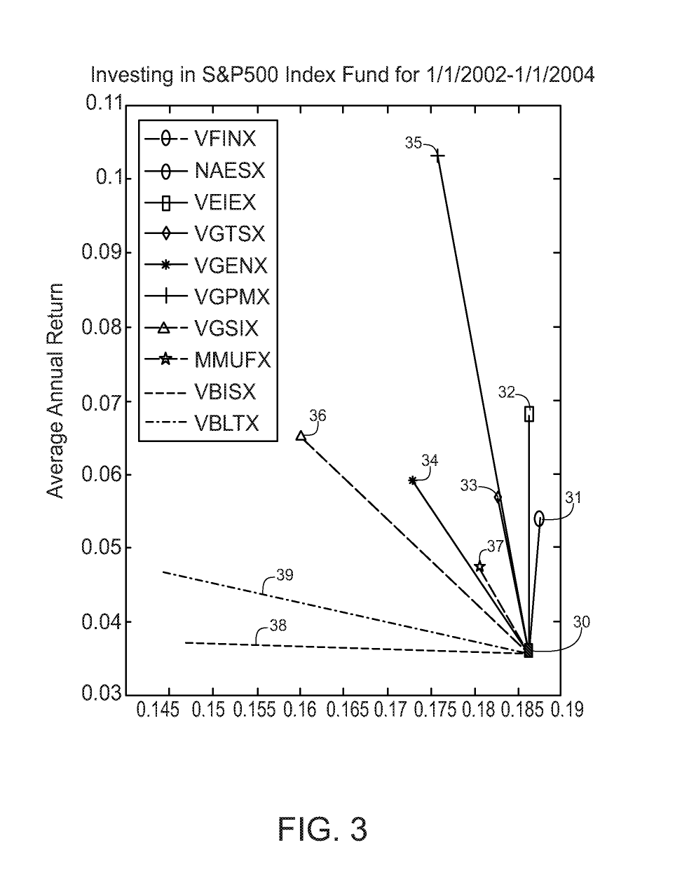

The performance of the same S&P 500 portfolio 30 for the period from 2002 through 2004 is shown in FIG. 3. We can see that downward momentum is stabilizing—the S&P 500 portfolio 30 has bottomed out with respect to all of the other asset classes 31-39. There are no legs of the portfolio that extend below the current portfolio 30—every modified portfolio 31-39 increases return, reduces risk, or both.

Investing in S&P500 Index Fund for Jan. 1, 2004-Jan. 1, 2006

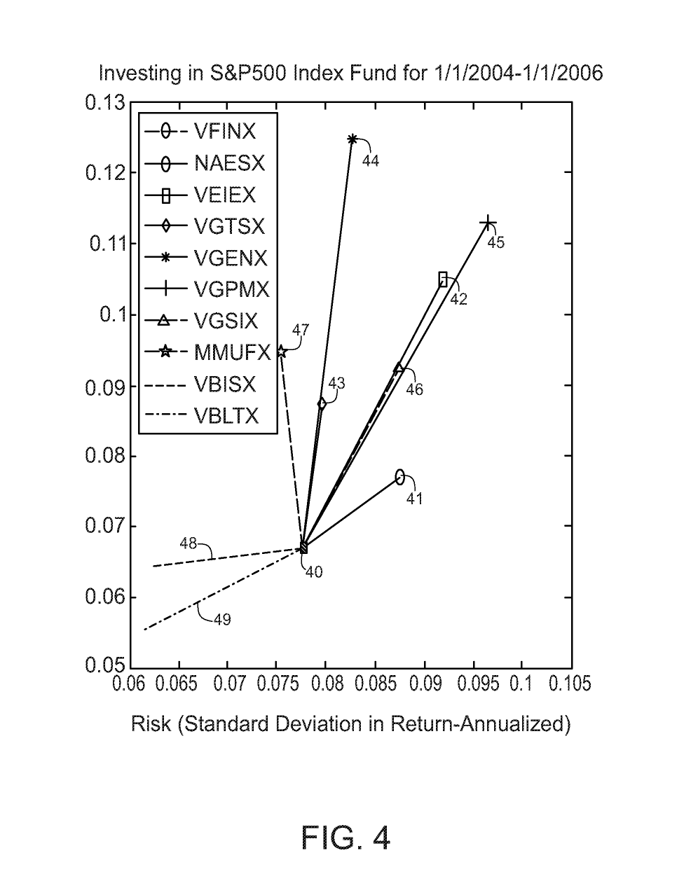

For the 2004-2006 period shown in FIG. 4, the same S&P 500 portfolio 40 still had fairly anemic returns, but there was no way to add return (with one exception) to the S&P 500 portfolio 40 without also adding some risk—the legs (41-46) of the star that increase return also increase risk (i.e., the ones that increase vertically 41-46 also increase horizontally). The one exception is utilities 47—and this remains a consistent pattern. This persistent effect with utilities 47 provides evidence in favor of fundamental weighting in a portfolio. For this period, the portfolio 40 is clearly improving—because one cannot add return with out also adding risk—but the increased return for a small increase in risk shows that the current portfolio 40 is out-of-favor. Even as things have improved, the outlook for this portfolio 40 is not great.

It is clear that adding energy stocks (VGENX) 44 and international stocks (VGTSX) 43 would both have dramatically improved the performance of this portfolio 40 over the past two years (the portfolios 43, 44 with these added to the portfolio 40 have generated dramatically more return with minimal increase in risk). While this does not mean that this trend will continue, it is clear that these asset classes have the potential to substantially improve this portfolio 40. In fact, every asset class (except two 48, 49) improves this portfolio 40, which suggests that just being in the S&P500 is not a good place to be. Reversion to the mean may work in favor of the S&P500, but the relative performance of the S&P500 40 is so far below other asset classes 41-49 that there is an implicit warning.

Investing in S&P500 Index Fund for Jan. 1, 2006-Jan. 1, 2008

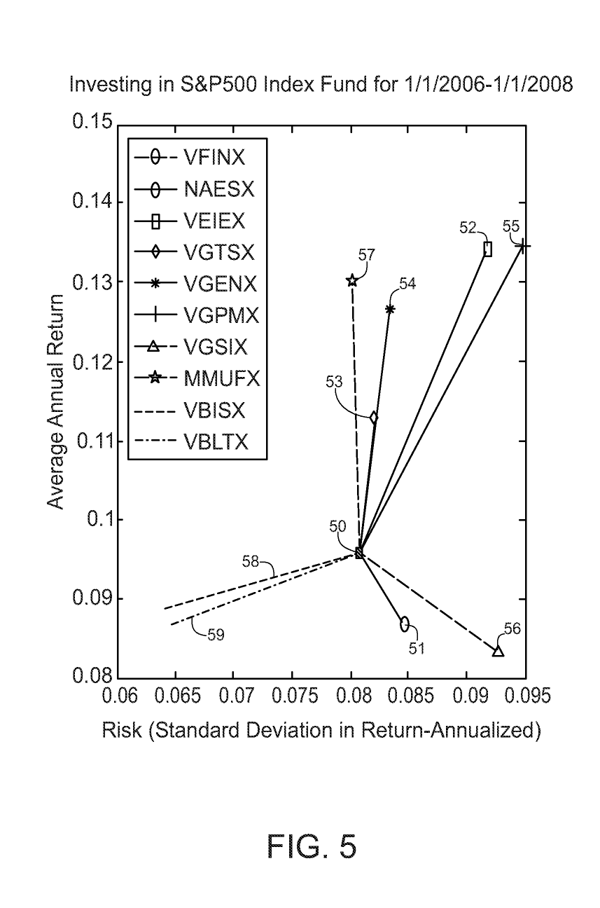

In the 2006-2008 period shown in FIG. 5, things have improved—the current portfolio 50 has delivered more return with less risk than four (51, 56, 58 and 59) of the modified portfolios and the incremental improvement from adding other asset classes has diminished (there are shorter legs on the star). Still, this pattern, as measured by relative performance to other asset classes, sees the S&P 500 portfolio 50 on an improving trajectory, but still quite far from upward momentum.

There is a cycle that can be observed in any portfolio's performance that shows up quite clearly, as will be seen as we go through a series of examples.

Before expanding into the examples, several points bear discussion. First, this graphical mapping of a portfolio captures a great deal of key information about the portfolio. This information is diagnostic, but also motivates the key potential sources of risk and reward, as the later example show.

A portfolio that is a pure sector bet on momentum is clearly indicated and has a very different signature than a portfolio that generates high return due to effective exploitation of diversification effects.

Second, one can compare portfolios of any make-up to any other. A portfolio's characteristics can be diagnosed by seeing how it responds to increased allocations to a set of core asset classes. To show the evolution of a portfolio over time, the portfolio compass may be animated, which would capture the impact of temporal evolution. Short of animation, one can show the portfolio compass in several panels through time, as will be shown in examples below.

In such an animation, a revolution of the legs around a center point of the fund indicates a well-diversified portfolio.

### The Portfolio Compass as a Decision Tool

The core of the portfolio compass concept is that one can learn a great deal about a portfolio, fund, or folio by looking at how the portfolio responds to adding allocations to one of a number of asset classes. The sensitivity of the portfolio to these perturbations provides insight into the underlying portfolio and its future prospects.

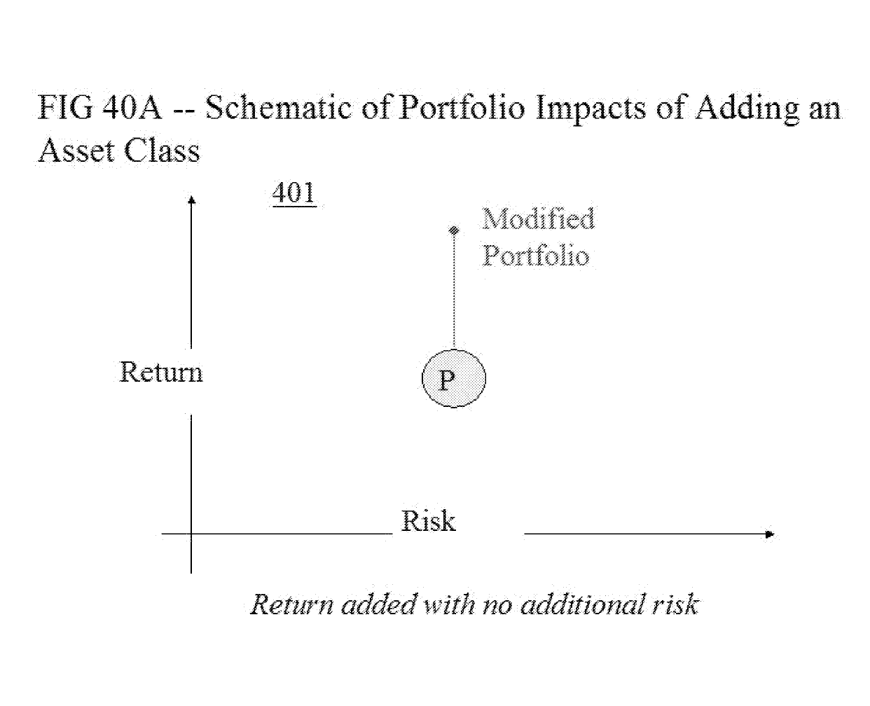

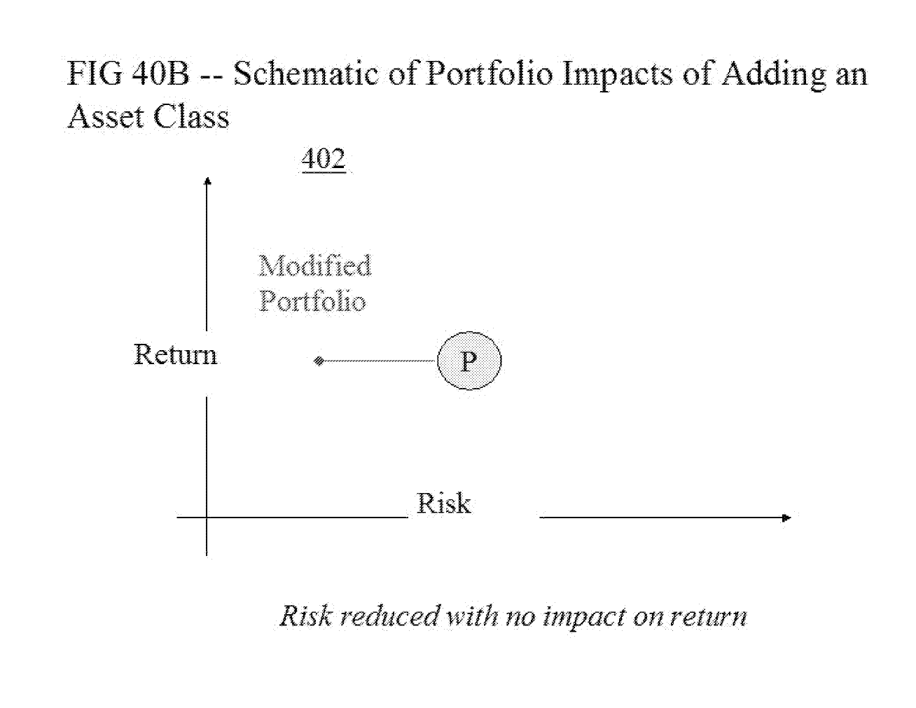

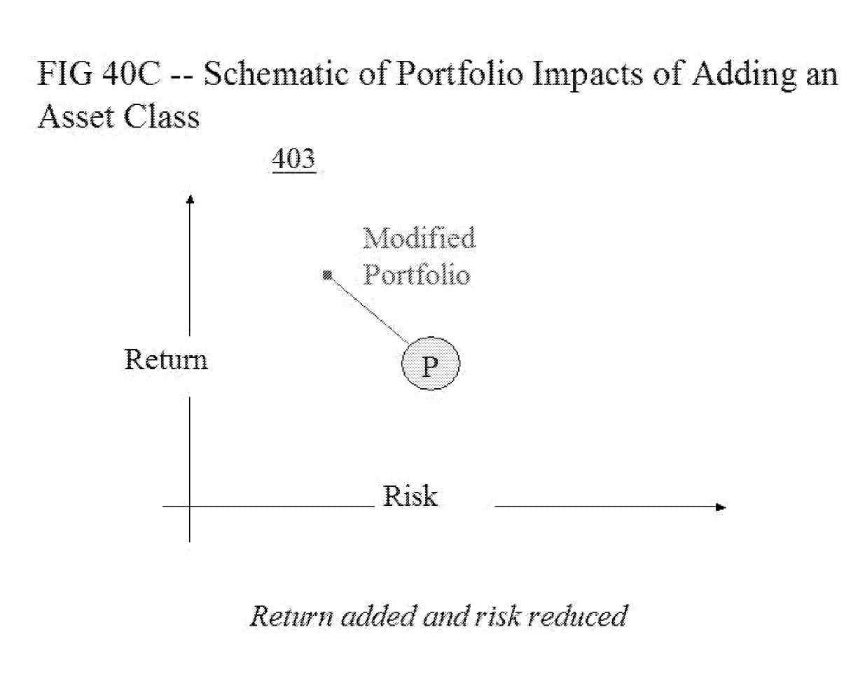

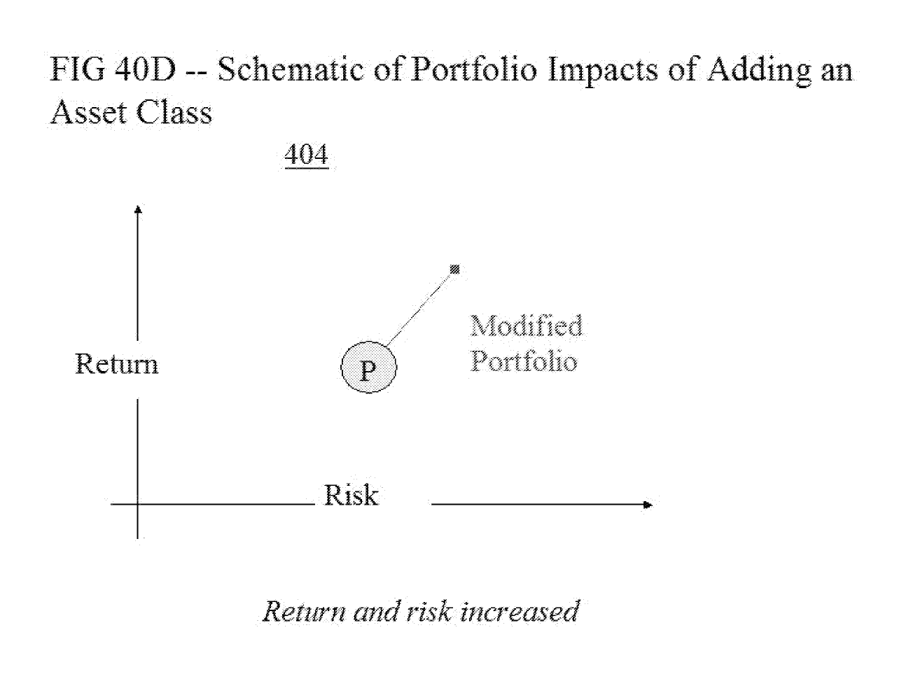

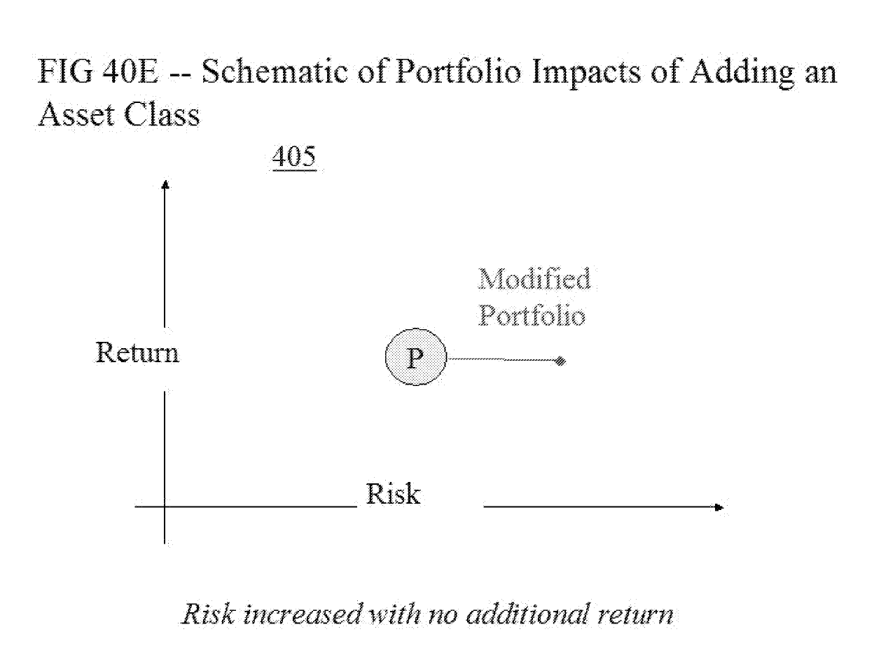

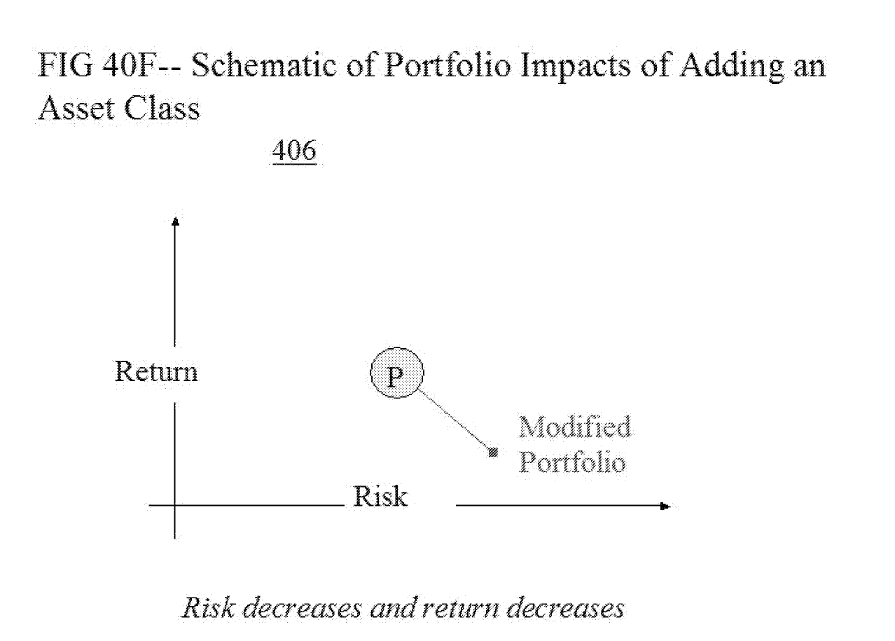

FIGS. 40A-F depict schematics of the impacts on a portfolio by adding a certain asset class. In FIG. 40A, diagram 401 indicates that the modified portfolio added no risk with increased return, whereas in FIG. 40B, diagram 402 indicates that the modified portfolio added no additional return with reduced risk. In FIG. 40C, diagram 403 indicates that the modified portfolio resulted in reduced risk with increased return, whereas in FIG. 40D, diagram 404 indicates that the modified portfolio resulted in increased return with increased risk. In FIG. 40E, diagram 405 indicates that the modified portfolio had increased risk with no impact on return, whereas in FIG. 40F, diagram 406 indicates that the modified portfolio had increased risk with decreased return. The shorter the ‘leg’ associated with an asset class, the more similar the portfolio is to that asset class. A portfolio that that simply invested in one of the core asset classes will have a leg of zero length from the center of the ‘star’.

A key indicator in the portfolio compass is simply how many of the perturbed portfolios had outperform the portfolio under analysis. If the portfolio has outperformed all of the modified portfolios, momentum was a key driver, for example. A portfolio for which some modified portfolios outperformed the portfolio under analysis and some modified portfolios underperformed the portfolio under analysis indicated the portfolio under analysis was more likely to be diversified. This finding points to a single metric: how many of the modified portfolios outperform the portfolio under consideration?

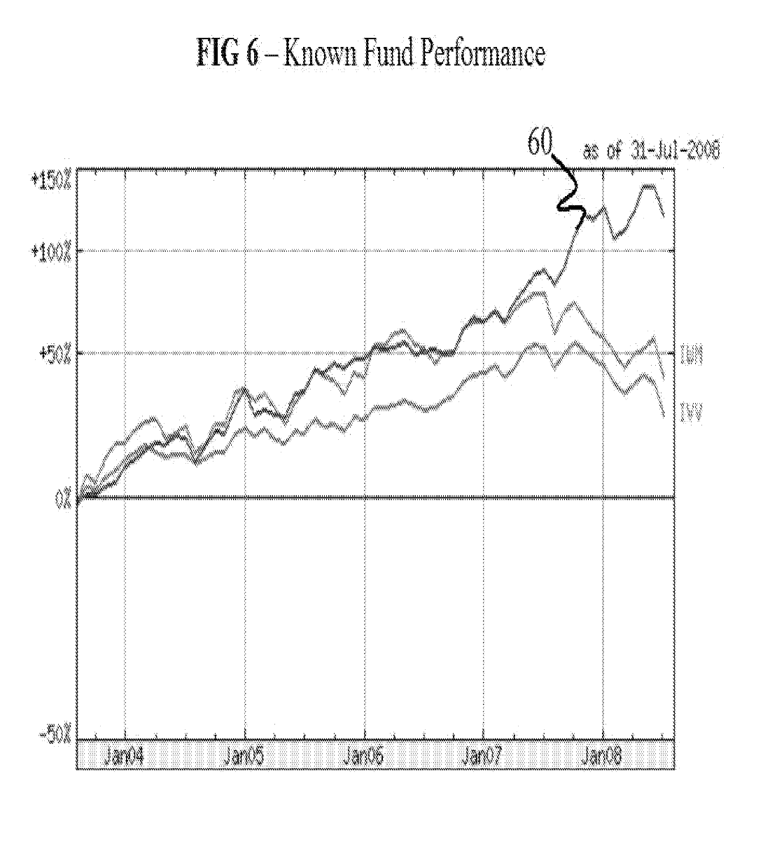

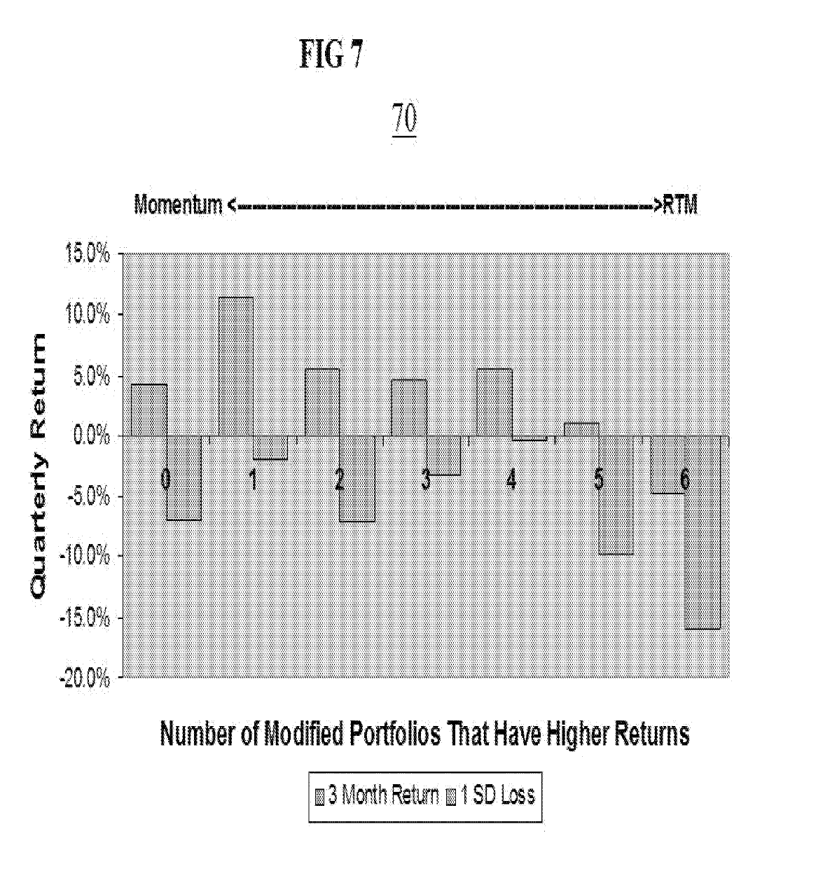

As a first example, we will look at a known fund 60, the performance of which over time is shown in FIG. 6. This known fund 60 is a concentrated equity mutual fund, which holds most of its assets (80%) in twenty to thirty stocks. Morningstar gives this fund 60 a five-star rating.

We want to see whether the performance of this fund 60 can be judged by how many asset classes have led to out-performance in a trailing period. For the initial model tests, we looked at 20% allocations to one of six asset classes (rather than ten previously). The six core asset classes are:

Large cap domestic equities (VFINX)

Small cap domestic equities (NAESX)

Total International Stock Index (we use VGTSX)

REIT's (VGSIX)

Energy (VGENX)

Short-term bonds (VBISX)

As before, we have used a long-lived index fund as the proxy for the asset classes—the ticker used follow each asset class. We are using twelve years of trailing data, unless otherwise noted.

There will be six candidate “perturbed” or “modified” or portfolios, in which 80% of the portfolio is allocated to the portfolio in question and 20% is allocated to one of these asset classes.

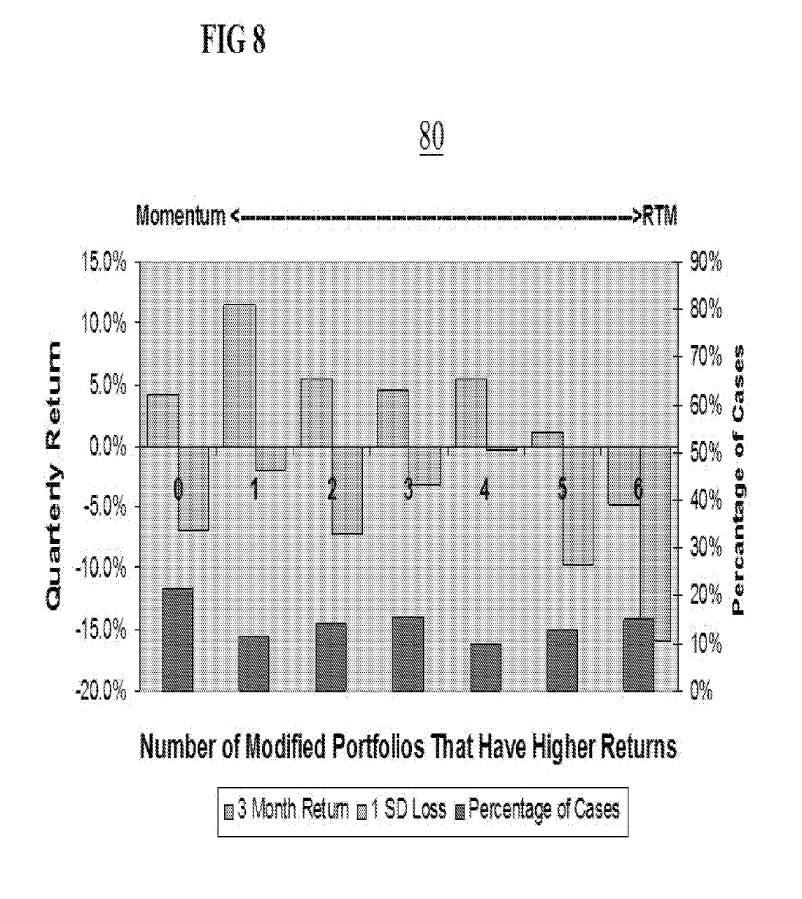

Our test metric is how many of the modified portfolios outperform the original. For the example shown in FIG. 7, we are looking a quarterly performance—both trailing (in assessing the metric) and looking forward to gauge performance. We are using rolling three-month periods, with monthly resolution.

This chart 70 shows the average return for the known fund 60 in FIG. 6 over a three-month period, depending on how many modified portfolios had higher returns than the known fund 60 over the previous three-month period. The chart also shows the one-standard deviation (1 SD) loss under the same criteria.

There are a number of features of this chart 70 that are notable. First, most of the performance of the known fund 60 is skewed towards momentum. After a quarter in which very few (or no) modified portfolios outperform the known fund 60, the known fund 60 tends to generate its best returns. Investing when the known fund 60 has been out-performing is a bet on momentum—and thus the performance of momentum bets is shown on the left side of the chart. By contrast, when most of the modified portfolios out-perform the known fund 60 in one quarter, the next quarter is not likely to be good (see the right side of the chart). A bet on Reversion to the Mean (RTM), i.e., after a quarter in which the known fund has not out-performed most of the modified portfolios, has not (historically) provided good results. There is one aspect in which RTM predicts the performance of the known fund 60 on short time horizons: a quarter in which the known fund 60 is in State 0 is one in which it has massively out-performed. The subsequent quarter does not provide particularly good returns. The best times to buy the known fund 60 are when it is outperforming, but not massively so (State 1 or 2).

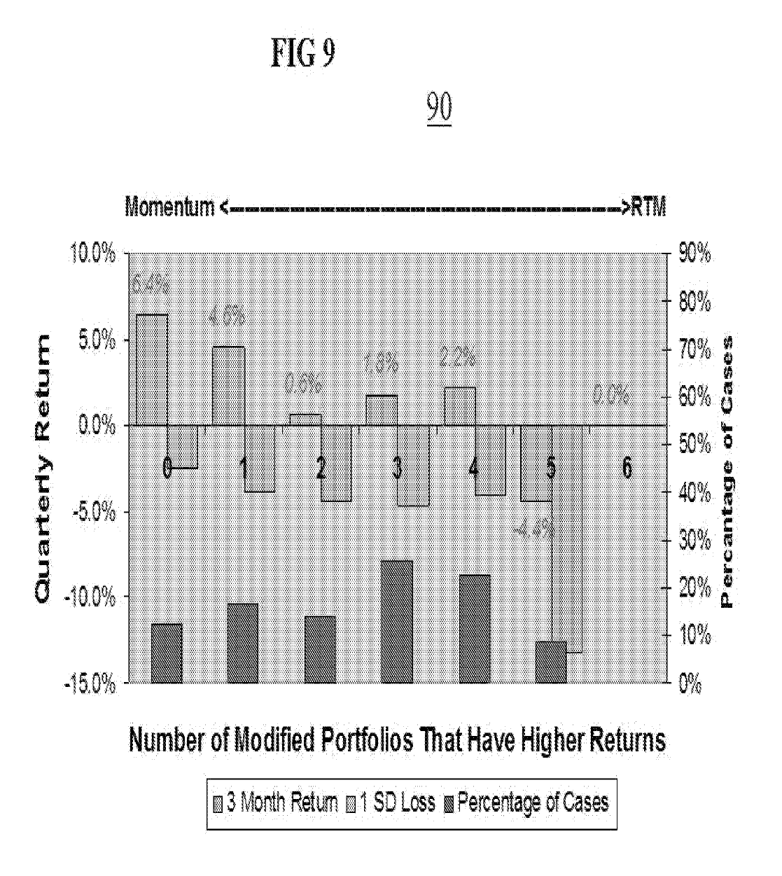

There is an important piece of information that we must add to this chart to really nail down the meaning of the data: how likely each state has been. The modified chart is shown in FIG. 8.

What we see is that the known fund 60 has a substantial fraction of its performance that correspond to quarters in which the fund outperforms all modified portfolios (far left) and under-performs all modified portfolios (far right). There is also a peak in percentage of cases which are in the middle. For a diversified portfolio, we would expect to see the peak in the percentages of cases near the middle—a well-diversified portfolio will tend to always have a few asset classes outperforming and a few under-performing. The known fund 60 has the signature of a largely momentum driven fund and is not particularly diversified.

100% VFINX (S&P500 fund)

Let's now look at a simple case of a portfolio invested 100% in the S&P500 via VFINX shown in FIG. 9. This portfolio is clearly quite diversified—notice the peak in the fraction of quarters that are in the middle range in terms of percentage of cases—with tails declining in both directions. VFINX shows a signature of momentum—when VFINX tend to out-perform all other modified portfolios, VFINX will tend to continue to out-perform. VFINX never under-performs all modified portfolios because the S&P 500 is one of our core indices.

What else doe this chart show us? First, it is unwise to try to bet on reversion-to-the mean for the S&P 500 relative to other asset classes. When five of the modified portfolios out-perform the S&P 500 as a standalone over the previous quarter, the next quarter is not likely to be good (see category 5).

60% VFINX and 40% VBIIX

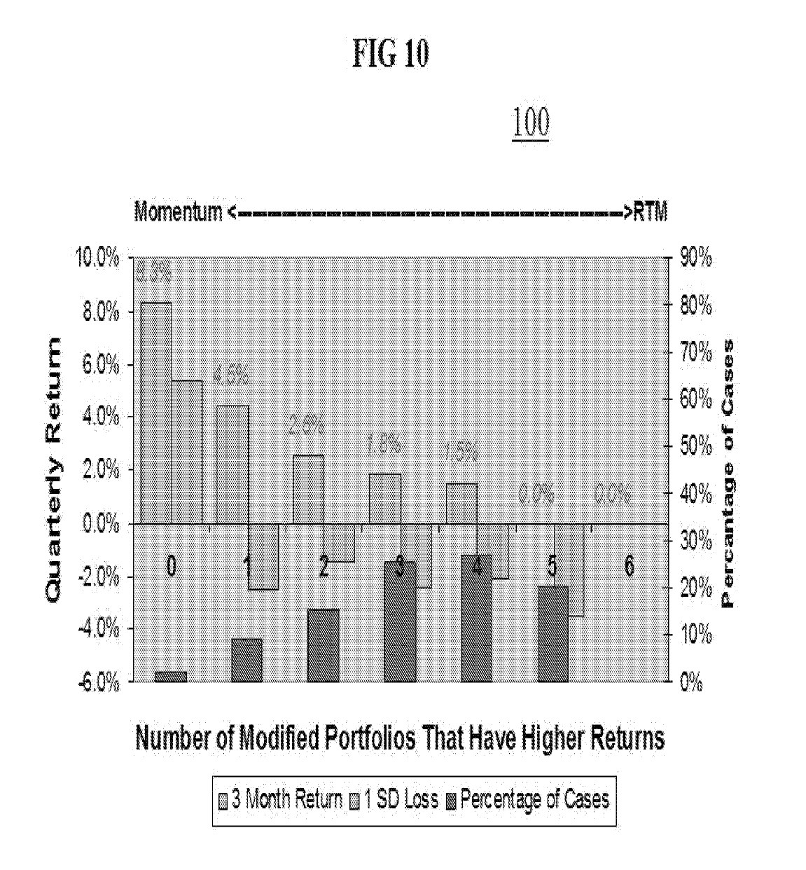

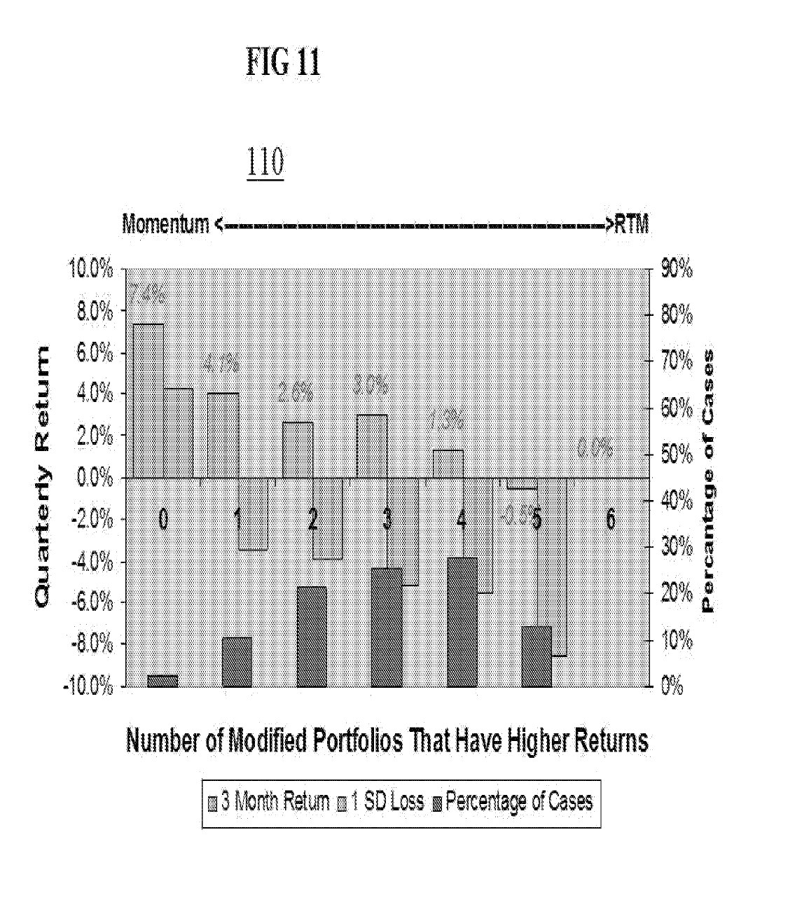

What about the classic benchmark, the 60/40 (60% S&P500 and 40% bonds)? See FIG. 10. The probability that the 60/40 portfolio will out-perform all of the modified portfolios is very small, but the portfolio is likely to out-perform in the next quarter if this occurs. Most of the time, three or more modified portfolios will out-perform the 60/40—and this suggests the potential for more diversification benefit.

Portfolio that is Half in VFINX and Half in VGTSX

Let us next examine a case of diversifying the portfolio between VFINX and an international index fund, VGTSX (see FIG. 11). We now see a very clean signature of a diversified equity portfolio. There are clear momentum effects (with regard to the other sectors), and the probability of the different states shows a strong peak, with tails declining on both sides. These data suggest that buying this mixed portfolio during periods with poor performance in recent quarters is not likely to yield superior performance.

The reader should bear in mind that the results in this section have looked only at the short-horizon signal from the portfolio compass: a three-month outlook. The same general principles are used to generate outlooks on other time horizons.

Exemplary Embodiment of Analytical Tool for Generating Plots Shown Herein

The present invention includes a computerized tool for generating the portfolio compass plots and other graphs shown herein. This tool generates all of the statistical analysis shown previously. The tool allows the user to specify:

The portfolio to be analyzed;

The “core assets” to be used in testing the current portfolio;

The look-back period to be used to calculate the compass and related statistics; and

The forward projection period for which outlooks are generated.

While we used ten core asset classes in the prior discussion, for simplicity purposes we used six asset classes in this portion. Users of the tool can specify how many core asset classes to select, and the core assets classes. The number of asset classes is not limited to six or ten, but can be any other number. At a certain point, the information provided from too many asset classes can be redundant. Alternatively, using too few asset classes may miss important information. The inventor has determined that six or ten provide useful information.

The present invention includes a batch testing mode for the portfolio compass as a predictive tool, in which we can specify a universe of mutual funds for item and the remaining variables and the tool will run every single fund on a monthly rolling basis and calculate for each month:

The “state” of the fund at a given date (using the look-back period of history); and

the subsequent return of that fund in the future period.

The State of a fund is defined as the number of modified (perturbed) portfolios that beat the fund in the look-back period. State zero means that no modified portfolios beat the fund in question. State N means that N of the modified portfolio beat the fund in question. The model steps through history, one month at a time and compiles the statistics. The output statistics allow use to calculate the following for each fund:

The average return for a fund following being in each state;

The risk level for a fund following each state; and

The historical probability of being in each state.

With these data for each fund, we can easily aggregate funds in a variety of ways and look at whether the simple approach to using the portfolio compass as a prognostic tool makes sense.

### Results of Large-Scale Testing

We have tested almost 4000 mutual funds which had at least 12 years of historical performance data available with the following inputs:

Six core assets classes

Large cap domestic equities (VFINX)

Small cap domestic equities (NAESX)

Total International Stock Index (we use VGTSX)

REIT's (VGSIX)

Energy (VGENX)

Short-term bonds (VBISX)

3 month look back/3-month projection

6 month look back/6-month projection

12 month look back/12-month projection

The results from these analyses suggest a series of conclusions:

Momentum and RTM both play substantial roles in predicting future performance of a fund;

Momentum and RTM play different roles with different fund types/asset classes/fund styles;

Broadly diversified equity indices behave differently (EAFE vs. S&P500); and

Different styles of sector funds behave differently;

Momentum and RTM play different roles on different time horizons;

Momentum tends to dominate on short time horizons; and

RTM tends to play a larger role on longer time horizons; and

The portfolio compass can effectively characterize funds;

Concentrated vs. diversified; and

Degree of diversification.

Altogether, our results suggest that we have an effective method for capturing the interplay between momentum and mean reversion in a portfolio. This method appears to have meaningful prognostic value for investment strategy. Further, our results suggest that the commonly-applied momentum-based strategies are missing a large amount of useful information.

### Case Studies

In this section, we will look at some specific cases from the operational tool and explain them in depth.

Case 1: Ford Dec. 31, 2007, 12-Month Prediction

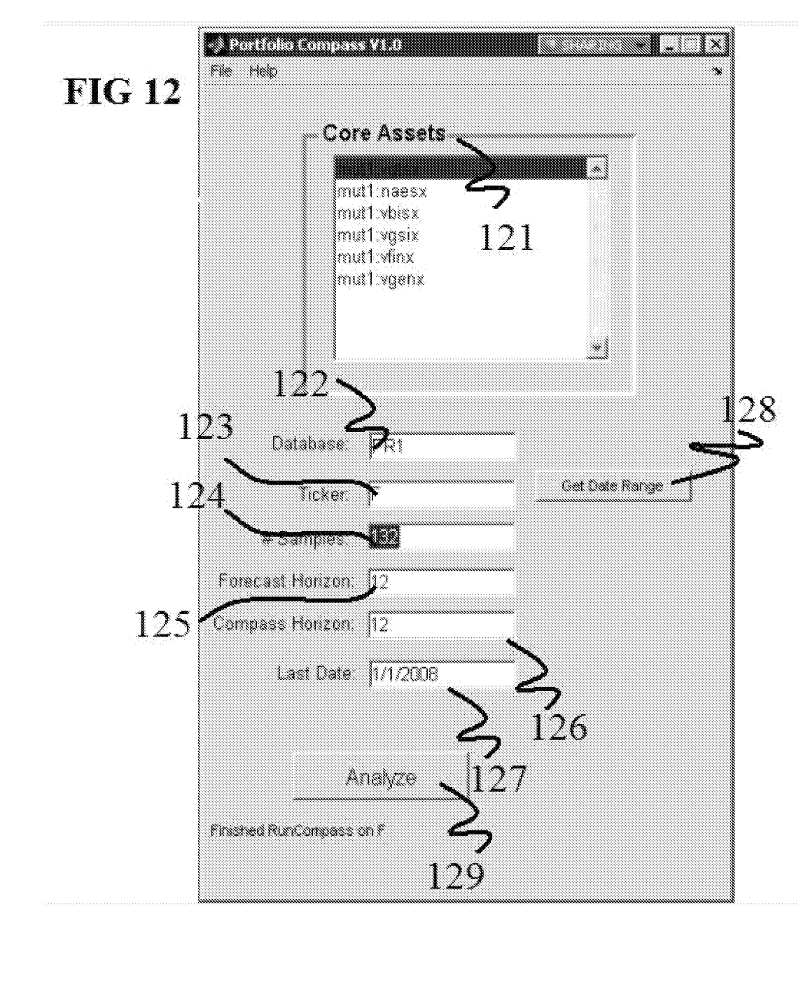

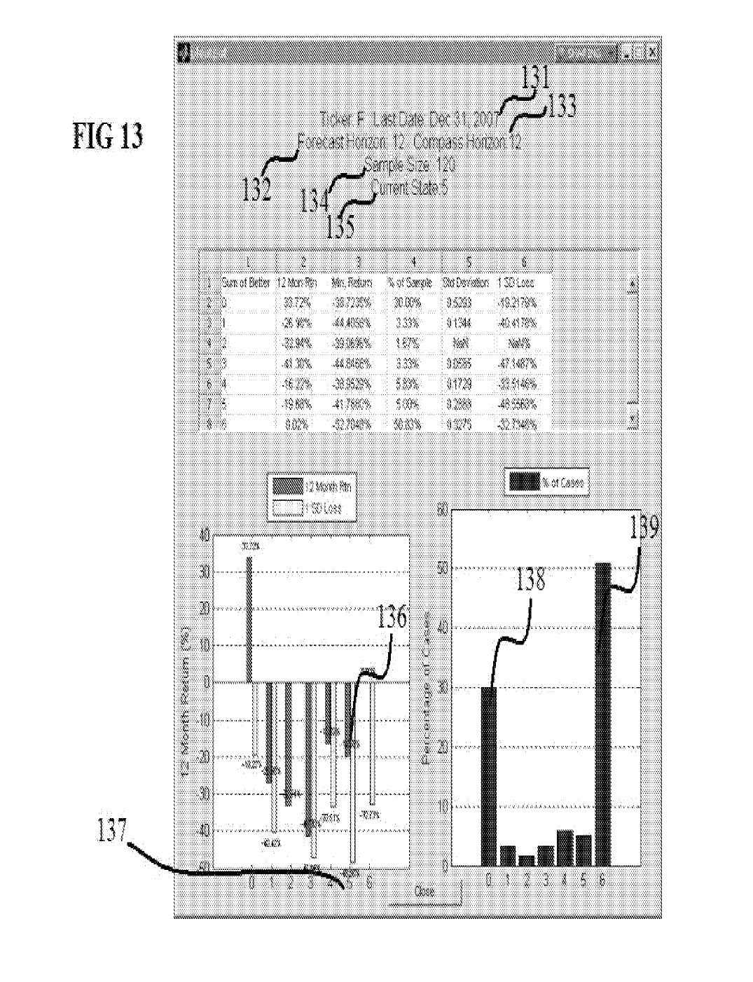

In this example, we generated a twelve-month outlook for Ford Motor Company (F), with a twelve-month look-back period. We constrained the tool to use data available only up to and including Dec. 31, 2007. The input screen is shown in FIG. 12.

We have chosen to use six core asset classes 121, and the Database 122 used for the historical market data is called PR1, which is from where the historical stock data can be found). The ticker 123 for Ford is F. We used eleven years (132 months) of data 124, and this was chosen so that one could have ten years of test data (the first twelve months being used to generate parameters for the first forecast 125). More data is good as it provides more samples for the model. We used twelve years of data 126 in our validations. The model uses monthly data, so having the Last Date be Jan. 1, 2008 means that the model had Dec. 31, 2007 as its final data point 127. Button 128 can be used to select specific date ranges from a menu of choices. Button 129 initiates the analysis.

This chart in FIG. 13 shows the output. In the text at the top of this screen, we have the following information:

Last date 131 for which the model had access to data: Dec. 31, 2007. This means that the output shown here is what the model would have projected for calendar year 2008. The model is projecting for a twelve-month horizon 132. The sample size 134 is 120 samples. The compass horizon 133 is twelve. Ford is currently in State five 135.

When you look at the chart in the bottom left side of the screen, at element 136 you see that Ford has historically delivered average returns of −19.7% for the twelve-month period after having been in State Five. The one-SD loss 137 (the One Standard Deviation loss) is a measure of the typical downside—and this is −48.6%. In other words, the historical performance of F after being in State five is very poor for the next twelve months.

The only state in which one might want to buy Ford is State Zero. When Ford is in State Zero, the next twelve months have averaged more than 33% return. This means that Ford is a pure momentum play. When Ford is in State Zero, it means that Ford has out-performed all modified portfolios that add in the other asset classes—Ford has been on a run-up. This is the only time to bet on Ford.

The chart on the bottom right shows the amount of time that Ford has spent in the various states. Ford spends most of its time in State Zero 138 or State Six 139—Ford either substantially outperforms everything (State 0) or it substantially underperforms (State 6). This is the standard signature of a highly concentrated portfolio—and a portfolio containing one stock (Ford) is highly concentrated. A diversified portfolio shows the mirror image of this chart—spending most of its time in the middle and little time in States Zero and Six. A diversified portfolio has a mountain shaped chart. A concentrated portfolio has a canyon shaped chart.

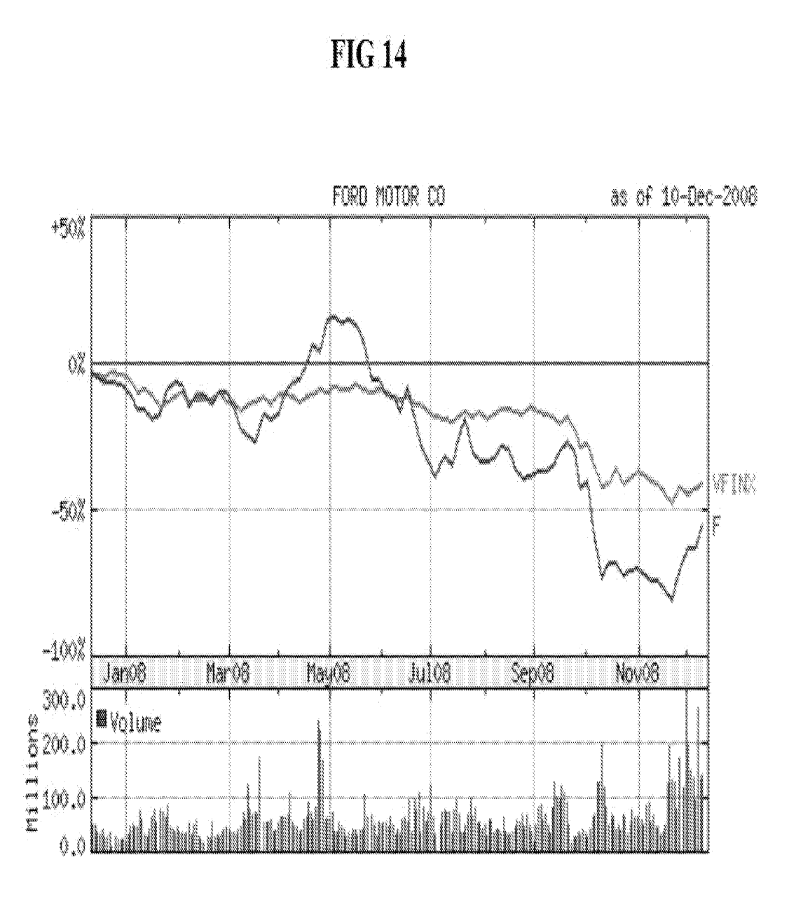

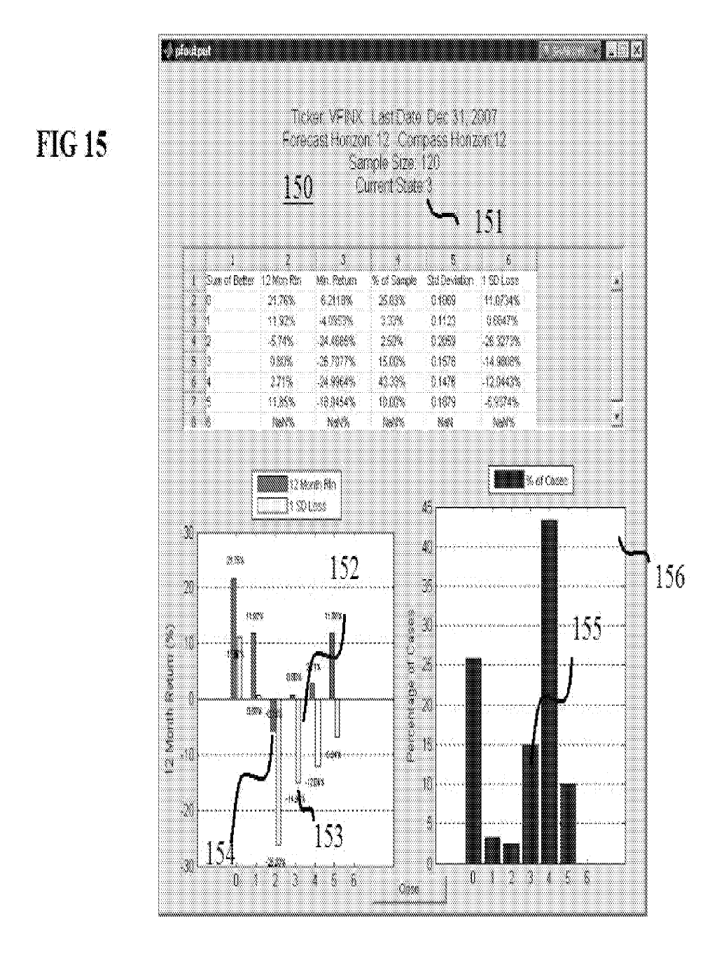

So, the model would have told us that 2008 is not going to be a good year for Ford, and FIG. 14 shows 2008 was in fact not a good year for Ford.

Case 2: VFINX Dec. 31, 2007, 12-Month Prediction

VFINX is the Vanguard S&P 500 index fund. We performed an analysis showing what the tool would have shown as of Dec. 31, 2007, i.e., the outlook for 2008 (see FIG. 15). The current state for VFINX as of the end of 2007 was State Three 151 (see text at top of screen). In State Three, the S&P 500 has averaged 0.8% (less than 1% in return) 152 over the subsequent twelve months. The one-SD loss has been −14.98% 153. This means that investors who put their money into VFINX in this state have averaged less than 1% in return for the next year, and not infrequently lost 15%. The only worse state to buy VFINX is State Two 154.

When do you want to buy VFINX? States Zero and One are goods times to buy VFINX as they average substantial returns over the next twelve months (i.e., 21.8% and 11.9%). This is a momentum play. State Zero and State One mean that the S&P 500 has been doing very well relative to other asset classes for the last twelve months and this performance tends to persist. State Five is also a good time buy into the S&P 500 and this is a bet on recovery. When the S&P 500 is in State Five, the S&P 500 has been lagging all other asset classes, i.e., under-performing—and the next twelve months is typically quite good—averaging 11.9%.

As of the end of 2007, the S&P 500 was under-performing some of the core asset classes and out-performing others, hence being in State Three. Calendar year 2007 was not a terrible year for the S&P 500, just moderately bad. These results show us that the model would have forecasted that 2008 was not going to be a good year for the S&P500!

The analysis shows that the S&P500 exhibits both momentum effects and mean reversion effects on the twelve-month horizon.

Look now at the chart 156 on the bottom right side of the screen 150. The most common state in which to find VFINX is State Four 155—and all other states have lower odds of occurring. This is a characteristic of a diversified portfolio. We also have a peak in State Zero, however, which is created by the fact that market cap weighted indexes such as the S&P 500 have are tilted towards growth stocks. This result also suggests that the S&P 500 is not a fully diversified portfolio of stocks. There is too much dependence of momentum effects for this to be the case. A fully diversified portfolio is less dependent on momentum.

Case 3: General Electric Dec. 31, 2007, Twelve Month Prediction

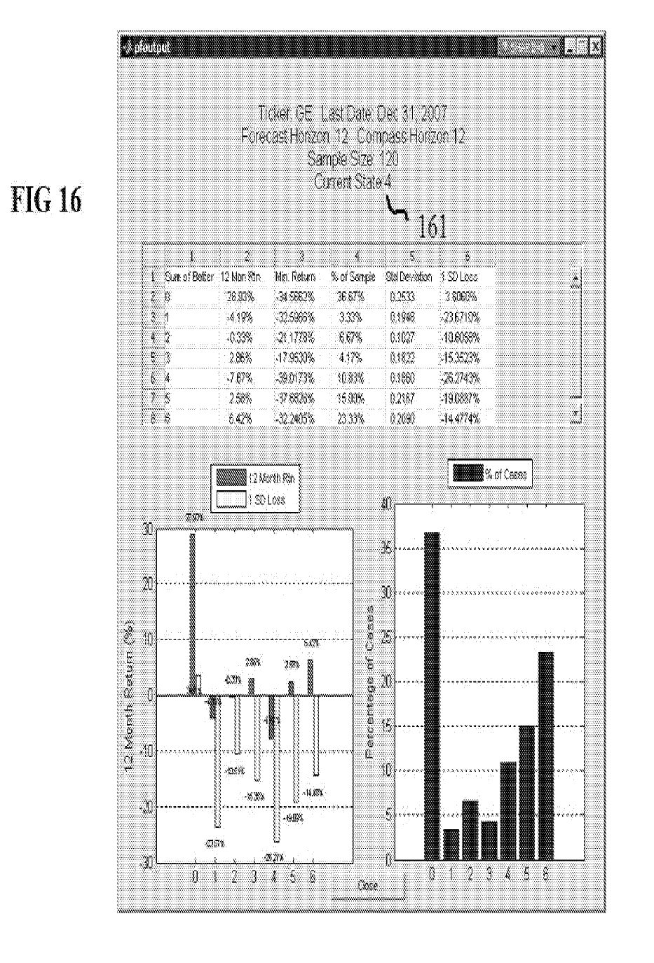

This is a similar case, but for General Electric (GE). We are looking at what the model would have shown us at the start of 2008. The current state at that time was State Four 161 as shown in FIG. 16.

State Four has historically been the worst time to buy GE in terms of average return and risk (as measured by the one-SD downside). The best time to buy GE is when it is in State Zero—GE appears to be dominated by momentum effects. The second-best state in which to buy GE, however, is State Six. State Six means that GE has substantially under-performed, i.e., GE has under-performed all of the core assets. Buying in State Six is a bet on reversion to the mean: history suggests that GE has generated moderately good returns following a year of substantial under-performance.

The lower right-hand chart shows how many of our historical periods have been in each state. The signature is of a highly concentrated portfolio (the plot resembles a canyon rather than a mountain) but the plot is notable in that the canyon is less steep—there are more historical periods in the middle states—than we saw with Ford. This can be attributed to the fact that GE is far more diversified as a company than Ford. GE is a single stock, but the company has many divisions in a range of industries. Ford, by contrast, does not. This means that adding GE to a portfolio confers more diversification benefit than adding Ford, all other things being equal.

The result that GE performs well in only one or two states does not mean that GE may not be a long-term holding in a portfolio if it is combined properly with other stocks. The key is the total portfolio. GE is clearly a potentially attractive investment for market timers, those investors who buy and sell to try to exploit the dynamics of a stock's price.

### Exemplary Embodiment

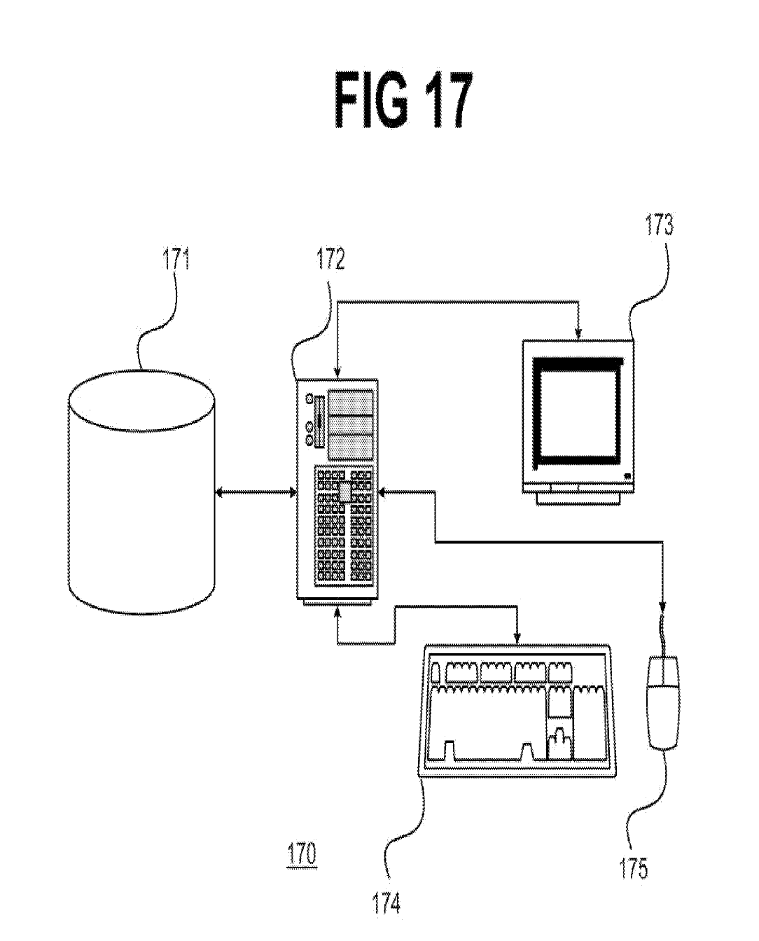

Turning to FIG. 17, an exemplary embodiment of an apparatus 170 used for generating the portfolio compass statistics, plots and related graphical output includes a database 171, a computer/server or processor 172 and a user interface, including a monitor 173, a keyboard 174 and a mouse 175 along with a program executing either on a local computer to which the monitor is connected or a remote server via a network or the Internet.

The database 171 stores historical closing prices for stocks and funds. The data stored in the database 171 comprises adjusted closing prices so that the effects of splits and reinvested dividends are included in the data.

The computer or processor 172 is used to retrieve the historical pricing data from the database and to perform the calculations set forth herein. Any standard computer will suffice; however, a Pentium III processor with 1 GB of RAM should suffice to perform all necessary calculations. Other implementations for the computer are possible.

The user interface enables a user to input the portfolio or investments of interest, the amount of historical data to be used in the calculations and the forecast period. Any standard monitor, keyboard and mouse or other pointing device should suffice. Of course, other implementations are also possible.

The expression of the algorithms and the subsequent calculations can be performed in Microsoft EXCEL and in MATLAB. These calculations can also be performed in code, such as JAVA. The underlying algorithms do not depend on the specific code (e.g., JAVA, C++) or development environment (e.g., EXCEL, MATLAB).

The user interface provides the user with access to the input and output of the model. The user interface can be provided in MATLAB or EXCEL, for example.

### Exemplary Embodiment of Method

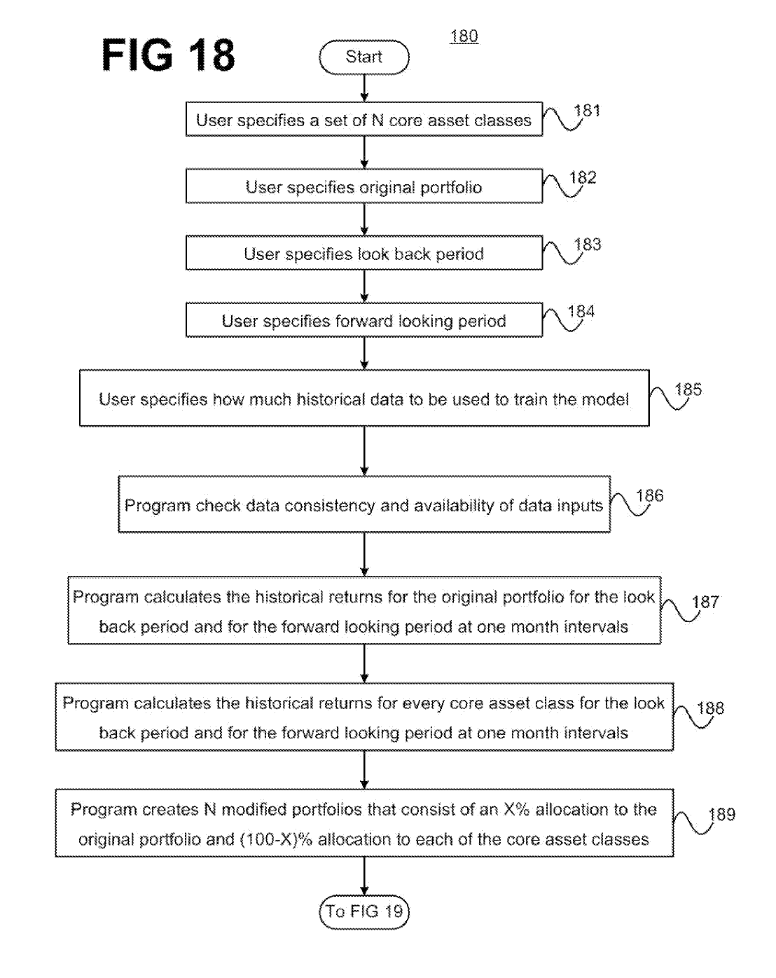

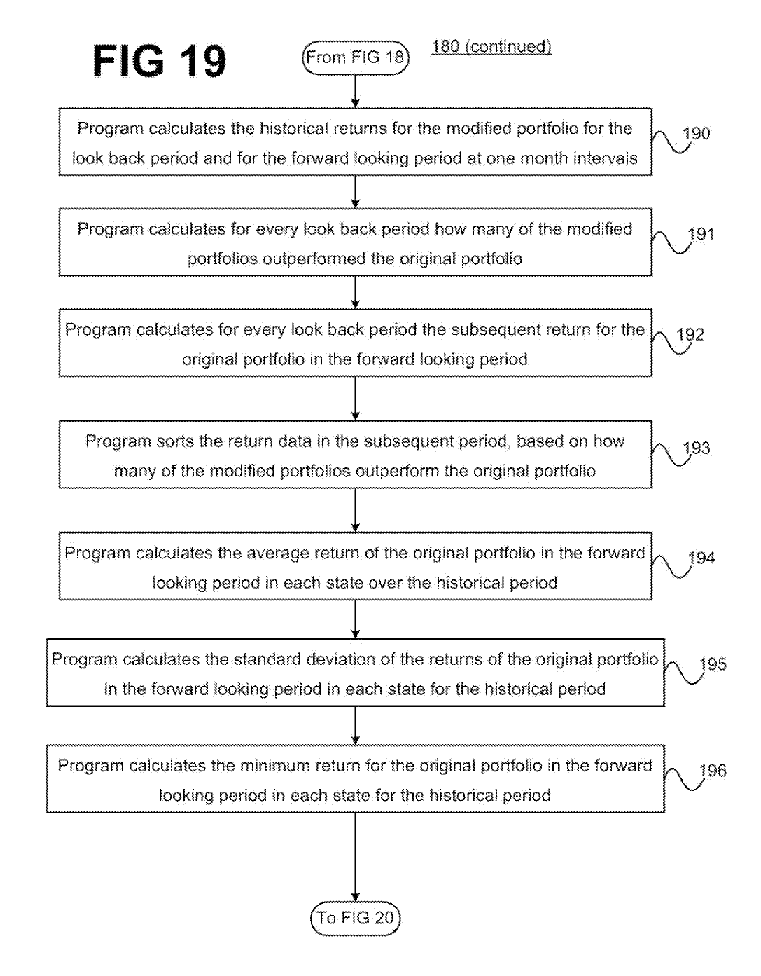

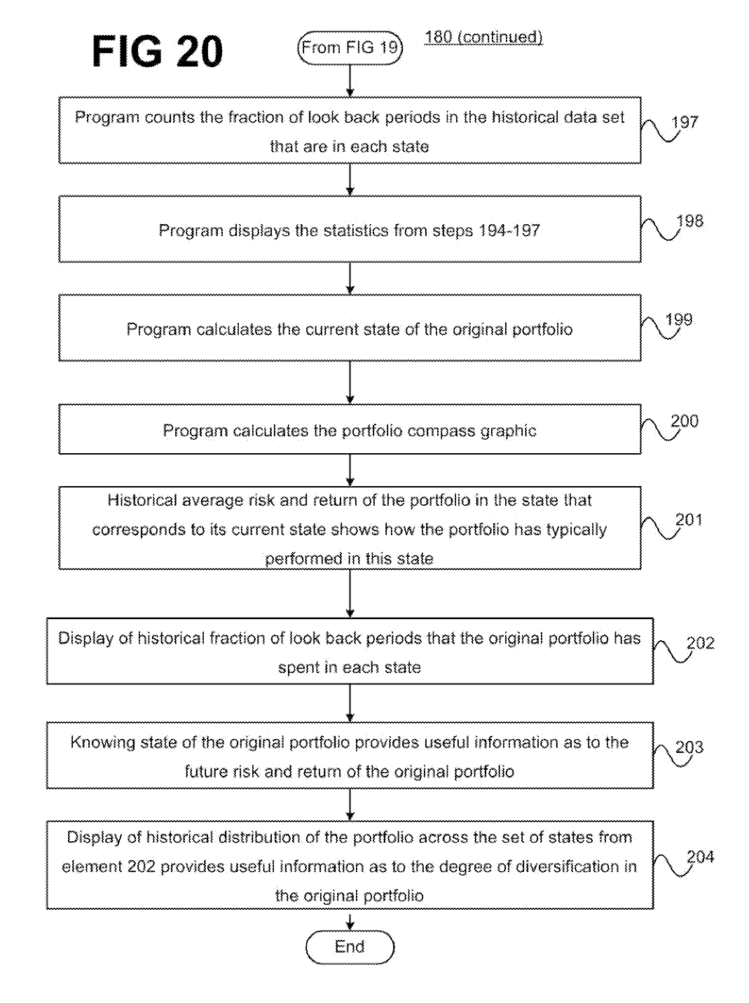

Shown in FIGS. 18-20 is a step-by-step methodology 180 of the present invention.

In element 181, the user specifies a set of N core asset classes (C1, C2 . . . CN). These are in the form of index funds or raw index data. The program will start with different default sets as choices, but the user may specify his/her own set and the number of core asset classes to be used.

In element 182, the user specifies the original portfolio that is to be examined/analyzed.

In element 183, the user specifies the look-back period for the model.

This is the historical time period that is used to predict the forward-looking period.

In element 184, the user specifies the forward-looking period for the model.

This is the period for which the user wishes to have a projection.

In element 185, the user specifies how much historical data to use to “train” the model.

In element 186, the program checks the consistency and availability of data inputs.

In element 187, the historical returns for the original portfolio are calculated for the look-back period and for the forward-looking period at one-month intervals (known as rolling periods).

In element 188, the historical returns for every core asset class are calculated for the look-back period and for the forward-looking period at one-month intervals (known as rolling periods).

In element 189, the program creates N modified portfolios that consist of an X % allocation to the original portfolio and (100%−X %) allocation to each of the core asset classes.

One idea is for the percentage to the core asset class to be relatively small: a perturbation.

We have used 20% allocated to the core asset class in most testing, but this is a variable that users may change.

In element 190, the historical returns for the modified portfolios are calculated for the look-back period and for the forward-looking period at one-month intervals (known as rolling periods).

In element 191, for every look-back period, the program calculates how many of the modified portfolios out-performed the original portfolio.

In element 192, for every look-back period, the program calculates the subsequent return for the original portfolio in the forward-looking period.

In element 193, the program sorts the return data in the subsequent period, based on how many of the modified portfolios out-performs the original portfolio.

We call this count the “state” of the portfolio

The “state” can have values from 0 to N

State 0 means that the original portfolio has out-performed every modified portfolio in the look-back period

State 1 means that the original portfolio has out-performed (N−1) modified portfolios in the look-back period

At every point in time for which we have data over the look-back period, we can assess the state of the original portfolio

In element 194, the program calculates the average return of the original portfolio in the forward-looking period in each state over the historical period

In element 195, the program calculates the standard deviation of the returns of the original portfolio in the forward-looking period in each state for the historical period

In element 196, the program calculates the minimum return for the original portfolio in the forward-looking period in each state for the historical period

In element 197, the program counts the fraction of look-back periods in the historical data set that are in each state

In element 198, the program displays the statistics in (14)-(17) in the Graphical User Interface (GUI).

In element 199, the program calculates the current State of the portfolio.

In element 200, the program calculates the portfolio compass graphic

The graphic is a two-dimensional (X-Y) chart.

The horizontal axis is risk (standard deviation in return).

The vertical axis is average return.

The average annual return and standard deviation (risk) in annual return for the original portfolio over the historical period are used to create a point on the chart.

Each modified portfolio's risk and return is used to generate a point on the chart.

A line is drawn from the point for each modified portfolio to the point for the original portfolio.

This constitutes the “portfolio compass” graphic.

In element 201, the user looks at historical average risk and return of the portfolio in the State that corresponds to its current state to see how the portfolio has typically performed in this state.

In element 202, the user looks at the historical fraction of look-back periods that the portfolio has spent in each state.

In element 203, analysis has shown that knowing the state of the portfolio provides useful information as to the future risk and return of the portfolio.

In element 204, analysis has shown that the historical distribution of the portfolio across the set of states (see item 22) provides useful information as to the degree of diversification in the portfolio.

Computerized Rating and Ranking Tool for Portfolios

The present invention includes inter alia a computer implemented rating and ranking tool for portfolios, which is useful for advisors and sophisticated investors as well as novice investors. The computerized interactive tool of the present invention supports portfolio analysis on multiple investment horizons. For example, the computerized tool of the present invention enables investors to exploit momentum effects, mean reversion and other “timing” aspects of portfolio management. As such, the computerized tool of the present invention provides prognostic information. The present invention also provides a very simple but powerful rating tool that allows quick screening of mutual funds, portfolios, index funds, ETFs, baskets of assets, rights or liabilities, folios, etc. This simple tool provides value to mutual fund families in selling their funds (much like Morningstar), as well as enables investors to rapidly filter the universe of their investment choices.

Key Dimensions for the Rating and Ranking Tool

The rating and ranking tool of the present invention displays key information for screening funds or folios. An example of existing rating tools is the Morningstar “star” rating, which comprises a single number, i.e., one dimension of information. Another example of a rating too, is the Morningstar Style Box, which employs two dimensions of information (i.e., Size and Value).

In contrast, the rating and ranking tool of the present invention, employs more dimensions but retains the smallest number of dimensions that capture the key portfolio diagnostics. The rating and ranking tool of the present invention embodies three key dimensions—risk, return and diversification.

These three dimensions represent a basic minimum but complete set of data in of value to investors. For example, a very aggressive investor (i.e., an investor willing to take high risk) may want to find a portfolio that is diversified or non-diversified. The very aggressive investor may want a portfolio that has been doing well in recent years (i.e., one with a previous high return) or one that is beaten down. Conversely, an investor with a preference for moderate risk may seek funds with a range of diversification levels. The rating and ranking tool of the present invention provides the capability for both of these desires.

Portfolio theory suggests that an investor will be best served with a total portfolio that has the highest level of available diversification for the level of risk that the investor chooses. An investor with such a portfolio is said to be on the efficient frontier.

An investor who screens mutual funds to find the funds with the highest returns for a given level of risk will gain additional insight by further screening these funds based on diversification benefits. It does not require a great deal of skill to get high returns over some period of time in an un-diversified fund. To achieve the same levels of return in a diversified fund requires better portfolio design; such a fund cannot simply be a naked bet on a single sector.

The rating and ranking tool of the present invention provides a robust metric for portfolio diversification. The analytics set forth herein capture the degree of diversification in a portfolio. Diversification can be represented as the historical probability that a portfolio would be in a specific “State.” The State of a fund or portfolio is determined by how many “modified” portfolios have out-performed the original fund or portfolio over a trailing time interval. A State of zero (0) means that no modified portfolios have out-performed the portfolio under analysis. The maximum State is determined by the number of core asset classes used for the analysis, for example, one possible number of core asset classes is six thereby providing seven possible States (zero through six), but other numbers are possible without departing from the scope of the present invention.

The historical probability of a fund being in a given State looks like a valley (or “U” shape) for non-diversified funds and like a mountain for diversified funds. As a first case, we will look at some non-diversified funds as listed in Table 1.

TABLE 1

| Ticker | Fund Style |
|---|---|
| KBECX | Technology |
| RYPMX | Precious Metals |
| PRJPX | Japan Stock |
| RFIFX | Intermediate Term Bond |
| TWGTX | Mid Cap Growth |

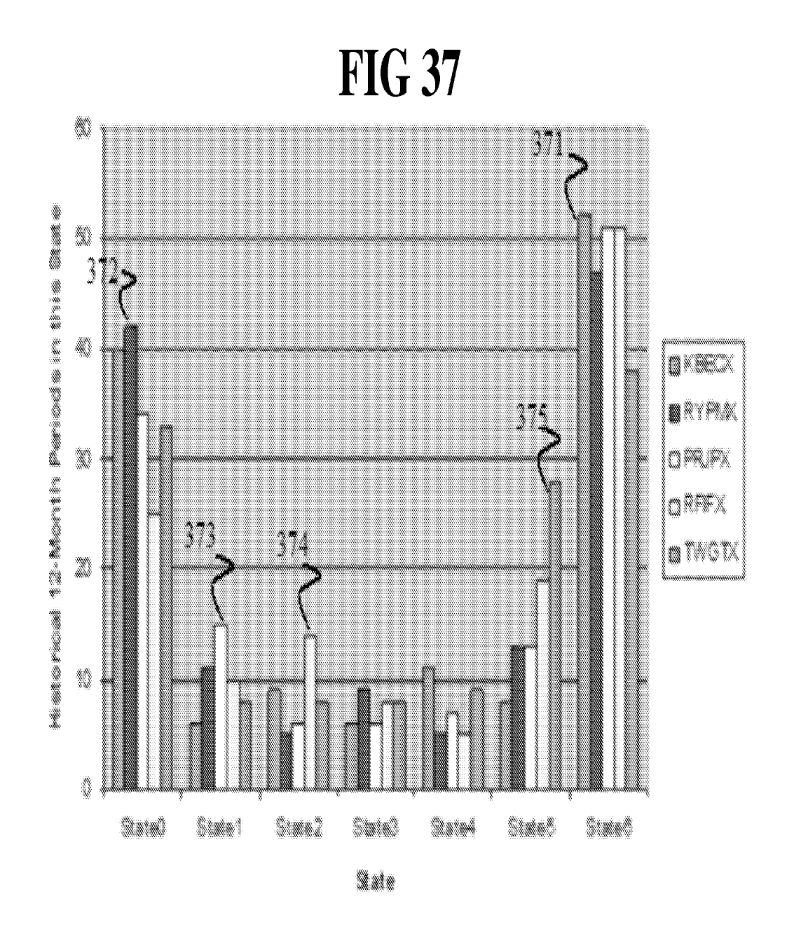

See FIG. 37, which shows the number of 12-month periods the funds in Table 1 were in each State for a given historical period for each of the above funds, in which KBECX=371; RYPMX=372; PRJPX=373; RFIFX=374 and TWGTX=375. As can be seen in FIG. 37, each of the funds in Table 1 exhibits this U-shaped performance with a minimum centered about the middle States.

For diversified funds, we have chosen the following:

TABLE 2

| Ticker | Fund Style |
|---|---|
| MALOX | World Allocation |
| VHAGX | MidCap Blend |
| MUBFX | Large Blend |
| DODGX | Large Value |
| DEIEX | Foreign Large Value |

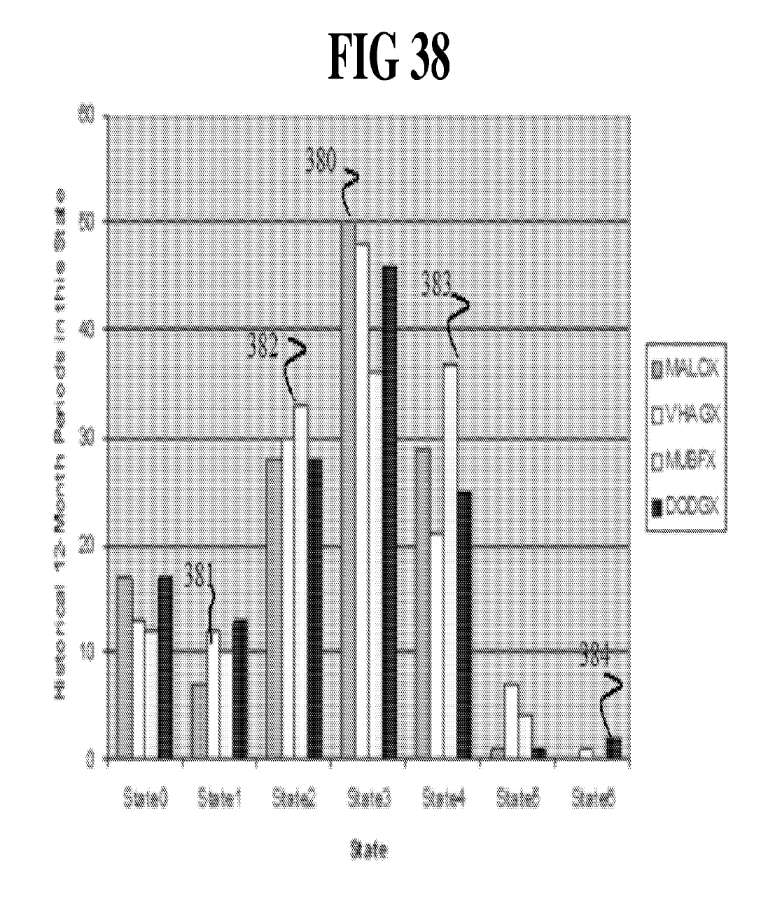

See FIG. 38, which shows the number of 12-month periods the funds in Table 2 were in each State for a given historical period, in which MALOX=380; VHZGX=381; MUBFX=382; DODGX=383 and DEIEX=384. FIG. 38 shows the inverse of FIG. 37, in that now each of the funds exhibits an inverted U-shape with the maximum centered about the middle States.

The rating and ranking tool of the present invention provides a single number to describe diversification, which employs a weighting function that gives high weight when a fund or portfolio lands in the central states (around State 3) and low weight when a fund or portfolio lands in the extreme states (0 and 6), and scales between these extremes. The optimal weight for State 6 is 0; the same applies for the final state even where the number of states is not six though. The diversification metric of the present invention then uses the following formula for Diversification=D:

$$D = \frac{{W}_{0} {H}_{0} + {W}_{1} {H}_{1} + … + {W}_{N - 1} {H}_{N - 1}}{{H}_{0} + {H}_{1} + … + {H}_{N - 1} + {H}_{N}}$$

In the above formula, Hᵢ is the number of historical periods the portfolio lands in State i and Wᵢ is the weight assigned for State i.

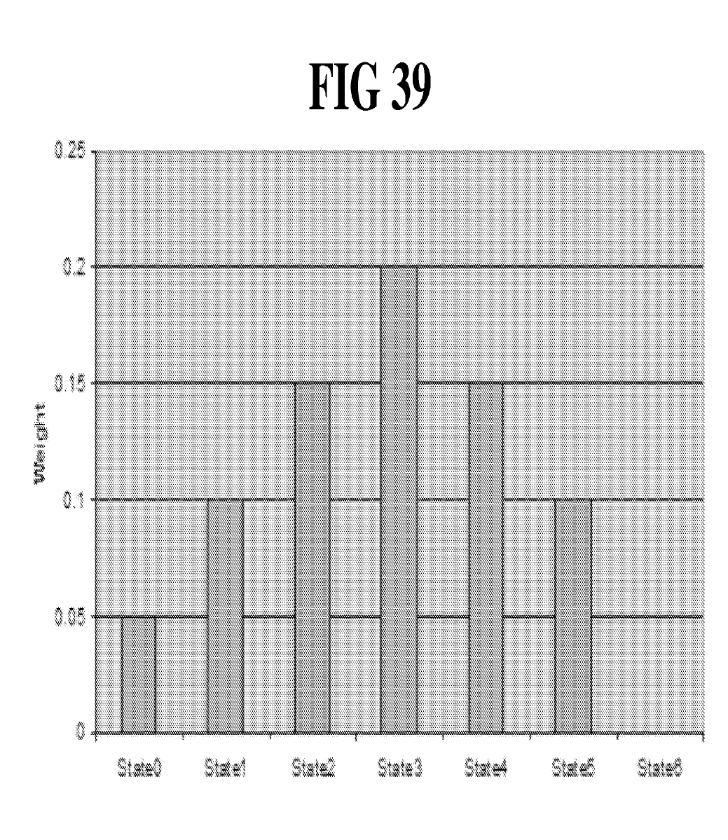

One exemplary embodiment for the weights is shown in FIG. 39, which uses five core asset classes and thus has six states. State Zero (0) is assigned a weight of 0.05; State One (1) is assigned a weight of 0.10; State Two (2) is assigned a weight of 0.15; State Three (3) is assigned a weight of 0.20; State Four (4) is assigned a weight of 0.15; State Five (5) is assigned a weight of 0.10; and State Six (6) is assigned a weight of 0.

These weights and the numbers of States are merely one example. Other weights are possible even for an implementation with six States and other numbers of States are also possible. The present invention provides that a weighting with higher distributions towards the center and symmetric distributions seems preferable but other values could be used without departing from the present invention.

This simple but elegant solution for a rating and ranking tool generates a single-valued measure of diversification that applies to any fund or portfolio. For risk and return, the other two dimensions of the simple screening tool, the present invention uses standard measures. Risk is the annualized trailing standard deviation in return. Return is the trailing average annual return.

Testing the Screening Tool

The first step in testing the screening tool is to see whether the screens are effective in finding the most extreme cases. A set of 400 mutual funds was created for the testing. These 400 mutual funds cover a range of values of the diversification metric of the present invention and the calculated trailing Betas, risks, and returns for all of these. The data was then screened on various criteria. Three years of trailing data was used for risk and return. Over the trailing three years through December 2008, the S&P500 has had an average annual return of −9%.

Screen 1: 80th Percentile Risk/3rd Percentile Diversification

The set of 400 funds was screened for those at or above the 80th percentile of risk and at or below the 3rd percentile of Diversification. In other words, funds were identified that are high risk and not at all diversified. The list of funds is shown below in Table 3.

The funds identified from this screening operation serve as one validation method of the present invention. These are, indeed, un-diversified funds.

Screen 2: 80th Percentile Risk/80th Percentile Diversification

In this screening operation, funds were identified for high risk and high diversification, which resulted in a very different set of funds than those identified under the screening operation for high risk and low diversification. The results are shown in Table 4.

Note that the average risk levels in Table 4 are considerably lower than they were in the high risk/low diversification screen of Table 3. This is because the 80th percentile risk level is around 20% annualized standard deviation. The more diversified funds tend, however, to be less risky than the less diversified funds. These funds do tend to be far more diversified than the ones in Table 3.

Screen 3: 20th Percentile Risk/90th Percentile Diversification

Table 5 shows the results of screening for 20th Percentile Risk/90th Percentile Diversification.

From this screen shown in Table 5, funds with substantially less risk than the S&P500 but that are highly diversified. These selected funds employ global asset allocation strategies. This seems like a particularly useful screen for the average investor. The diversification metric shows the value of investing beyond the United States.

Screen 4: Low Risk

The results for screening for low risk are shown in Table 6.

In this screening shown in Table 6, the funds were funds based on low risk and a series of funds were selected that were at similar risk levels but showed very different values for the Diversification. The fund styles were then determined, and the results were quite striking. The screening tool correctly identified that there were two target date funds with the same risk levels as municipal bond funds. As the scale increased up to slightly higher risk levels, several Conservative Asset Allocation funds were identified, which funds are low risk but exhibit more than 50% more Diversification. These results show that you can have a fund or portfolio at a given risk level that has a wide range of diversification value. KRFEX has 18.6% of its assets in equities. STWRX has 15% of its holdings in equities, and the remaining fixed-income assets include international government bonds—providing additional diversification.

Analysis

The present rating and ranking tool of the present invention comprises a screening tool for classifying funds and portfolios on the basis of three metrics: Risk, Return, and Diversification. Testing has demonstrated that the diversification statistic effectively identifies the degree to which a portfolio is taking advantage of diversification opportunities at its risk level.

Investors will benefit from being able to see this form of information for two reasons. First, a given level of return over a trailing period is more indicative of good design and/or management if the portfolio is more diversified. It is trivial to find sector concentrated mutual funds or portfolios that have out-performed over a specific historical period, which could be due to chance alone. It is much harder for a diversified portfolio to out-perform by chance alone. Second, diversification is a “free” source of performance enhancement: a portfolio can generate more return with no increase in risk if it is diversified. Modern Portfolio Theory is predicated on the idea that all investors will know enough to diversify. Unfortunately, many mutual funds and portfolios that appear diversified because of their names or the fact that they invest in many different stocks are not all that well diversified. Without some quantitative method to identify whether a fund or portfolio is diversified, it will be unlikely that investors effectively exploit this source of performance. With the screening tool of the present invention investors can identify funds or portfolios that are better diversified than the S&P500 or can improve the diversification levels of their existing portfolios. Even for investors with low risk tolerance, a portfolio with a modest exposure to equities (like the target date funds) adds value by increasing diversification benefits, as opposed to investing entirely in bonds.

Efficient Frontier

The concept of the efficient frontier is central to the theory of portfolio development. By combining assets in optimal mixes, a surface is defined that represents the most return that the portfolio was (theoretically) possible to achieve for a given level of risk over a specific historical time period. While the idea of the efficient frontier demonstrates the power of diversification, using the historical efficient frontier as the basis for allocating a portfolio consistently leads to poor performance. The problem with simply using an historical efficient frontier to choose a portfolio is that the optimal portfolios will have heavy allocations to assets that have out-performed during the historical period.

There are two factors that determined whether a specific asset allocation would have out-performed over the historical period. The first (factor 1) is due to the choice of the specific historical period. Over any period, certain asset classes out-perform and other under-perform their expected levels (assuming that there is some rational ‘expected’ level of return for all asset classes, although this value has high estimation error). The second (factor 2) is due to diversification opportunities provided by combining assets with low correlations with one another. One cannot tell from a chart of the efficient frontier how much of the risk-adjusted performance of a portfolio on the frontier is due to effective diversification and how much is due to the specific period of history being examined.

By examining the underlying holdings of a fund, one can discern whether the out-performance is due to factor 1 or factor 2 to a limited degree. For the four years through 2007, VGPMX (Vanguard's precious metals fund) had very high returns and very high risk-adjusted returns (as measured by the ratio of average return to standard deviation in return). As clear to most investors, however, this is a totally un-diversified fund and that these high returns (relative to risks) are due to the specific events associated with this period. Another fund with a high return and risk-adjusted return over this period is VEIEX, Vanguard's emerging markets index fund. Many investors will not have a strong feeling about the level of performance that is due to diversification across different emerging economies versus the recent popularity of emerging markets as an asset class. If one were to pose the question “how diversified is the MSCI emerging markets index?” it is unclear how even experienced investors could provide an answer. VEIEX is classified as a Diversified Emerging Markets fund, but what does this mean? How diversified is a Diversified Emerging Markets fund? The percentage of assets invested in the top ten holdings provides some indicator of diversification, but this is a weak metric. VEIEX has 17% of assets in the top ten holdings, while the S&P500 has 22% of assets in the top ten holdings. The degree of diversification has more to do with the correlations between holdings than the level of allocation to any individual stocks.

These two examples illustrate the challenge of determining whether a fund is diversified or not. Only having a subjective sense of whether a portfolio is well diversified is clearly not ideal.

Considering the wide range of possible portfolios that have exhibited high risk-adjusted returns, it would be very useful to be able to tell which allocations are good allocations going forward and which have simply out-performed over the trailing period due to short-term drivers. The continued out-performance of concentrated portfolios depends on tactical asset allocation or chance. The continued out-performance of a well-diversified portfolio may depend to some extent on both of these factors, but is likely to be higher over an extended period of time than an under-diversified portfolio.

For investors to be able to determine the degree to which a portfolio is exploiting the available increases in risk adjusted return due to diversification, they must have access to a metric of diversification. The present invention provides such a metric.

Diversification Metric

One aspect of the present invention provides inter alia a method for portfolio selection using a new metric of diversification. Consequently, an investor selecting mutual funds can generate higher returns by selecting a portfolio of funds that have a higher degree of diversification.

Unlike previous measures of diversification, the metric of diversification (which we will refer to as D) according to one aspect of the present invention can calculate diversification for any portfolio, given its historical returns. Previous methods (such as that used by RiskGrades and others require specific information as to the holdings of a portfolio to be able to calculate diversification. Style analysis is used to examine diversification; however, no specific measure of diversification has been derived from Style Analysis. A style analysis approach to diversification must deal with the potential for non-stationary exposure to various asset classes, while the present invention requires no assumptions about stationarity. Further, Style Analysis cannot fully account for correlations between portfolio holdings not captured by the major asset classes.

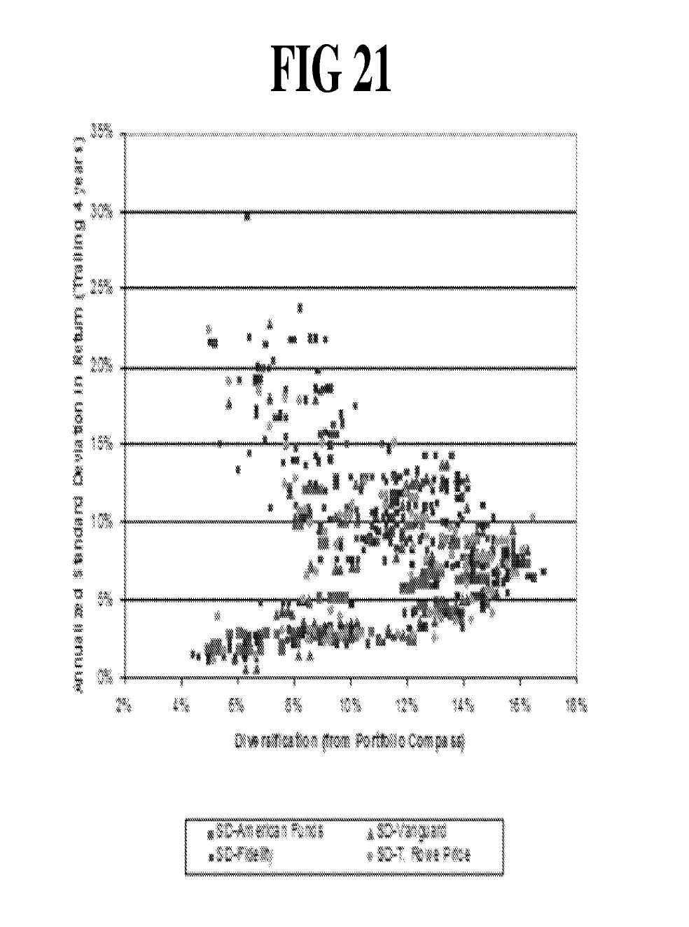

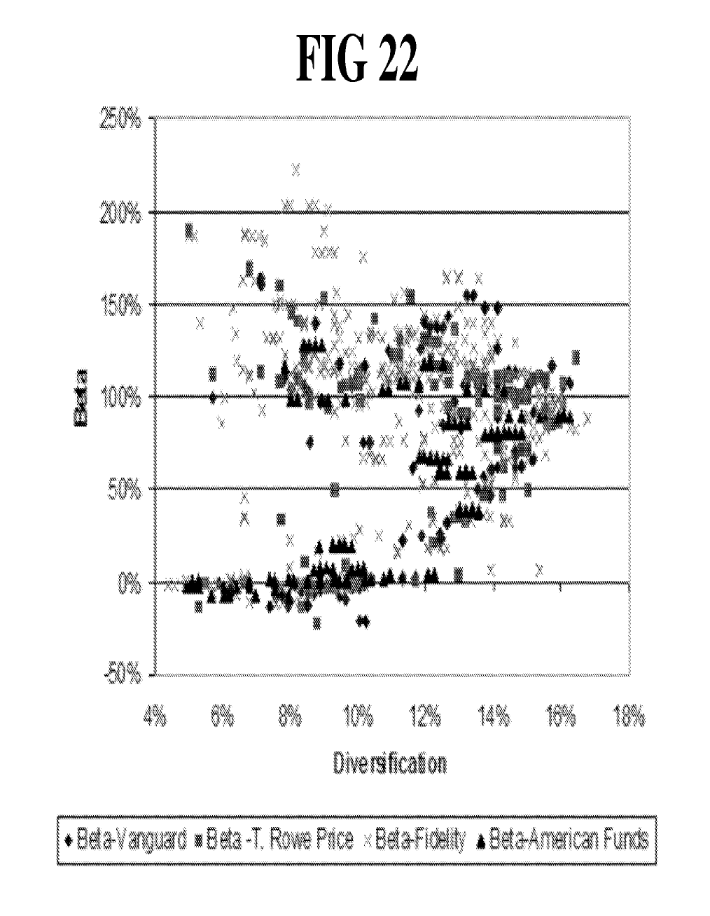

The diversification metric of the present invention provides significant advantages for investors as opposed to simply creating a proxy for risk. FIG. 21 shows Diversification versus annualized standard deviation in return for all Fidelity, T. Rowe Price, Vanguard, and American mutual funds as of the end of 2007 (using 48 months of trailing data to calculate D).

These results provide a composite picture of the universe of available mutual funds that is quite intuitive. At very low levels of Diversification, funds tend to be either very high risk (like precious metals funds) or very low risk (bond funds). As diversification increases, funds will naturally include a higher degree to exposure to a wide range of asset classes with partly offsetting risks—so the range of diversification tends to decrease. The funds with the maximum level of diversification also exhibit a very small range of risk levels. This relationship indicates a re-conceptualization of the efficient frontier. While in the traditional frontier one examines historical risk and historical return, the present invention provides a third dimension with a quantitative measure of diversification.

The same general form of relationship is present when comparing Beta of mutual funds to D. Funds that have very low diversification will tend to be either high Beta or low Beta, while funds with higher diversification will tend to exhibit a much narrower range of Betas, as shown in FIG. 22. The high-Beta/low-diversification funds are those that focus on asset classes like emerging markets and precious metals. The low-Beta/low-diversification funds tend to be bond funds. At the highest levels of diversification, Beta is around 100%.

An S&P500 index fund (VFINX) has a Diversification value of 14.1% as of the end of 2007 (corresponding to the charts above). VEIEX has a diversification level of about 7%.

This aspect of the present invention provides a metric of diversification that adds value for investors. There are two significant factors. First, a highly diversified portfolio will tend to out-perform a less diversified portfolio (on a risk-adjusted basis) over extended periods of time. The less-diversified portfolio is said to be ‘inefficient’ because it is not fully exploiting the available diversification opportunities between asset classes. Of course, one can invest in many un-diversified funds and create a total portfolio that is quite well-diversified. Thus, it is not necessary to only buy well-diversified funds to obtain the advantages of diversification. Of course, one may assemble a portfolio that is properly diversified across many funds (assuming one has the expertise to combine these funds to create an efficient overall portfolio), thereby avoiding the need to select funds on the basis of higher diversification.

Testing the Diversification Statistic

The Diversification measure generated within the portfolio compass of the present invention has been qualitatively tested, which tests demonstrated that the statistic was properly categorizing a range of un-diversified funds and portfolios versus diversified funds and portfolios. Diversification is not simply a proxy for risk, although more diversified funds (or portfolios) will span a smaller range of risk levels. In moving beyond this qualitative level of testing, the focus has been on testing diversification as a forward-looking metric.

Using the four largest fund families (Vanguard, T. Rowe Price, Fidelity, and American) over 22 years through 2008, the performance of funds selected on the basis of high diversification have been examined.

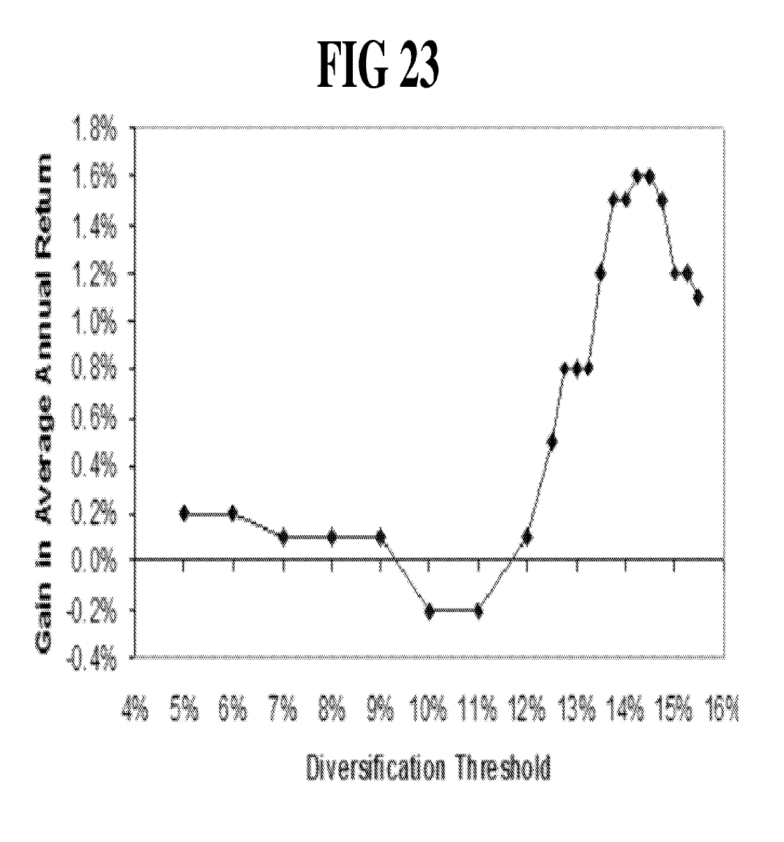

Prior to the start of each calendar year, the testing included running the Portfolio Compass with a window of 48 months and using 12 months of trailing returns and a 12-month forward projection period. The funds were then sorted on the basis of diversification and the returns examined over the subsequent 12 months for funds with high diversification versus the entire population of funds. The simplest approach was to assume that one buys funds with trailing diversification greater than some threshold value. Higher diversification funds do appear to provide some performance benefits over the 22-year period as shown in FIG. 23.

In FIG. 23, the horizontal axis shows the diversification threshold and the vertical axis shows the difference in average annual return between funds rated as ‘buy’ and the entire population. As discussed earlier, a diversification of 5% suggests funds that are totally un-diversified (pure bond funds and pure sector funds in very narrow sectors such as precious metals). The maximum diversification observed among the four fund families is around 16%. Approaching this level, the sample of funds becomes very small, which limits the ability to ascribe much meaning upon reaching this level. From funds with diversification levels at or below 10% to those with diversification levels on the order of 14%-15%, a rapid increase occurs in the average annual return advantage conferred by diversification. These results suggest that selecting highly diversified funds provides a gain in average annual return on the order of 1.5% per year over the 22-year period. The optimal level of diversification for selecting funds appears to be on the order of 14.25% to 14.5%. This level is very close to that exhibited by the S&P500. The average annual performance gain for an S&P500 index fund (VFINX) is 2.5% over the 22-year period, which corresponds quite closely to estimates of the performance drag of actively managed funds over recent decades. It has been estimated that the average equity mutual fund lagged an S&P500 index fund by 2.8% per year over the 20 years from 1983-2003. This result does beg the question of whether these results simply indicate that investors are better off if they buy only a total market index fund. For investors selecting from among the universe of mutual funds, this is certainly one result, but it is far from the whole story. There are funds with diversification levels around 14% that have a wide range of risk levels, and S&P500 index funds are only one among these. That said, the results do show that simply investing in an S&P500 index fund will be superior to a large universe of investment portfolios made up of mutual funds.

These results are quite striking given that the population of all funds, even if it includes many un-diversified funds, should (as a whole) provide a high degree of diversification. The average annual return of this total population is equally weighted, which means that this is the return of a portfolio that is equally allocated between all funds (this is often called the ‘1/N’ strategy). Even though this approach does provide quite a lot of diversification (albeit randomly), this analysis suggests that this 1/N allocation is still missing as much as 1.5% per year of available return because it is not an ‘efficient’ way to create a portfolio. One of the problems with earlier research on the value of diversified portfolios (versus a 1/N allocation) is that it is backward looking. Standard approaches to creating a forward-looking efficient frontier have so much estimation uncertainty in parameters that they are not, in fact, a better solution than 1/N allocation. The present invention provides an alternative that does provide insight on a forward-going basis.

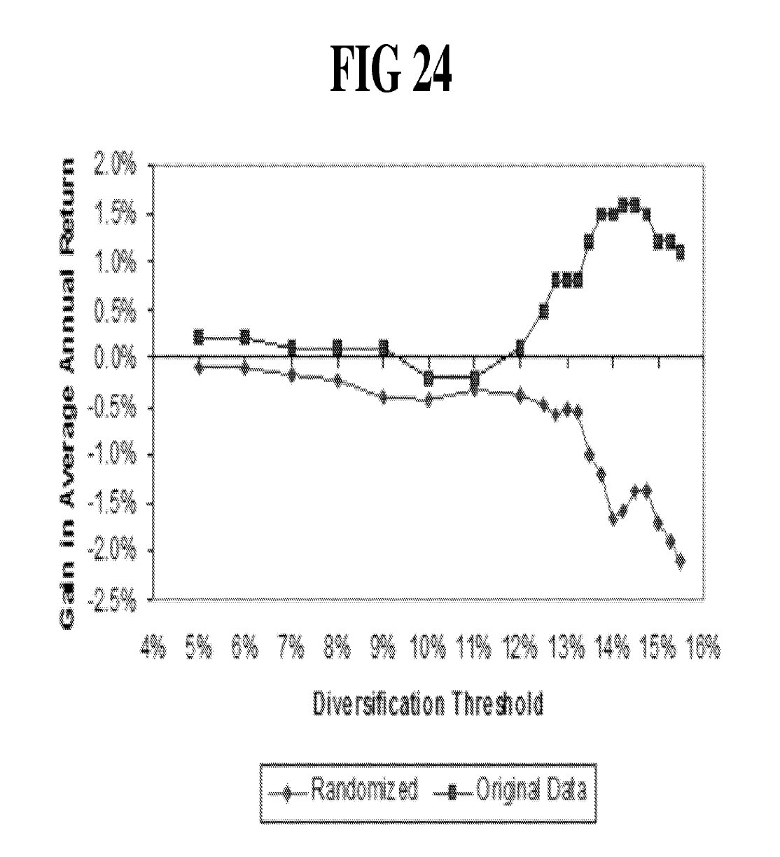

To further examine this diversification effect, an additional test was performed. For the four fund families over 22 years, the subsequent years' returns were randomized to examine the null hypothesis of the impact of changing the sub-sample size as the result of the diversification thresholds. Because of the randomization, the sub-samples with higher diversification simply correspond to smaller random subsets of funds. There were no positive gains in returns in the resulting data. The average gain in return becomes negative as the threshold in diversification increases and the subsequent 1/N portfolios become less diversified by virtue of holding fewer and fewer funds as the diversification threshold increases. See FIG. 24.

FIG. 24 shows that the randomized sub-sampled portfolios that use the diversification thresholds have near-zero gains for low diversification portfolios (because these will hold larger numbers of funds) and a negative gain as diversification thresholds increase. This shows that investors who choose small numbers of funds with no information on diversification effects under-perform a 1/N portfolio of all funds and substantially under-perform a small number of funds chosen on the basis of diversification.

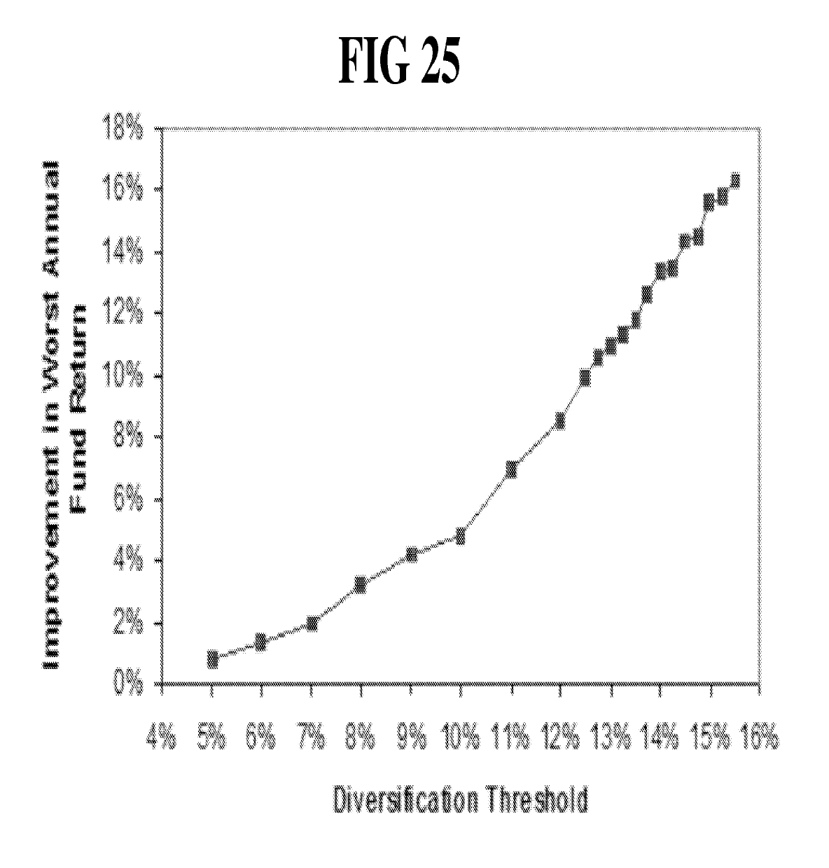

Aside from the issue of fully exploiting diversification benefits in terms of average return, there is another reason why investors may want to know how diversified a fund or portfolio is. If investors did invest in every fund (either via 1/N or a better approach), they would end up diversifying away most non-systematic risk. This is not, however, the way that individual investors behave: most investors in 401(k) plans invest in no more than four funds. This is not a problem if these investors choose four well-diversified funds, but what if these funds are not well-diversified? A simple way to examine this issue is to look at the worst return in a given year if an investor chooses a single fund from the population of all funds vs. from the funds with diversification greater than the threshold value. What we expect to see is that the worst fund return in any give year is substantially more likely when a fund is chosen from the total population than when the fund is chosen from the limited universe of funds with diversification above the threshold level. This is indeed what we find, as shown in FIG. 25.

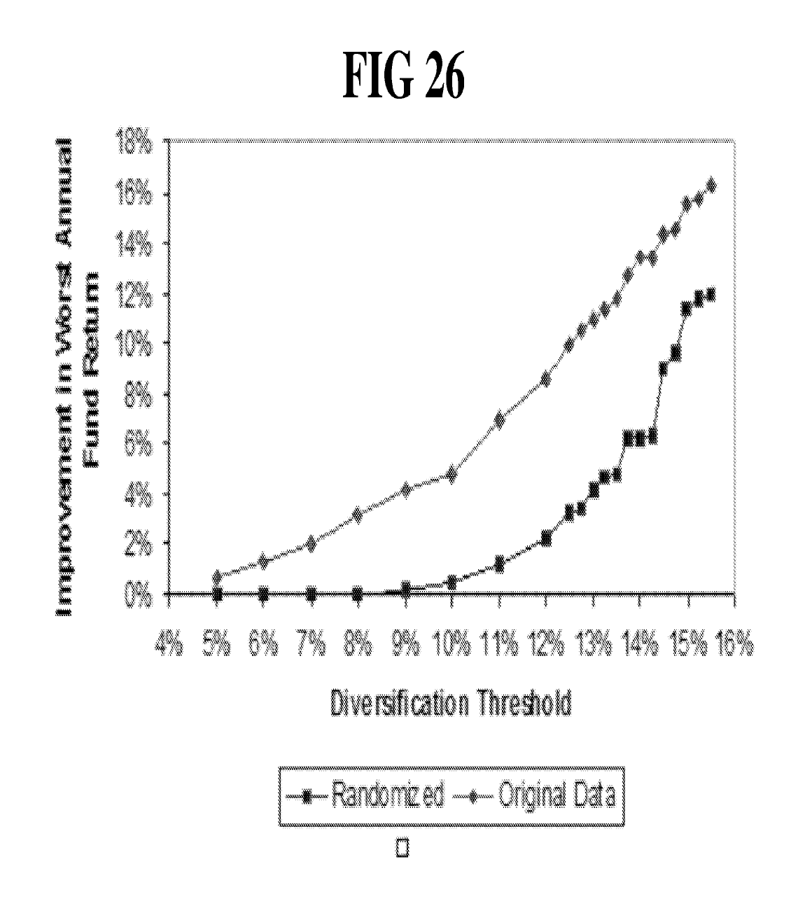

In FIG. 25, the worst performing fund in any given year from a fund family is likely to be substantially worse in the entire population than in the sub-sample selected using diversification as a cutoff criterion. The worst fund in the entire sample is likely to have a return 13.5% below the worst fund in the sample when we use a threshold of 14.5% as the minimum diversification for a fund, for example. If the worst fund in the sample with the diversification threshold has a return of −10% in a given year, the worst fund in the total sample is likely to have a return of −23.5%, etc. Before conclusions are drawn based upon this chart, there is an additional factor that must be accounted for. The diversification threshold creates smaller sub-samples of data. The minimum value in even a randomized smaller sub-sample would be expected to have a less extreme minimum return by chance alone—so this effect was tested for. The randomized results are shown in FIG. 26.

As expected, we see that a substantial portion of the ‘worst case’ effect is also present in the randomized data, but a large benefit still remains. This result suggests that investors picking individual funds will be able to substantially reduce their probability of selecting a fund with very high losses in a given year if they use diversification as a selection criterion.

Discussion

Diversification is crucially important, but many (if not most) retail investors do not have well-diversified portfolios. A survey of 2.9 million 401(k) plan participants' asset allocation choices demonstrated that 55% of participants in 401(k) plans were not making asset allocation decisions that were broadly consistent with good practice. In 2009, a similar study from EBRI found that of investors age 60 and over who did not invest in target date funds, 24% had 90% or greater allocations to equities. Fully 38% of investors below the age of 30 who did not participate in target date funds had 0% exposure to equities. For the average retail investor who chooses a small number of funds, there is a good chance that he/she will miss the diversification benefits of even a naïve ‘1/N’ allocation and this, in turn, substantially under-performs a portfolio in which the funds are chosen on the basis of the Portfolio Compass Diversification statistic.

There is a disconnect in the process of portfolio construction for investors. On one hand, investors are told to create well-diversified portfolios. On the other hand, the vast majority of investors have no objective (quantitative) criteria with which to select a well-diversified portfolio or to choose between mutual funds on the basis of diversification. The Portfolio Compass Diversification statistic provides a simple and effective basis upon which to assess diversification.

If investors randomly purchased all possible mutual funds in a fund family, with equal allocation to each fund, they would have a reasonably good chance of building a fairly well diversified portfolio (the 1/N portfolio). Most investors have access to a limited subset of funds in any fund family through their 401(k) plans, and investor tend to invest in a very small subset of these. For this reason, most investors are likely to under-perform the ‘1/N’ portfolio of all possible funds. The ‘1/N’ portfolio itself is sub-optimal simply because it is not strategically taking advantage of diversification opportunities. Choosing funds on the basis of diversification allows an investor to compensate for both of these problems: a small set of well-diversified funds identified using the diversification statistic appears to out-perform the ‘1/N’ portfolio of all funds in a fund family.

Further, it is important to understand that the Portfolio Compass does not require diversification to be examined for funds on a standalone basis. To the contrary, the Portfolio Compass diversification statistic is generated for a portfolio that may consist of any combinations of individual securities and funds. We hypothesize that the truly optimal strategy is to create a portfolio with the maximum diversification benefit at a given risk level and that this portfolio is likely to be made up of multiple funds.

The classical portfolio theory model suggests that investors need to look at risk and return of all possible portfolio combinations and choose the portfolio with the highest return for the observed risk level. A third variable must be added: diversification. A portfolio with the highest observed return for a given risk level over some time horizon is subject to substantial levels of chance and ‘optimal’ portfolios based upon history are actually likely to under-perform a ‘1/N’ strategy. By using this new quantitative measure of diversification for portfolio selection, an investor is likely to create a more efficient portfolio which provides incremental returns that are substantial.

The survivorship bias effect is negligible or even improves the historical results because more diversified fund selections tend to reduce exposure to the most concentrated/highest risk funds and these funds are the most likely to generate extreme poor results and to be de-listed. The 1/N portfolio will tend to have more exposure to these extreme funds, and thus to suffer more from survivorship bias.

Our results also point to a new process for portfolio construction, whether a portfolio is made up of individual stocks, mutual funds, ETF's, or any combination of these. In this study, we have examined the selection of individual mutual funds, but the approach to calculating Diversification is applicable to any portfolio. Mutual funds simply represent an easily accessible history of multiple portfolios. An investor can (and probably should) take his/her selection of mutual funds and analyze the total portfolio properties (including diversification) in light of the results above. If an investor can build a portfolio strategy that meets his/her risk criteria, there is no reason why he or she should not prefer to maximize Diversification. It is also worth noting that our proposed approach does not require that a portfolio hold a static asset allocation that is diversified at every point in time. To the contrary, a sector rotation strategy (which is highly concentrated at a given instant in time) might have a high Diversification value over time. This idea may help to reconcile the classical theory of the value of diversification with the perspectives of those who believe that the notion of a static policy asset allocation in time is sub-optimal.

Applicability to Individual Stocks

The concept of the efficient frontier hinges on the ability of an investor to determine a reasonable approximation to the efficient frontier when making asset allocation decisions. Investors choosing from among mutual funds will have a substantial performance benefit if they have access to a quantitative metric of diversification.

The diversification metric according to the present invention applies equally well to portfolios constructed from individual stocks. There is nothing in the Portfolio Compass model that is specific to mutual funds as opposed to portfolios of individual stocks.

A range of evidence demonstrates that investors who own stocks tend to hold small numbers of individual stocks. These studies are conceptually similar to those which show that investors in 401(k) plans tend to hold very small numbers of funds. The reasons that investors choose a small number of holdings are unknown, but there are a range of reasons why this might be the case. To really address the issue of diversification in investor portfolios, one must look deeper than simply counting up the number of holdings. One measure of diversification is using the number of stocks in a portfolio, which is a useful heuristic for identifying the degree of diversification. However, this measure is insufficient to accurately characterize the diversification characteristics of a portfolio. Another measure of diversification exploits the covariance structure of investors' portfolios and decomposes the level of portfolio diversification into two components: (i) the risk reduction due to holding more than one security, i.e., passive diversification, and (ii) the risk reduction due to choosing imperfectly correlated stocks, i.e., diversification skill.

This point is consistent with portfolio theory, yet many analyses of the diversification problem assume that the only variable that matters is the number of individual securities held in the portfolio. It is this type of analysis that typically suggests that investors need to own a specific number of stocks in order to be effectively diversified. Metrics of diversification based only on the number of individual stocks held is not ideal.

Applicability of Portfolio Compass Diversification for Portfolios of Individual Stocks

One measure of diversification for a portfolio made up of individual stocks is the ratio of variance in returns for the portfolio to the average variance in returns of the individual stocks in the portfolio. This statistic is called Normalized Variance (NV). This statistic is simple to compute and provides a useful point of comparison for the Diversification statistic generated by the Portfolio Compass.

The Normalized Variance is an excellent statistic for measuring diversification in a portfolio of individual stocks. NV cannot be used to compute the diversification benefits for a portfolio of one or more funds, however, because it does not capture the ‘internal’ diversification effects provided by the components of each fund. The new metric of diversification of the present invention, D, accounts for internal diversification effects in a single company's stock, a mutual fund, or even a hedge fund strategy, by performing a perturbation analysis on a record of historical returns. Previously, the diversification metric was tested using mutual funds. In this analysis, using portfolios made up of individual stocks the calculated Diversification (D) metric of the present invention is compared to the Normalized Variance (NV).

NV is a very intuitive metric of diversification benefit in a portfolio and does not require theoretical justification. Diversification reduces the volatility of returns for the portfolio relative to the volatilities of the underlying assets. If a portfolio has no diversification at all, NV=100%. As diversification increases, NV decreases.

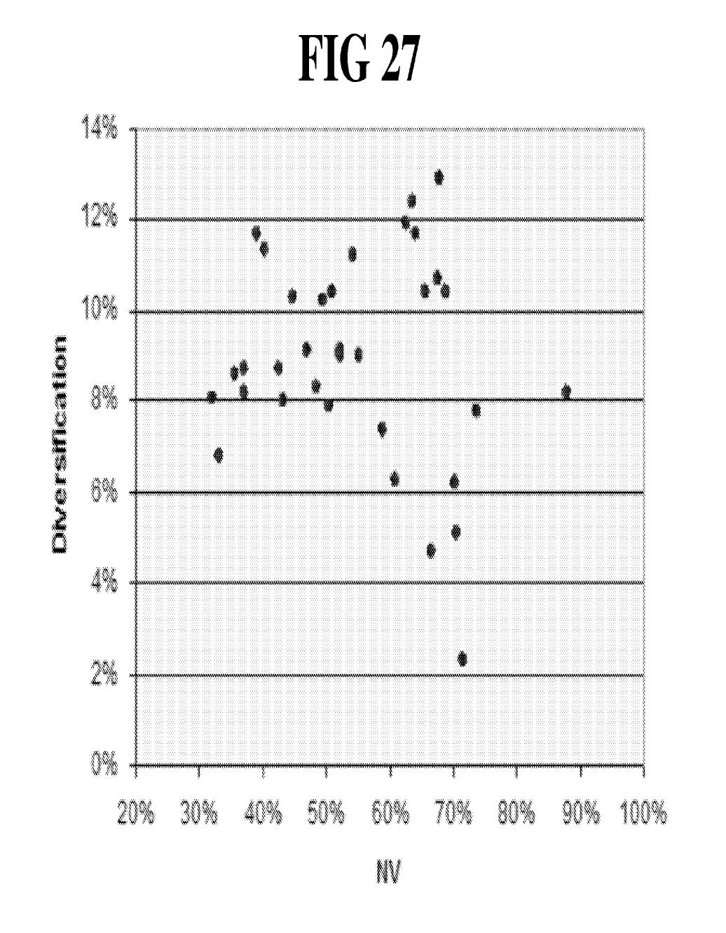

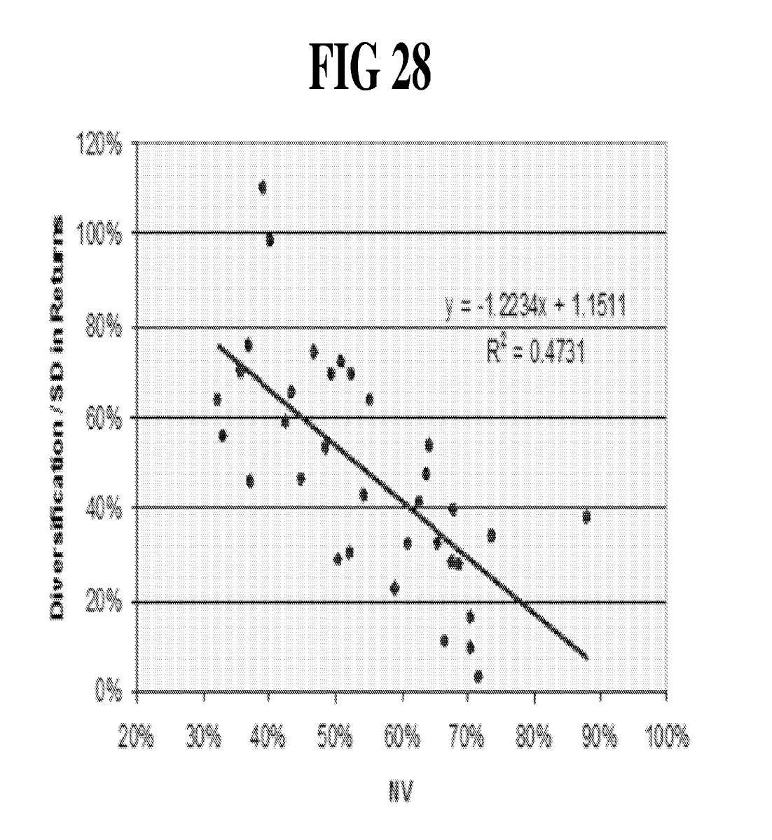

As a starting point, a series of 36 arbitrary portfolios of between 2 and 20 individual stocks were examined, using five years of trailing monthly returns through the end of 2007. Equal weights of all stocks in a portfolio were used, and attempted to construct portfolios with a wide range of values of NV and Diversification, D. There was essentially zero correlation between NV and D of the present invention (See FIG. 27), which is paradoxical given that D and NV are supposed to be measures of diversification. The relationship between D and NV was, in fact, robust if the results are normalized by the trailing portfolio volatility (trailing standard deviation in returns), as shown in FIG. 28.

The correlation between D/SD and NV is −69%. Others reported correlations between the other various diversification measures between 0.53 and 0.64. The diversification statistic, D, of the present invention, differs from NV by a scaling factor of risk, or NV measures diversification per unit of risk (D/SD).

Internal Diversification Effects

A substantial difference between the formulations of D and NV is the fact that NV cannot be calculated for any portfolio for which there are no return histories for all of the aggregate components of the portfolio. NV for an index fund, for example, is zero. D for the S&P500 is about 14%, suggesting a level of diversification higher than for any of the portfolios of individual stocks portfolios in our sample. With D, individual stocks have diversification levels greater than zero. The idea that individual stocks might be internally diversified is not hard to motivate. Some firms operate many separate divisions and product lines (conglomerates such as GE, 3M, and United Technologies are obvious examples) while others are a pure play on a single business. Berkshire Hathaway is another example of a business with a high degree of internal diversification. A substantial literature appeared in the last decade that examines the relationship between conglomeration (internal diversification across business units), geographic diversification, and market value of firms. The Diversification metric of the present invention picks up the evidence of internal diversification effects. Corporate diversification is due to a firm operating in a range of industries, a company operating in a range of geographic locations, or both. Corporate diversification also appears to relate to a company's decision to pay dividends.

If diversified firms trade at a discount, buyers of these firms have higher expected returns than buyers of concentrated firms. This has been nicely explained via the higher skewness of returns on stocks in concentrated firms versus diversified firms. Stocks in concentrated firms have higher positive skewness—higher potential to produce positive outsized returns. Diversification reduces this potential. Skewness-seeking investors (and fund managers seeking to differentiate their performance) will see less value in these firms.

The premium that investors pay for the chance of owning an extreme winner appears to be a large part of the explanation for why firms with diversification discounts have higher expected returns. Investors may require higher average returns on diversification-discount firms to compensate for the fact that such firms are unlikely to produce extreme winners.

Diversification of Stocks Versus Funds

If it is, indeed, possible to measure internal diversification effects within a firm in a manner consistent with the approach to a mutual fund (which creates diversification effects by aggregating shares of firms in a portfolio), this would have a range of important implications. Is it possible that some individual firms are as diversified as some mutual funds? Such a conclusion would have implications for portfolio construction. Table 7 below shows Diversification values for a series of stocks and funds using the same input criteria and data as the previous analysis for stock portfolios and the previous analysis for mutual funds.

TABLE 7

| | Ticker | Diversification (D) |
|---|---|---|
| Fund | | |
| Fidelity Emerging Markets | FAMKX | 5.6% |
| Fidelity Select Electronics | FELAX | 5.7% |
| Vanguard Energy | VGENX | 6.7% |
| Vanguard Emerging Markets | VEIEX | 7.7% |
| Vanguard Precious Metals | VGPMX | 8.0% |
| Stock | | |
| General Motors | GM | 3.1% |
| Apple | AAPL | 5.2% |
| 3M | MMM | 7.3% |
| Johnson and Johnson | JNJ | 8.3% |
| General Electric | GE | 8.9% |
| Consolidated Edison | ED | 10.2% |
| United Technologies | UTX | 10.8% |

GE, 3M, and United Technologies are often cited as examples of companies with a high level of internal diversification—these three firms are conglomerates with very large market caps. These three firms have higher levels of Diversification than a series of selected mutual funds (also shown). Companies like GM and Apple (AAPL) have very low levels of internal diversification. Even though firms like Johnson and Johnson are not considered to be conglomerates, their wide range of product lines and international exposure makes them quite highly diversified. Is it reasonable, however, to assert that JNJ is more diversified than the Vanguard emerging markets fund? United Technologies, UTX, is judged to be more diversified than the selection of mutual funds in Table 7 above—and quite substantially so.

The Diversification statistic depicts the relative diversification of highly diversified individual stocks versus concentrated funds. While portfolio theory has traditionally not been able to account for internal diversification effects with a metric that also can be used for portfolios, the metric of the present invention does just that. The implication from testing to date is that it is perfectly rational for investors to combine individual stocks in their portfolios to create well-diversified portfolios, and this is possible even with fairly small numbers of individual securities.

Funds vs. Stock Portfolios

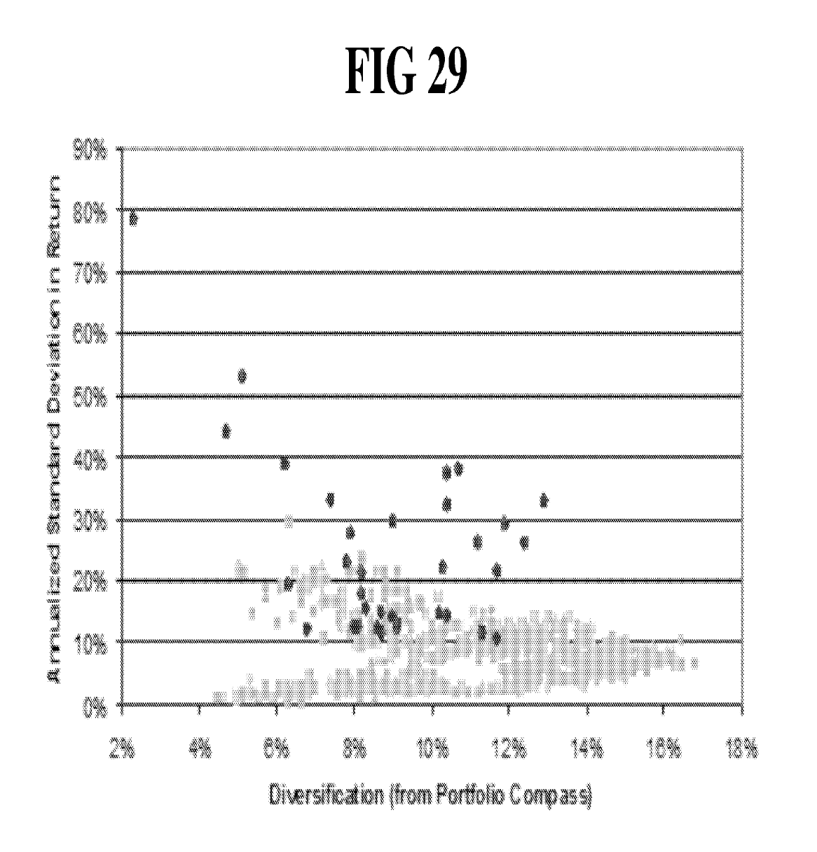

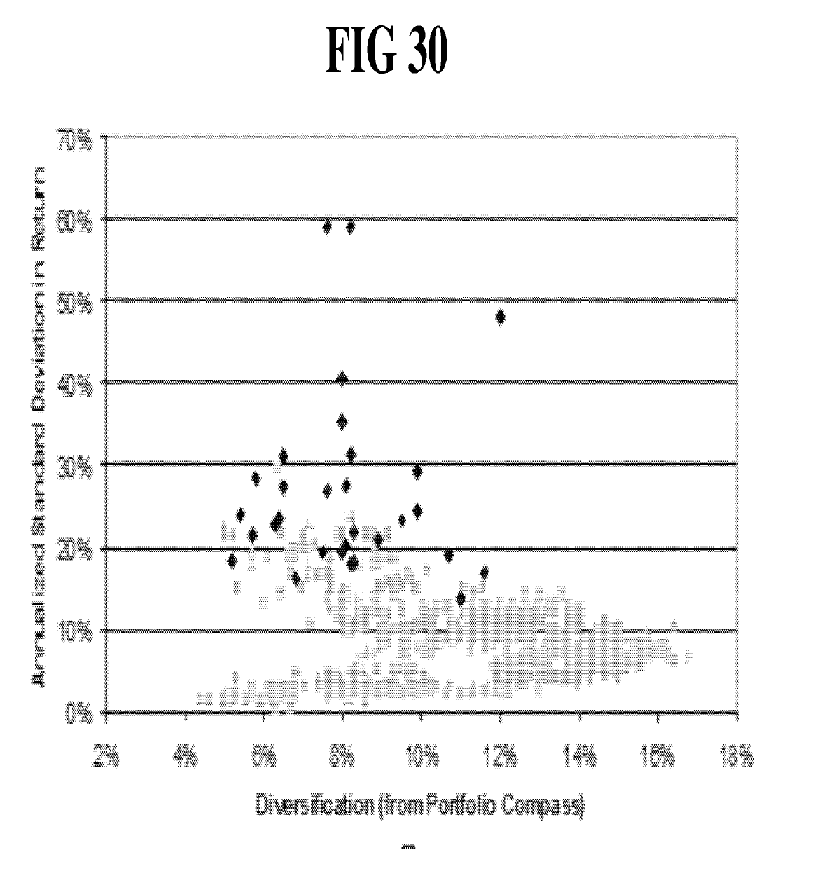

It is of interest to look at the diversification of our simple portfolios of individual stocks versus the funds. The results from the four major fund families profiled are combined in part 1 with the 36 stock portfolios—the results are superposed in FIG. 29. In general, the simple stock portfolios are considerably riskier than the funds—and this is to be expected. What is perhaps surprising is how many of the simple stock portfolios from the earlier section overlap the Diversification-Standard Deviation range of the population of funds. The stock portfolios consist of anywhere from 2 stocks to 18 stocks, and the stocks are equally weighted in all of these portfolios, so these are ‘1/N’ portfolios of individual stocks, which previous research has suggested is not optimal. The results suggest that a small number of stocks is required in order to create a portfolio with similar risk and diversification levels as a wide range of mutual funds. The next interesting question to explore is how many stocks are required in order to create a portfolio with diversification levels comparable to that of the most diversified funds. From a practical standpoint, however, the most relevant question may be whether we can create portfolios from a combination of low-cost ETF's and individual stocks that are more diversified than even the most diversified mutual funds. See FIG. 30.

Diversification Vs. SD for Mutual Funds Vs. 36 Stock Portfolios

The ultimate limiting case of examining Diversification vs. SD is simply to look at individual stocks. The chart in FIG. 30 shows this relationship for the thirty stocks that make up the Dow Jones Industrial Average, superposed on the values for the four major mutual fund families.

We see that some stocks are more diversified and have lower risk than a fraction of the mutual fund population.

A significant advantage exists for investors if they select mutual funds with a screen for high Diversification. Selecting a small number of funds with high values of D provide a substantial increase in portfolio return vs. choosing an equal number of funds randomly in any given year. See FIG. 23.

FIG. 23 shows the average increase in annual return for a portfolio that buys mutual funds with levels of D at or above the specified Diversification threshold (vs. buying all funds in a fund family at equal weight). These results are a composite of four fund families over a 22-year period through 2008. When mutual funds are selected with high value of D, they generate a substantial amount of additional returns. The populations of funds from which we chose included all funds in a family, including bond funds.

When the Dow 30 stocks were analyzed individually, evidence was found of the opposite mechanism. Choosing individual stocks on the basis of high diversification over the same 22-year period analyzed above 1 actually reduced return and risk-adjusted return vs. buying an equal allocation in all Dow 30 stocks. This was particularly notable given that we included GM in our sample and GM has consistently exhibited very low diversification, so the high D portfolios tended to exclude GM. The Diversification statistic can describe diversification effects in individual stocks as well as portfolios of stocks and funds, and that diversification provides consistent features in a portfolio. Screening mutual funds on the basis of Diversification provided no net increase in return for values of D less than 13% or so. In fact, there was actually a negative relationship between D and return for values of D<=11% (see FIG. 30). Using every stock in the Dow 30 and for every year of the 22-year period, the cumulative probability was calculated that a Dow 30 stock might have D>11%. The 75th percentile for D is 11.1%, so only one in four stocks is likely to have D>11% in any given year. Most of the time, individual stocks have values of D<11%, so individual stocks tend to be in the regime in which increasing D has very little impact on return.

These results suggest that it does not make sense to choose individual stocks on the basis of higher return but that it does make sense to assemble portfolios or to choose mutual funds with high Diversification. Individual stocks typically have not reached the threshold levels of diversification at which selection on the basis of higher D adds value. This result is quite intuitive. A rational risk-averse investor will build a portfolio with a goal of increasing D for the total portfolio or might buy funds with high D, but this same rational investor will not necessarily tend to select stocks on the basis of their individual values of D.

Discussion

The logic of diversification is simply that a portfolio that is made up of a series of assets that are not perfectly correlated should be able to generate more return for a given level of risk than any of the individual assets (with or without leverage). The Capital Asset Pricing Model takes this concept a step further by assuming that a market cap weighted asset allocation is optimal. The end result is that investors are taught that owning individual stocks is likely to be too risky. More specifically, the non-systematic risk associated with individual stocks does not add returns to the portfolio. Implicit in this argument is that individual stocks do not have internal diversification (or at least that any such internal diversification is priced in) and that stocks are essentially indistinguishable to the average investor. The risks that investors assume when they buy small numbers of stocks are supposed to be risks that will not be compensated and thus should simply be diversified away. If this is true, the only risk that investors are compensated for taking on will be systematic risk via higher Beta. In the decades since CAPM was proposed, however, a number of anomalies have been identified that invalidate CAPM. Low Beta and low Book-to-Market portfolios substantially outperform CAPM predictions, for example. Amidst increasing evidence that markets are not efficient in all cases, it is not unreasonable to revisit the notion that individual stocks have no place in an investor's portfolio. To examine this problem, tools are needed that can quantify the diversification of a portfolio ranging from a single stock to many stocks and to a combination of stocks and funds.

The diversification measure of the present invention remains consistent with the Normalized Variance diversification measure. The computed Diversification is also applicable to individual stocks.

The results suggest that the idea that stocks and funds represent fundamentally different classes of investments (‘diversified’ vs. ‘undiversified’) is simply not very meaningful. Some companies have such diversified businesses that their stocks may be more diversified than a subset of the mutual fund universe. An efficient market perspective would suggest that the value of such internal diversification in a conglomerate or other diversified firm must already be priced in, but there is a substantial literature on the ‘diversification discount’ which suggests that diversified corporations tend to sell at a discount to their underlying businesses. There is evidence that the market may not efficiently price the value of a company relative to its components from a variety of sources, including the diversification discount discussed above, as well as the literature on ‘equity carve outs’ and the persistent differences between the NAV and market values of Closed-End Funds (CEF's). Given these market anomalies, being able to distinguish between portfolios with more or less internal diversification is likely to be of value.

Even prior to completely testing this concept, a rational risk-averse investor, given the choice between two almost statistically indistinguishable portfolios which differ only in their diversification levels is likely to choose the more diversified of the two. If the historical risk, return, Beta, and factor exposure are the same, an investor would choose the less diversified portfolio if he/she puts a premium on skewness in a portfolio—the chance to have a big win. Investors tend to hold portfolios with small number of stocks—far fewer than are required to approximate the market portfolio. This tendency has been rationalized using a range of mechanisms, but we are going to propose a new one.

Assuming that an investor does value diversification; will that investor ever choose a portfolio which is comprised of a small number of stocks? Using the present invention's metric of diversification, it is possible to build a portfolio from a small number of stocks that is not less diversified than another portfolio made up of a large number of stocks (such as the market index).

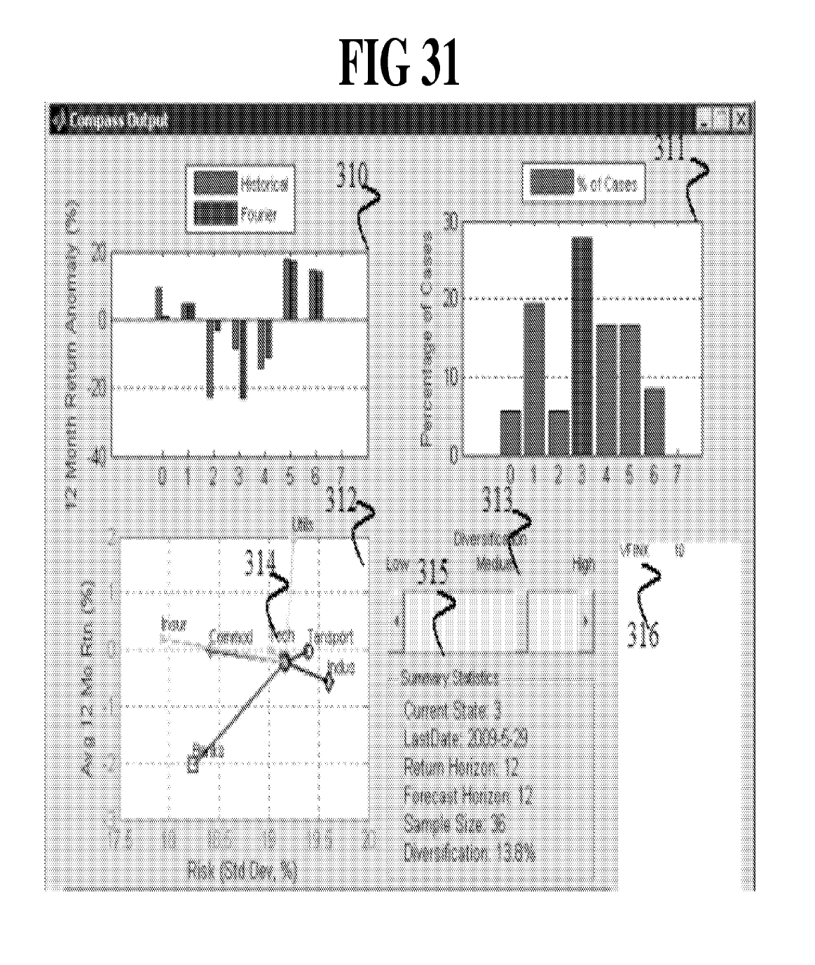

This concept will be illustrated with an example. FIG. 31 shows output from the Portfolio Compass for VFINX, an S&P500 index fund, using data through the end of May 2009.

Portfolio Compass for the S&P500 (VFINX)

As expected, the S&P500 provides a fairly highly diversified portfolio all by itself—more diversified than the majority of mutual funds. This may be seen as a basic argument in favor of indexing. On the other hand, the average return of this portfolio over the past five years is essentially zero, while the annualized volatility is quite high at something greater than 19% (see FIG. 31).

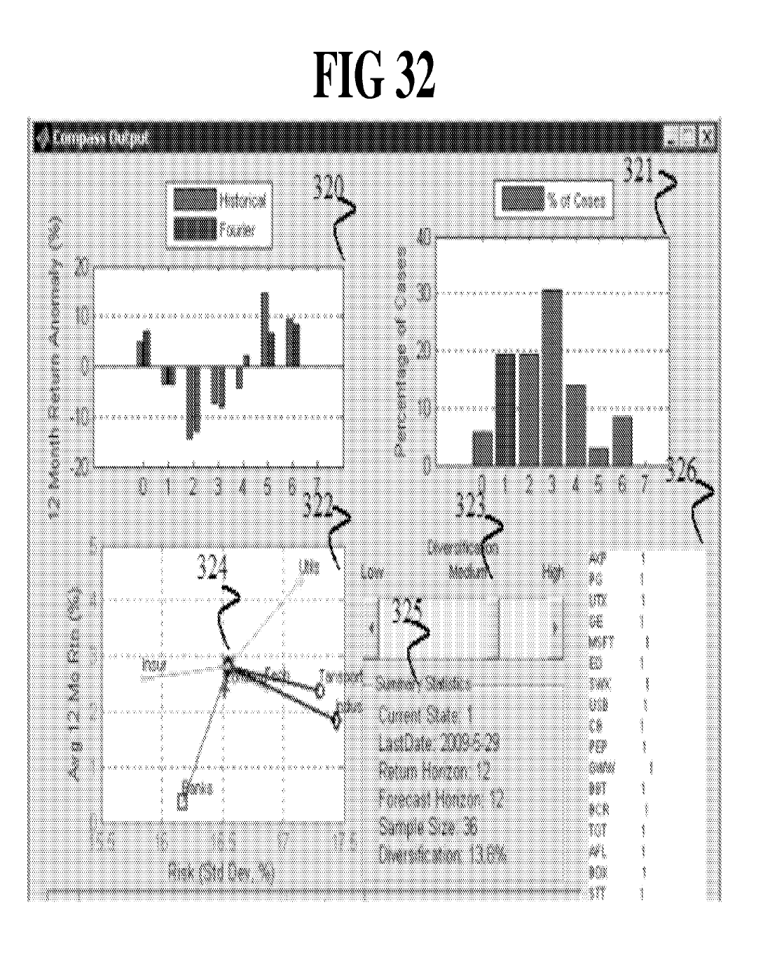

FIGS. 31 and 32 are screen shots from an exemplary embodiment of the present invention utilizing MATLAB. In FIG. 31, the graph in the top left-hand corner 310 shows the average return of the portfolio for the period following the time when the portfolio is in each state. Thus, for the 12 months following when the portfolio (comprised of a single fund, VFINX) is in State 3, the historical average return is about −8% (a smoothing Fourier algorithm is used, which generates a smoothed version of the average returns by state, the result is shown as about −25% in State 3), whereas following being in States 5 or 6, the average return almost reaches 20%. These data are a key driver to timing one's investments or modifications.

In FIG. 31, the graph in the top right-hand corner 311 shows the historical probability that a portfolio is in each state, with the current state being State Three. The data from the graph in the top right corner is used as the input to the diversification metric. Highly concentrated portfolios tend to have higher probabilities of being in either very low-numbered states or very high-numbered states. More diversified portfolios have higher probability of being in central states.

The chart at the bottom left-hand corner of the screen 312 shows the “portfolio compass” chart. This is a risk-return chart: the horizontal axis depicts risk and the vertical axis depicts return. The center point of the “star” 314 shows the current portfolio, and each leg of the star shows the historical risk and return of the portfolio with an added allocation (20%) to one of the core asset classes.

For FIG. 31: This is VFINX, and S&P500 fund. The best way to increase return without increasing risk is to add utilities. The best way to reduce risk via changing your equity allocations is via insurance sector stocks and commodities, which both reduces risk and slightly increases return.

The summary table 315 in FIG. 31 shows the statistics for the portfolio being analyzed. The current State of the portfolio is State 3, which means that during the time period under consideration, three of the modified portfolios outperformed the portfolio being analyzed. The last date of the data being used is May 29, 2009, with a return horizon of 12 months and a forecast horizon of 12 months. The sample size used is 36 and the calculated diversification metric is 13.8%. Element 313 shows the relative diversification in graphical format.

Now, we may consider an alternative portfolio. We have selected a series of stocks that exhibit high levels of internal diversification (see table below). The discussion above shows that many funds have diversification levels below 9%, and this discussion uses a series of individual stocks with D>9%. By combining 17 of these stocks together with equal weights, a portfolio was created with a comparable risk level to the S&P500.

High Diversification Individual Stocks

The Portfolio Compass analysis for this portfolio is shown in FIG. 32. FIG. 32 shows a diversified portfolio of individual stocks. In FIG. 32, the graph in the top left-hand corner 320 shows the average return of the portfolio for the period following the time when the portfolio is in each state. Thus, for the 12 months following when the portfolio (comprised of a list of stocks in table 326) is in State 2, the average return is about −5%, whereas following being in States 5 or 6, the average return runs near or over 10%.

In FIG. 32, the graph in the top right-hand corner 321 shows the historical probability that a portfolio is in each state, with the current state being State One. The chart at the bottom left-hand corner of the screen 322 shows the “portfolio compass” chart. The center point of the “star” 324 shows the current portfolio, and each leg of the star shows the historical risk and return of the portfolio with an added allocation (20%) to one of the core asset classes.

For FIG. 32, the best way to increase return without increasing risk is to add insurance sector stocks. Adding utilities increases return at the expense of increased risk. Transportation and industrial sectors stocks would increase risk without any change in return.

The summary table 325 in FIG. 32 shows the statistics for the portfolio being analyzed. The current State of the portfolio is State 1, which means that during the time period under consideration, only one of the modified portfolios outperformed the portfolio being analyzed. The last date of the data being used is May 29, 2009, with a return horizon of 12 months and a forecast horizon of 12 months. The sample size used is 36 and the calculated diversification metric is 13.8%. Element 323 shows the relative diversification in graphical format.

Portfolio Compass for 17 Individual Stocks

This portfolio has generated modest but positive average returns for the past five years, with somewhat less risk than VFINX (see FIG. 32 versus FIG. 31). This is not, in and of itself, all that notable. This portfolio of seventeen stocks is, however, as diversified as the S&P500 according to the Portfolio Compass.

This portfolio has not always had a higher diversification value than the S&P500 (see table below):

This result occurs because the Diversification is determined by relative performance of the portfolio in question, as compared to a series of alternative portfolios. In the 1990's, this portfolio was not terribly well diversified as compared to the universe of alternative portfolios. In the early-to-mid 2000's, this portfolio became quite well diversified.

### Conclusions

Is it possible for a portfolio of seventeen stocks to be as diversified as the S&P500? This question can only be answered once we have defined a quantitative measure of diversification. Further, this is a different question than simply asking how many randomly chosen stocks are required to diversify away the majority of non-systematic risk.

The Diversification statistic classifies mutual funds and shows how to select mutual funds on the basis of Diversification to enhance portfolio performance. The Portfolio Compass Diversification measure is consistent with Normalized Variance (NV), a metric previously developed and tested. NV has many advantages, not least that it is highly intuitive and easy to calculate. NV quantifies how combining risky assets can result in a portfolio with total risk that is lower than the average of the assets. The limitation of NV is that you must account for all of the holdings of the portfolio, and this is especially problematic for portfolios that change their holdings over time. The Portfolio Compass Diversification, by contrast, only requires the return history of the portfolio to be analyzed, making this approach very flexible.

A portfolio which contains a single stock will have a non-zero value of diversification. It is well known that some companies are more diversified than others. Corporate diversification may occur because of diversification across product lines or geography. In current portfolio analytics, however, there is no way to account for the portfolio impacts of investing in diversified companies vs. concentrated companies. The Portfolio Compass captures diversification in an approach that is agnostic with respect to whether the portfolio is made up of one or more stocks, one or more funds, or any combination of these.

Under CAPM, the market portfolio should be optimal and idiosyncratic risk is not rewarded with higher expected return. If this were correct, then no portfolio of a few tens of stocks should provide as much return as the market portfolio at the same risk level. A body of research demonstrates, however, that idiosyncratic risk is a significant predictor of returns in equities. Portfolios with smaller numbers of stocks tend to have higher idiosyncratic risk, and the results suggest that such risk is rewarded with substantially higher returns. They show that portfolios in the highest decile of idiosyncratic risk exhibited returns 40% higher than portfolios in the lowest decile of idiosyncratic risk. Thus, it is not unreasonable to revisit the issue of how to build ‘efficient’ portfolios from a selection of securities.

There is substantial evidence to suggest that risk-averse investors might quite rationally build portfolios from small numbers of securities. This has important implications for portfolio formation. The challenge for these investors is to be able to quantify whether they are effectively exploiting the available diversification benefits, but we propose that the Diversification metric discussed here may provide the solution. The investor who randomly selects investment choices will be better served by choosing from among index funds. For the investor with quantitative measures of risk, return, Beta, size, value, and Diversification, however, it is not unreasonable to believe that it is possible to build a higher return portfolio for a given level of risk.

The discussion to this point has ignored transaction costs, fees, and taxes. Holding a fairly small number of individual securities provides substantial savings in all three of these areas as compared to owning funds. Even if investors minimize costs with index funds or ETF's, the tax benefits of timing the sales of individual securities may provide investors with a significant increment to portfolio return.

Testing

In previous analysis of the performance of the Portfolio Compass as a timing tool, the results were limited by the lifespan of the index funds used to represent core asset classes. In this study, pure index data was used to represent a set of core asset classes and this allows the creation of substantially longer historical analyses. This study looks at the performance of the Portfolio Compass as a timing tool over a 22-year period, from 1987 through 2008. The 22-year period rather than the 20-year period was chosen so as to include 1987.

The process followed in this study is straightforward. A list of all mutual funds in each of the four largest fund families (by assets) was started with: Vanguard, T. Rowe Price, Fidelity, and American Funds. For the core asset classes, the choices were limited by the specific population of indexes available within FAME. Quite coincidentally, this provided an interesting new set of indexes. In choosing core asset classes, the goal is to find asset classes that have unique characteristics and span a wide range of volatility levels. From the available set of indexes within our FAME database, the following seven were selected:

NDX (NASDAQ 100)

DJFI (Commodities)

DJ15UT (Utilities)

BANK (Banks)

INDS (Industrials)

TRAN (Transportation)

INSR (Insurance)

The choice of core assets is somewhat arbitrary, and the specific set of core assets is not terribly important, as long as the core asset classes are not too well correlated. For our analysis, a 48-month window of trailing returns was used to form the compass (with a minimum of 36-months for funds with short histories). A 12-month trailing return was used to define the current state of the portfolio and the computer generated an outlook for 12 months into the future.

At the start of each calendar year, all funds were identified in a fund family that met our minimum data requirements. The Portfolio Compass tool was executed and assigned either a ‘buy’ or a ‘no buy’ rating to each fund that meets the minimum data requirements. The rating is derived from a single trading rule that is used across all four fund families for the 22-year period. The average return of the funds rated as ‘buy’ were compared with the average return of all funds for that year. This process is performed for each year, from 1987 through 2008.

Defining a Timing Rule According to One Aspect of the Present Invention

A novel way to capture the relative effects of momentum and mean reversion in this framework in set forth in this Timing Rule of the present invention. A trading model is defined in the following format:

Trading Rule

According to one exemplary embodiment of a trading rule of the present invention, one will always buy in States 1 and 2, but never buy in States 4-7. For States 0 and 3, one buys when the average historical return for funds in that state is below a specifiable threshold, such as 0% for example. Other thresholds are also possible without departing from the scope of the present invention. What does this form of trading rule mean? State 0 means that a fund being analyzed has out-performed all seven of the core asset classes over the trailing 12-months. State 0, in fact, is the state that many ‘momentum’ strategies seek as the basis for a ‘buy’ rating. State 7 means that the fund being analyzed has under-performed all seven core asset classes over the most recent twelve months.

This trading rule of the present invention combines momentum effects with mean reversion effects. If a fund is in State 0 and has previously substantially out-performed following being in State 0 in the trailing 48 months, the average return in State 0 will be greater then zero, and we will not have a ‘buy’ rating—this is a bet that a recent high performer has been out-performing for so long and at such a level that the dominant probability is that it will revert to the mean.

On the other end of the performance spectrum, one simply will not buy funds that are in States 5-7. We are betting that poor performance is more persistent than good performance. This asymmetry with regard to momentum in good performance vs. poor performance has been noted in a range of momentum studies.

There are a range of permutations for this trading model. We might specify specific threshold returns for the trading rule rather than specifying only 0%, buy, and no buy in any given state. It is also possible to explore the use of a specific ‘sell’ rule in which we can take short positions.

Results

Over the 22-year period, the average annual gains in return from applying the Portfolio Compass trading rule are shown below:

The Average Performance Gain is the average return across all funds rated as a ‘buy’ minus the average return across all funds that met the minimum data requirements. This metric avoids the potential for bias in terms of survivorship and potential differences between funds with longer vs. shorter histories.

We can also compare the average returns for the timing model in an absolute sense:

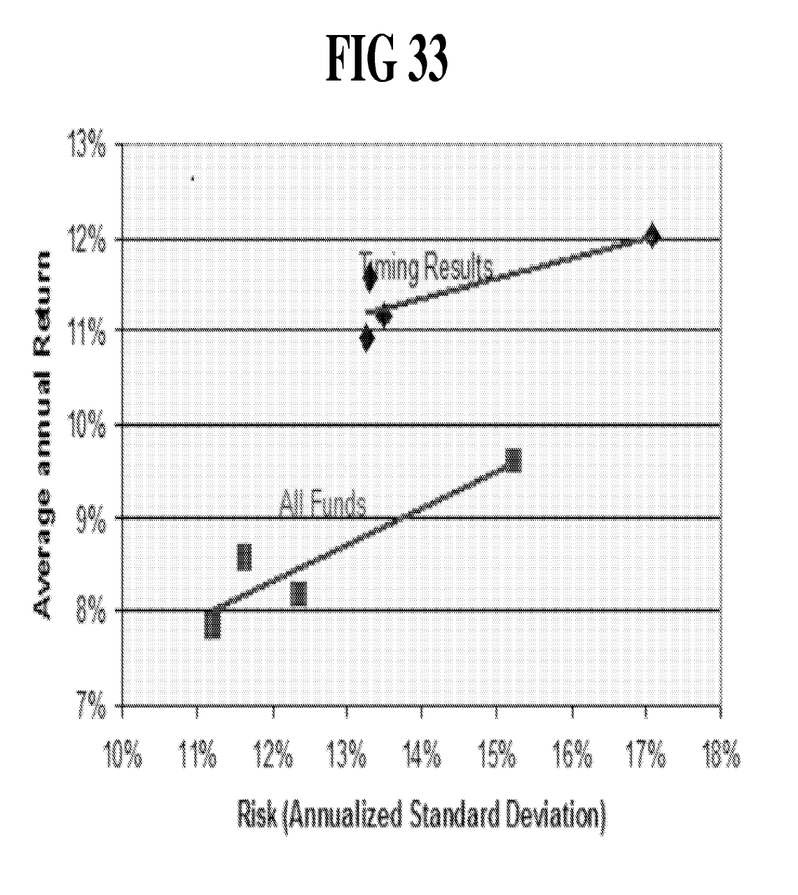

The timing model has out-performed the S&P500, with less risk (Annualized Standard Deviation in Return) for all four fund families. In the case of American, a fund family which has loads, we have not included the impacts of loads on these returns. The problem with simply looking at these results in tabular form is that it is hard to gauge the relative risk-return tradeoffs. Further, to what extent might the improved performance of the timing model simply be due to diversification effects beyond the S&P500? After all, the universe of funds includes many asset classes beyond the S&P500 such as small-cap stocks, real estate, etc. To explore this issue, the risk vs. return was charted for our four fund families, which is shown in FIG. 33.

In FIG. 33, each diamond (top portion of the chart) shows the risk vs. return using the timing model for one of the four fund families over the 22-year period. Each square (bottom portion of the chart) shows the same data for an equal allocation to every fund in each fund family with sufficient data to be rated by the timing model in each year. The solid black line shows the risk vs. return for a mix of the S&P500 with the yield on three-month T-bills. The slopes of the lines through each set of points are very similar, which is a good sign. This means that the incremental impacts of making a portfolio more aggressive are estimated similarly across the three lines. The distance between the lines at each risk level shows difference in average return, adjusted for risk. For the risk levels associated with the timing model and three of the fund families (13%-14% in annualized standard deviation), we see an offset of about 2% in return (the distance between the red line and the blue line). This is a reasonable estimate of the incremental return that the timing model provides, net of risk. The total average gain in return from the timing model is 2.9% (see the first table in this paper). We are estimating that the gain risk-adjusted gain from timing is 2% per year, so the incremental gain from taking on additional risk is 0.9% per year.

The fact that the return from All Funds is on the order of 0.5% per year greater than a simple mix of the S&P500 with T-bills is worth noting. There are two obvious sources of this effect. One of these is survivorship bias and the other is diversification benefit. This source of potential bias is why the timing model was compared to all mutual funds in a given year rather than simply comparing to a benchmark like the S&P500.

Comparison to Other Timing Models

The use of timing models has a long history. The timing model with the best documented long-term track record is produced under the brand name NoLoad FundX. There is little question that this firm provides the target to beat in terms of fund timing. The basic concept behind FundX is a straightforward momentum strategy. The portfolio is rebalanced on a monthly basis to drop funds that have been underperforming and add funds that have been out-performing. The firm also manages mutual funds based upon its strategies, which provide a measure of turnover that results from applying these strategies. The fund that trades the momentum strategy directly (FUNDX) averages 167% annual turnover, which will clearly lead to substantial tax consequences.

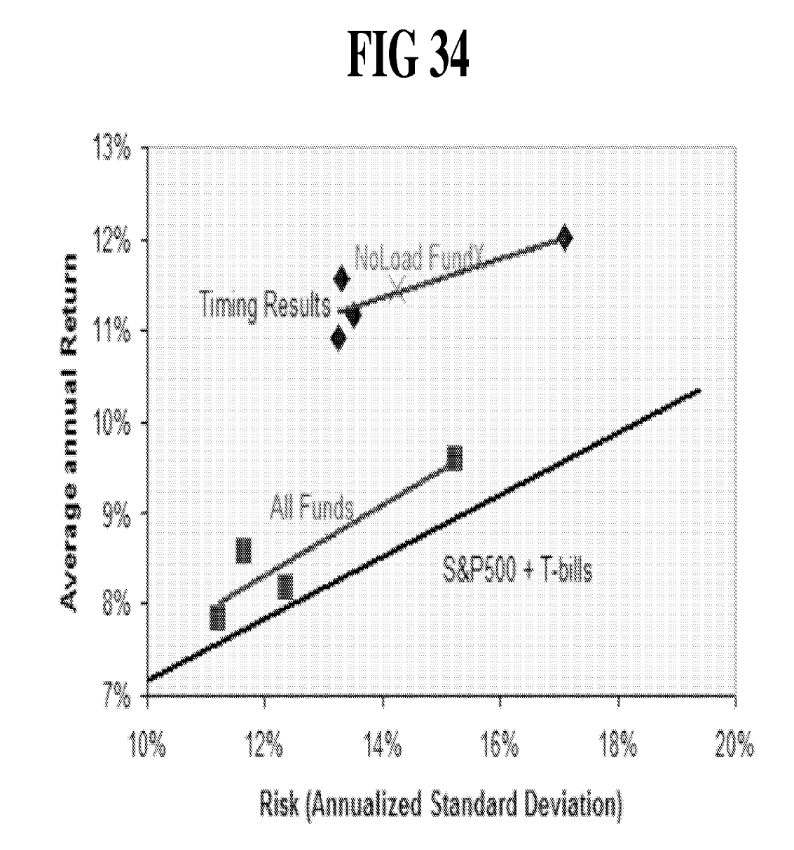

NoLoad FundX makes its estimates of total return from applying its strategies available on its website. There are four NoLoad FundX strategies that represent four different levels of risk tolerance. The performance of the strategy that most closely matches the Portfolio Compass risk levels (Class 4) is show in FIG. 34.

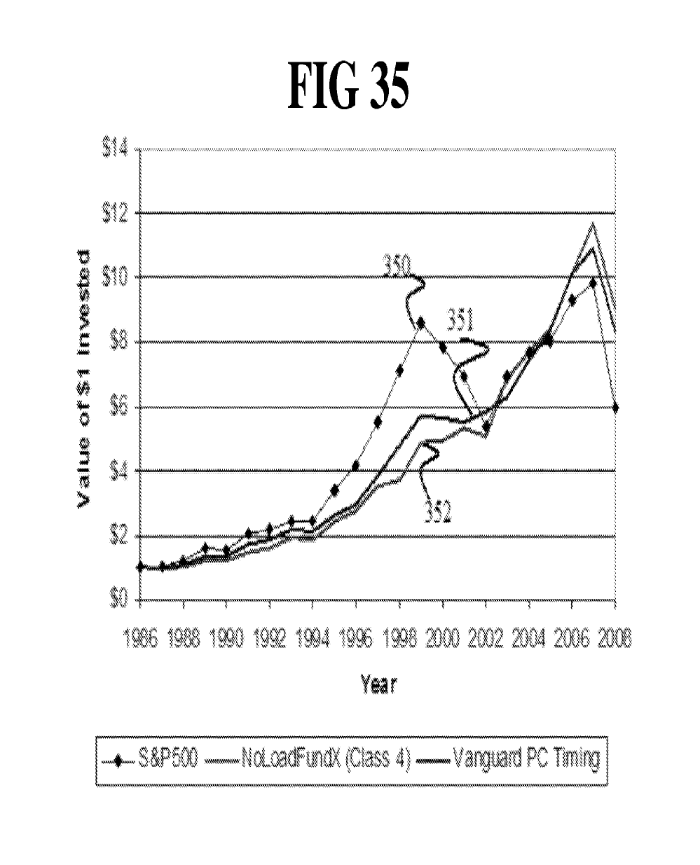

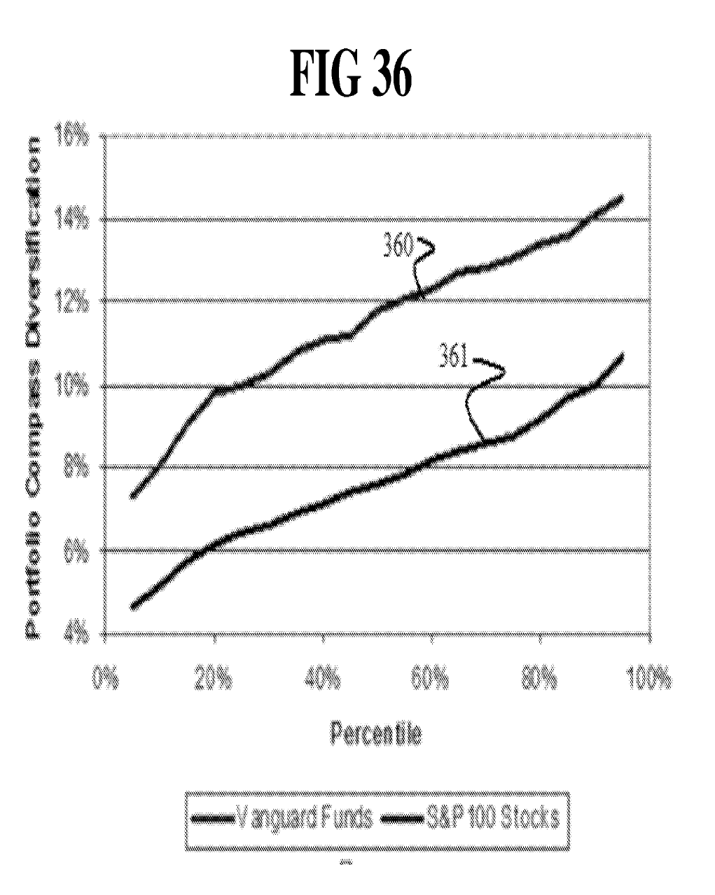

The high degree of similarity between the risk and return profiles of NoLoad FundX Class 4 and the Portfolio compass is notable. Further analysis reveals that the Betas of the annual returns for the Portfolio Compass and NoLoad FundX are very similar (about 60%). When we examine the value of $1 invested using the two timing models (352=NoLoadFundX; and 351=Vanguard PC Timing) vs. the S&P500 (350), the similarities are evident in FIG. 35.

The timing models were less aggressive than the broader market through the 1990's, were more aggressive in the first five years of the 21st century, and became less aggressive going into 2008.

What is perhaps most intriguing regarding the high degrees of similarity between these two strategies is that NoLoad FundX is a pure play on momentum (always switching to the funds which have performed best over a trailing period), the Portfolio Compass is less aggressive in terms of its goals. The trading rule used in this study does not simply buy into the highest-performing funds. This may, of course, correspond to the Class 4 strategy which segregates funds by their historical risk levels.

The slight out-performance of the NoLoad FundX strategy for the cumulative returns over the 22-year period must be considered in light of the high turnover (and associated transactions costs) that such a monthly trading strategy may require. The mutual fund that applies this strategy has annual turnover of 167%, as noted earlier. This also has substantial tax implications. The maximum turnover for the Portfolio Compass timing model applied here is 100% and that would only occur if every single fund held in one year was not held in the next. We have not yet quantified the average turnover for all fund families, but it is substantially less than 100% for the cases we have examined thus far. Further, because the minimum holding period is 12 months in the Portfolio Compass timing model, the gains would be subject to long-term gains tax rates rather than short-term.

Discussion

Tests of the Portfolio Compass over a 22-year period from 1987 through 2008 suggest that the value of this strategy may be substantial. These tests have yet taken into account the full value of the Portfolio Compass, however. Timing is only one aspect of the value proposition of the Portfolio Compass. The novelty of our approach is that it can also be applied to portfolios of individual stocks, as well as to mutual funds. This is a substantial distinction. In some of our ongoing testing, we have found that the threshold returns associated with each asset class vary depending upon whether we are looking at individual stocks or mutual funds.

There is no reason to believe that the same type of trading rule will apply equally well to funds and stocks. The relative role of market risk vs. non-market risk in stock prices vs. fund prices tends to be dramatically different—and in the Portfolio Compass measure of diversification, too. The chart in FIG. 36 shows the percentiles of our diversification measure for all Vanguard funds (360) vs. the individual stocks that make up the S&P100 (361).

As we would expect to find, the funds are vastly better diversified than the individual stocks. In the Portfolio Compass, diversification is measured based on the relative probability of the returns from the asset (stock, fund, etc.) being in the extreme states (0 and 7) vs. the central states (3 or 4). A portfolio that is more diversified with respect to the core asset classes is more likely to be found with a higher probability in the central states and vice versa. The R-squared values on individual stocks will tend to be much higher than that of funds for essentially the same reason. For these reasons, it is natural to expect that the trading rules developed for mutual funds will not be optimal for individual stocks.

### Conclusions

There appears to be a substantial advantage to mutual fund timing, based on exploiting a balance between momentum and mean reversion. Over the past 22 years, this advantage amounts to an average of 2.9% per year (before accounting for transaction costs). The effect is very similar for the one family of loaded mutual funds (American) before accounting for loads and the no-load families, which suggests that investors who seek to time mutual funds will fare better in no-load funds. Part of the extra return provided by the timing model is due to higher risk in funds selected by the model (order of 1% per year). This says nothing about the value of the timing model and simply shows a bias to higher risk levels than the average across all funds. The remaining 2% per year or so does appear to suggest the value of timing of funds.

### Other Exemplary Embodiments

The methods and techniques of the present invention provide a wide array of possible uses and applications for investment advisors, analysts and investors, both individual and those managing accounts for funds, plans or corporations. Several of these applications are listed herein, while others will be apparent to those of skill in the art.

One exemplary embodiment of the techniques herein uses the techniques of the present invention to characterize a large number of potential investment portfolios to enable one to make more intelligent investment decisions. For example, one could create a large number of possible investment portfolios and then characterize these portfolios using, e.g., four metrics (other known metrics could also be added to these without departing from the scope of the present invention): (1) Trailing return; (2) Risk; (3) Diversification; and (4) Timeliness.

Trailing return and risk are standard and known calculations. Risk may be calculated in terms of trailing volatility of returns. Other possible calculations of risk could also be employed. Diversification and Timeliness are metrics that are generated by the methods and processes set forth herein. The Diversification metric is based on the weighted sum of the probability that a given portfolio is in one of several possible States. Timeliness is determined from the timing rules generated as described previously. These metrics may be used to create screening functions to identify portfolios that best meet the needs of certain investors. These screening functions could be employed by individual investors, analysts, investment advisors or computerized investment tools, such as Foliofn.com.

As part of this exemplary embodiment, the range of possible portfolios could potentially include the universe of all mutual funds, portfolios built up from a wide range of combinations of these mutual funds, as well as portfolios built up from individual stocks and bonds. This is a similar process to that traditionally used to define the efficient frontier. Given a large sample of possible portfolios, one can then identify the portfolios with features optimized on specific variables. Some investors may want to screen for low risk, highly diversified portfolios. Some investors may want to identify portfolios with high trailing returns, high diversification, low risk, and for which the timing model indicates look favorable, etc. The methods and processes herein permit one to screen for a wide variety of characteristics.

Another exemplary embodiment of the present invention combines the aforementioned methods and processes with an investor questionnaire to help customize or optimize one's portfolio. For example, an investor questionnaire could be combined with the portfolio rating analytics to create a portfolio customized to a specific investor's needs. Typical investor questionnaires determine an investor's risk tolerance and time horizon. With additional questions, one can determine whether an investor is seeking a more or less diversified portfolio. With the output of the questionnaire, the rating technology can be used to: (1) identify funds that are consistent with the investor's goals; (2) identify existing model portfolios that are consistent with the investor's goals; or (3) iteratively identify or help create a customized portfolio. The questionnaire could also be combined with the previous embodiment to identify a hypothetical portfolio that best matches a specific investor's needs.

Another exemplary embodiment of the present invention uses the aforementioned methods and processes in combination with a portfolio optimizer and a list of possible investments. The optimizer would then be used to identify the portfolios that best match specific investment criteria. There are a range of different optimizers available. This exemplary embodiment allows the optimizer to identify the portfolio that will provide the maximum or minimum values on specific characteristics. For example, an investor may specify that the optimizer should find possible portfolios with risk below the 50th percentile of all possible portfolios, trailing returns in the 75th percentile and above, and diversification in the 75th percentile and above that are also rated as a ‘buy’ on the basis of the timing model. If such portfolios exist, a list of these possible portfolios is provided in a list to the user or investor.

Yet another exemplary embodiment of the present invention employs the methods and techniques of the present invention to create a ranking tool for selecting among a large number of mutual funds and ETF's. The ranking tool generates the four key metrics described in one of the previous exemplary embodiments for all mutual funds, as of a given date. The methods of the present invention then generate these statistics for a range of time horizons. The metrics may differ, depending upon the expected holding period. These metrics may be visualized in a range of ways. These metrics may be used for screening mutual funds, i.e., ranking mutual funds on the basis of the values of these metrics as well as other standard metrics (fund style, Morningstar rating, etc.).

Still another exemplary embodiment of the methods and processes of the present invention categorizes mutual funds and ETF's. Morningstar characterizes funds in terms of their primary asset class (large cap blend, for example) and their relative factor tilts towards value-oriented stocks and between larger capitalization stocks and smaller capitalization stocks. This is represented in a form that Morningstar calls the Style Box. Using the methods of the present invention, one can also categorize mutual funds and ETF's in terms of the four attributes described in the aforementioned exemplary embodiment.

Yet another exemplary embodiment of the present invention, uses the methods and processes of the present invention to identify a unique ‘thumbprint’ of a mutual fund, ETF, or user-generated portfolio using the portfolio compass diagram and then to use a pattern recognition software tool (which are now available off-the-shelf) to identify other mutual funds, ETF's, or pre-defined portfolios that are most ‘similar’ to the original mutual fund, ETF, or under-generated portfolio.

Still another exemplary embodiment of the present invention uses the timing rule of the present invention to assist in choosing when to buy or sell a specific mutual fund or ETF or other portfolio. This is equivalent to using the technology as a mechanical trading rule.

Other applications and uses of the methods and processes herein will be apparent to those of skill in this art.

Although various embodiments are specifically illustrated and described herein, it will be appreciated that modifications and variations of the invention are covered by the above teachings and are within the purview of the appended claims without departing from the spirit and intended scope of the invention. For example, the above examples employ six and ten asset classes when perturbing the portfolio under analysis. Other numbers of asset classes or specific asset classes can be employed without departing from the present invention. Furthermore, these examples should not be interpreted to limit the modifications and variations of the invention covered by the claims but are merely illustrative of possible variations.

What is claimed is:

1. A computer implemented method for analyzing a portfolio comprising:
creating with a computer a plurality (N) of modified portfolios, each of which includes a predetermined percentage (x) of one of a plurality of user specifiable analytic elements and a remaining percentage (100−x) composed of the portfolio being analyzed;
determining with a computer a historical probability (Hᵢ) that a given number (i) of the plurality of modified portfolios outperformed the portfolio being analyzed during a predetermined period for each possible number (i=0 through N), including zero, of the plurality of modified portfolios;
calculating a metric representing the portfolio being analyzed with a computer by calculating a weighted sum of the determined probabilities;
ranking with a computer the portfolio relative to a plurality of other portfolios based on the calculated metric; and
displaying the ranking via a graphical user interface.

2. A computer readable media having a plurality of programming instructions that cause a processor to analyze a portfolio by:
creating a plurality (N) of modified portfolios, each of which includes a predetermined percentage (x) of one of a plurality of user specifiable analytic elements and a remaining percentage (100−x) composed of the portfolio being analyzed;
determining a historical probability (Hᵢ) that a given number (i) of the plurality of modified portfolios outperformed the portfolio being analyzed during a predetermined period for each possible number (i=0 through N), including zero, of the plurality of modified portfolios;
calculating a metric representing the portfolio being analyzed with a computer by calculating a weighted sum of the determined probabilities; and
displaying the calculated metric via a graphical user interface.

3. An apparatus for analyzing a portfolio comprising:
a computer to create a plurality (N) of modified portfolios, each of which includes a predetermined percentage (x) of one of a plurality of user specifiable analytic elements and a remaining percentage (100−x) composed of the portfolio being analyzed;
said computer to determine a historical probability (Hᵢ) that a given number (i) of the plurality of modified portfolios outperformed the portfolio being analyzed during a predetermined period for each possible number (i=0 through N), including zero, of the plurality of modified portfolios;
said computer to calculate a metric representing the portfolio being analyzed by calculating a weighted sum of the determined probabilities;
said computer to rank the portfolio relative to a plurality of other portfolios based on the calculated metric; and
a graphical user interface coupled to the computer to display the ranking.
